(19) United States
(12) Patent Application Publication
(10) Pub. No.: US 2026/0189707 A1
(43) Pub. Date: Jul. 2, 2026

(54) IMAGE DECODING METHOD, IMAGE DECODING DEVICE, IMAGE ENCODING METHOD, AND IMAGE ENCODING DEVICE FOR QUANTIZATION SHIFT

(71) Applicant: SAMSUNG ELECTRONICS CO., LTD., Suson-si (KR)

(72) Inventors: Quockhanh DINH, Suson-si (KR); Yinji PIAO, Suson-si (KR); Kwangpyo CHOI, Suson-si (KR)

(73) Assignee: SAMSUNG ELECTRONICS CO., LTD., Suson-si (KR)

(21) Appl. No.: 19/543,025

(22) Filed: Feb. 18, 2026

Related U.S. Application Data
(63) Continuation of application No. PCT/KR2024/008342, filed on Jun. 17, 2024.

(30) Foreign Application Priority Data
Aug. 18, 2023 (KR) 10-2023-0108572
May 21, 2024 (KR) 10-2024-0065855

(51) Int. Cl. H04N 19/124; H04N 19/176; H04N 19/18

(52) U.S. Cl. CPC H04N 19/124; H04N 19/176; H04N 19/18

(57) ABSTRACT

An image decoding method including obtaining, from a bitstream, information indicating a quantization parameter for a current block. The method including obtaining a transform coefficient of the current block by performing dequantization based on the information indicating the quantization parameter. The method including determining a quantization offset among a plurality of quantization offsets, based on at least one of a prediction mode of the current block, a slice type of a current slice including the current block, a frequency band of the transform coefficient included in the current block, or the quantization parameter of the current block. The method including changing the transform coefficient by using the determined quantization offset.

### CROSS-REFERENCE TO RELATED APPLICATIONS

This application is a Bypass Continuation Application of International Application PCT/KR2024/008342 filed on Jun. 17, 2024, which claims benefit of Korean Provisional Application No. 10-2023-0108572, filed on Aug. 18, 2023 filed at the Korean Intellectual Property Office, and Korean Provisional Application No. 10-2024-0065855, filed on May 21, 2024 filed at the Korean Intellectual Property Office the disclosures of which are incorporated herein in their entireties by reference.

### BACKGROUND

### Field

The present disclosure relates to the field of image encoding and decoding, and more particularly, to an apparatus and method for encoding and decoding an image by performing a quantization shift so as to decrease an error occurring due to dequantization.

### Description of Related Art

In a codec such as H.264 Advanced Video Coding (AVC) and High Efficiency Video Coding (HEVC), an image may be split into blocks, and each of the blocks may be prediction-encoded and prediction-decoded via inter prediction or intra prediction. Also, encoding may be performed on a residual via transformation and quantization.

The quantization may indicate an operation of performing scaling on a transform coefficient by using a quantization parameter. Important information may be quantized in detail, and information that is relatively less important may be quantized by using a relatively large quantization parameter. A size of data may be decreased via quantization, but simultaneously, a loss of information may occur, and the loss due to the quantization may be represented as artifact in an image.

Dequantization may indicate an operation of performing scaling on a quantized transform coefficient by using a quantization parameter. A transform coefficient obtained by performing the dequantization on the quantized transform coefficient may be different from a transform coefficient before the quantization is performed. Accordingly, there is a demand for a method of decreasing an error between the transform coefficient obtained by performing the dequantization and the transform coefficient before the quantization is performed. As the error between the transform coefficient obtained by performing the dequantization and the transform coefficient before the quantization is performed is decreased, artifacts in a reconstructed image may be reduced.

Recently, techniques of encoding/decoding an image by using artificial intelligence (AI) are proposed, and an image may be effectively encoded/decoded by using the AI, for example, a neural network.

Information disclosed in this Background section has already been known to or derived by the inventors before or during the process of achieving the embodiments of the present application, or is technical information acquired in the process of achieving the embodiments. Therefore, it may contain information that does not form the prior art that is already known to the public.

### SUMMARY

According to an embodiment of the disclosure, an image decoding method including obtaining, from a bitstream, information indicating a quantization parameter for a current block. The image decoding method including obtaining a transform coefficient of the current block by performing dequantization based on the information indicating the quantization parameter. The image decoding method including determining a quantization offset among a plurality of quantization offsets, based on at least one of a prediction mode of the current block, a slice type of a current slice including the current block, a frequency band of the transform coefficient included in the current block, or the quantization parameter of the current block. The image decoding method including changing the transform coefficient by using the determined quantization offset.

In an embodiment, the plurality of quantization offsets are determined according to an offset table or an offset parameter table which is predetermined by using at least one of the prediction mode of the current block, the slice type of the current slice including the current block, the frequency band of the transform coefficient included in the current block, or the quantization parameter of the current block.

In an embodiment, the changing of the transform coefficient includes performing a quantization shift by performing interpolation, by using the quantization offset, on a value of the transform coefficient and a value subsequent to the transform coefficient.

In an embodiment, the determining of the quantization offset includes determining, as the quantization offset for the current block, a quantization offset value that is of a case in which the prediction mode of the current block is an intra mode and that is less than a quantization offset value of a case in which the prediction mode of the current block is an inter mode.

In an embodiment, the determining of the quantization offset includes determining, as the quantization offset for the current block, a quantization offset that is of a case in which bi-direction prediction is performed on the current block and that has a value greater than a quantization offset of a case in which uni-direction prediction is performed on the current block.

In an embodiment, the determined quantization offset has a value that is greater in a case in which a frequency band of the current block is a high frequency band than in a case in which the frequency band of the current block is a low frequency band.

In an embodiment, the determining of the quantization offset includes, when the quantization offset value is a second quantization parameter greater than a first quantization parameter, determining a second quantization offset as the quantization offset for the current block, the second quantization offset being greater than a first quantization offset determined based on the first quantization parameter.

In an embodiment, the determining of the quantization offset includes, when a quantized transform coefficient value for the current block is a second quantized transform coefficient less than a first quantized transform coefficient, determining a second quantization offset as the quantization offset for the current block, the second quantization offset being greater than a first quantization offset determined based on the first quantized transform coefficient.

In an embodiment, the determining of the quantization offset among the plurality of quantization offsets includes: based on locations of a plurality of samples included in the current block, classifying the plurality of samples included in the current block, according to a plurality of frequency bands; determining, among the plurality of frequency bands, a frequency band for the current block; and determining the quantization offset, according to the determined frequency band.

In an embodiment, the determining of the quantization offset among the plurality of quantization offsets includes: based on a scan order of a plurality of samples included in the current block, classifying the plurality of samples included in the current block, according to a plurality of frequency bands; determining, among the plurality of frequency bands, a frequency band for the current block; and determining the quantization offset, according to the determined frequency band.

According to an embodiment of the disclosure, an image encoding method including determining a quantization parameter used to perform quantization on a current block. The image encoding method including obtaining a transform coefficient of the current block by performing dequantization based on the quantization parameter. The image encoding method including determining a quantization offset among a plurality of quantization offsets, based on at least one of a prediction mode of the current block, a slice type of a current slice including the current block, a frequency band of a transform coefficient included in the current block, and the quantization parameter of the current block. The quantization offset is used to change the transform coefficient obtained by performing dequantization. The image encoding method including generating a bitstream including information indicating the quantization parameter of the current block.

In an embodiment, the plurality of quantization offsets are determined according to an offset table or an offset parameter table which is predetermined by using at least one of the prediction mode of the current block, the slice type of the current slice including the current block, the frequency band of the transform coefficient included in the current block, or the quantization parameter for the current block.

In an embodiment, a quantization shift is performed on the transform coefficient obtained by performing dequantization, via interpolation of a value of the transform coefficient and a value subsequent to the transform coefficient by using the quantization offset.

In an embodiment, the determining of the quantization offset included determining, as the quantization offset for the current block, a quantization offset value that is of a case in which the prediction mode of the current block is an intra mode and that is less than a quantization offset value of a case in which the prediction mode of the current block is an inter mode.

According to an embodiment of the disclosure, anon-transitory computer-readable recording medium storing computer program, which, when executable by at least one processor, causes the at least one processor to execute: obtain, from a bitstream, information indicating a quantization parameter for a current block; obtain a transform coefficient of the current block by performing dequantization based on the information indicating the quantization parameter; determine a quantization offset among a plurality of quantization offsets, based on at least one of a prediction mode of the current block, a slice type of a current slice including the current block, a frequency band of the transform coefficient included in the current block, or the quantization parameter of the current block; and change the transform coefficient by using the determined quantization offset.

According to an embodiment of the present disclosure, an error between an original image and a reconstructed image may be decreased. An error that occurs in a process of performing quantization or dequantization may be decreased.

### BRIEF DESCRIPTION OF THE DRAWINGS

FIG. 1 is a block diagram of an image decoding apparatus according to an embodiment.

FIG. 2 is a block diagram of an image encoding apparatus according to an embodiment.

FIG. 3 illustrates a process of determining at least one coding unit by splitting a current coding unit, according to an embodiment.

FIG. 4 illustrates a process of determining at least one coding unit by splitting a non-square coding unit, according to an embodiment.

FIG. 5 illustrates a process of splitting a coding unit based on at least one of block shape information and split shape mode information, according to an embodiment.

FIG. 6 illustrates a method of determining a preset coding unit from among an odd number of coding units, according to an embodiment.

FIG. 7 illustrates an order of processing a plurality of coding units when the plurality of coding units are determined by splitting a current coding unit, according to an embodiment.

FIG. 8 illustrates a process of determining that a current coding unit is to be split into an odd number of coding units, when coding units are not processable in a preset order, according to an embodiment.

FIG. 9 illustrates a process of determining at least one coding unit by splitting a first coding unit, according to an embodiment.

FIG. 10 illustrates that a shape into which a second coding unit is splittable is restricted when the second coding unit having a non-square shape, which is determined when a first coding unit is split, satisfies a preset condition, according to an embodiment.

FIG. 11 illustrates a process of splitting a square coding unit when split shape mode information is unable to indicate that the square coding unit is split into four square coding units, according to an embodiment.

FIG. 12 illustrates that a processing order between a plurality of coding units may be changed depending on a process of splitting a coding unit, according to an embodiment.

FIG. 13 illustrates a process of determining a depth of a coding unit as a shape and size of the coding unit change, when the coding unit is recursively split such that a plurality of coding units are determined, according to an embodiment.

FIG. 14 illustrates depths that are determinable based on shapes and sizes of coding units, and part indexes (PIDs) that are for distinguishing the coding units, according to an embodiment.

FIG. 15 illustrates that a plurality of coding units are determined based on a plurality of preset data units included in a picture, according to an embodiment.

FIG. 16 illustrates coding units that may be determined in each picture when a combination of shapes into which a coding unit is splittable is different for each picture, according to an embodiment.

FIG. 17 illustrates various shapes of a coding unit which may be determined based on split shape mode information that may be represented in binary code, according to an embodiment.

FIG. 18 illustrates other shapes of a coding unit which may be determined based on split shape mode information that may be represented in binary code, according to an embodiment.

FIG. 19 is a block diagram of an image encoding and decoding system that performs inloop filtering, according to an embodiment.

FIG. 20 is a diagram for describing a process of encoding and decoding a current image, based on intra prediction, according to an embodiment of the present disclosure.

FIG. 21 is a diagram for describing a process of encoding and decoding a current image, based on inter prediction, according to an embodiment of the present disclosure.

FIG. 22 is a diagram illustrating consecutive images, an optical flow between the consecutive images, and a residual image between the consecutive images.

FIG. 23 is a block diagram illustrating a configuration of an image decoding apparatus according to an embodiment of the present disclosure.

FIG. 24 is a flowchart of an image decoding method according to an embodiment of the present disclosure.

FIG. 25 is a flowchart of an image decoding method according to an embodiment of the present disclosure.

FIG. 26 is a diagram for describing a quantization offset according to an embodiment of the present disclosure.

FIG. 27 is a diagram for describing a quantization offset according to an embodiment of the present disclosure.

FIG. 28 is a diagram of an operation of classifying a frequency band according to an embodiment of the present disclosure.

FIG. 29 is a diagram of an operation of classifying a frequency band according to an embodiment of the present disclosure.

FIG. 30 is a block diagram illustrating a configuration of an image encoding apparatus according to an embodiment of the present disclosure.

FIG. 31 is a flowchart of an image encoding method according to an embodiment of the present disclosure.

FIG. 32 is a flowchart of an image encoding method according to an embodiment of the present disclosure.

### DETAILED DESCRIPTION

Throughout the present disclosure, the expression “at least one of a, b or c” indicates only a, only b, only c, both a and b, both a and c, both b and c, all of a, b, and c, or variations thereof.

In the present disclosure, the singular forms “a,” “an,” and “the” may include the plural forms as well, unless the context clearly indicates otherwise. Therefore, for example, the term “structural surface” may also refer to one or more of such surfaces.

In the descriptions of the present disclosure, detailed explanations of the related art which are well known in the art to which the present disclosure belongs and are not directly related to the present disclosure are omitted. By omitting unnecessary explanations, the essence of the present disclosure may not be obscured and may be explicitly conveyed. The terms used in the specification are defined in consideration of functions used in the present disclosure, and may be changed according to the intent or known methods of operators and users. Accordingly, definitions of the terms should be understood based on the entire description of the present specification.

For the same reasons, in the drawings, some elements may be exaggerated, omitted, or roughly illustrated. Also, the size of each element does not exactly correspond to an actual size of each element. In the drawings, the same or corresponding elements are denoted by the same reference numerals.

The advantages and features of the present disclosure and methods of achieving them will become apparent with reference to embodiments described in detail below with reference to the accompanying drawings. However, the present disclosure may be embodied in many different forms and should not be construed as limited to embodiments set forth herein. The disclosed embodiments are provided so that this present disclosure will be thorough and complete, and will fully convey the scope of the present disclosure to one of ordinary skill in the art. An embodiment of the present disclosure may be defined by the claims. Throughout the specification, like reference numerals denote like elements. In the descriptions of embodiments of the present disclosure, detailed explanations of the related functions or configurations are omitted when it is deemed that they may unnecessarily obscure the essence of the present disclosure. The terms used in the specification are defined in consideration of functions used in the present disclosure, and may be changed according to the intent or known methods of operators and users. Accordingly, definitions of the terms should be understood based on the entire description of the present specification.

It will be understood that blocks in each of flowcharts and combinations of the flowcharts may be implemented by one or more computer programs including computer-executable instructions. The one or more computer programs may be all stored in a single memory or may be stored in a plurality of different memories in a distributed manner.

In an embodiment, each block of flowchart illustrations and combinations of the flowchart illustrations may be implemented by computer program instructions. The computer program instructions may be provided to a processor of a general-purpose computer, special purpose computer, or other programmable data processing apparatus, such that the instructions, which are executed by the processor of the computer or other programmable data processing apparatus, generate means for performing functions specified in the flowchart block(s). The computer program instructions may also be stored in a computer-executable or computer-readable memory that may direct the computer or other programmable data processing apparatus to function in a particular manner, such that the instructions stored in the computer-executable or computer-readable memory produce an article of manufacture including instruction means that perform the functions specified in the flowchart block(s). The computer program instructions may also be loaded onto the computer or other programmable data processing apparatus.

In addition, each block of the flowchart illustrations may represent a module, segment, or portion of code, which includes one or more executable instructions for performing specified logical function(s). In an embodiment, the functions noted in the blocks may occur out of the order. For example, two blocks shown in succession may be executed substantially concurrently or the blocks may be executed in the reverse order, depending upon the functionality involved.

All functions or operations described in the present disclosure may be processed by one processor or a combination of processors. The one processor or the combination of processors may indicate circuitry for performing processing, and may include circuitry such as an application processor (AP), a communication processor (CP), a graphical processing unit (GPU), a neural processing unit (NPU), a microprocessor unit (MPU), a system on chip (SoC), an integrated chip (IC), or the like.

The term “ . . . unit”, as used in an embodiment of the present disclosure may refer to a software or hardware component, such as field-programmable gate array (FPGA) or application-specific integrated circuit (ASIC), which performs certain tasks. However, the term “ . . . unit” does not mean to be limited to software or hardware. A unit may be configured to be in an addressable storage medium or configured to operate one or more processors. In an embodiment, a unit may include components such as software components, object-oriented software components, class components, and task components, and may include processes, functions, attributes, procedures, subroutines, segments of program code, drivers, firmware, micro codes, circuits, data, a database, data structures, tables, arrays, or variables. A function provided by particular elements or particular ‘units’ may be associated with the smaller number of elements and units, or may be divided into additional elements and units. In addition, in an embodiment, a ‘unit’ may include one or more processors.

In the present disclosure, an ‘image’ may correspond to a still image, a picture, frames, a moving image including a plurality of consecutive still images, or a video. In the present disclosure, a ‘current image’ may indicate an image that is a current processing target, and a ‘previous image’ may indicate an image that is a processing target before the current image. The ‘current block’ or the ‘previous block’ may be a block split from a current image or a previous image.

In the present disclosure, a ‘sample’ indicates data that is allocated to a sampling location in one-dimensional or two-dimensional data such as an image, feature data, probability data, quantized data, etc., and may include data to be processed. For example, a pixel in a frame of a spatial region may correspond to a sample. A unit including a plurality of samples may be defined as a block. Alternatively, a sample may include a pixel in a two-dimensional image, and two-dimensional data may be referred to as a ‘map’.

In the present disclosure, a ‘neural network’ refers to a representative example of an artificial neural network model that mimics brain nerves, and is not limited to an artificial neural network model using a particular algorithm. A neural network may also be referred to as a deep neural network.

In the present disclosure, a ‘parameter’ refers to a value used in a computation process of each layer constituting a neural network, and for example, may be used when applying an input value to a certain arithmetic expression. A parameter is a value set as a result of training, and may be refined by using separate training data when necessary.

In the present disclosure, a ‘latent tensor’ may refer to data obtained as a neural network or a neural network-based encoder processes input data. The latent tensor may be one-dimensional or two-dimensional data including multiple samples. The latent tensor may also be referred to as a latent representation or feature data. The latent tensor may represent features inherent in data output by a neural network-based decoder.

It will be understood that an artificial intelligence (AI) based end-to-end encoding/decoding system is a system that uses a neural network in an image encoding process and an image decoding process.

In the AI based end-to-end encoding/decoding system such as HEVC, Versatile Video Coding (VVC), etc., intra prediction or inter prediction may be used to encode and decode an image.

As described above, intra prediction is a method of compressing an image by removing spatial redundancy within the image, and inter prediction is a method of compressing images by removing temporal redundancy between the images.

In an embodiment of the present disclosure, intra prediction may be applied to a first frame among multiple frames, a frame designated as a random access point, and a frame where a scene change occurs.

In an embodiment of the present disclosure, inter prediction may be applied to frames subsequent to a frame, among multiple frames, to which intra prediction is applied.

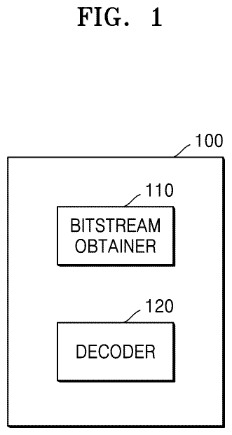

Hereinafter, with reference to FIGS. 1 to 19, an image encoding method and apparatus, and an image decoding method and apparatus, based on coding units and transform units of a tree structure, according to an embodiment, are provided.

FIG. 1 illustrates a block diagram of an image decoding apparatus 100 according to an embodiment.

The image decoding apparatus 100 may include a bitstream obtainer 110 and a decoder 120. The bitstream obtainer 110 and the decoder 120 may include at least one processor. Also, the bitstream obtainer 110 and the decoder 120 may include memory storing instructions to be performed by the at least one processor.

The bitstream obtainer 110 may receive a bitstream. The bitstream includes information about an image encoded by an image encoding apparatus 200 to be described below. Also, the bitstream may be transmitted from the image encoding apparatus 200. The image encoding apparatus 200 and the image decoding apparatus 100 may be connected by wire or wirelessly, and the bitstream obtainer 110 may receive the bitstream by wire or wirelessly. The bitstream obtainer 110 may receive the bitstream from a storage medium such as an optical medium, a hard disk, or the like. The decoder 120 may reconstruct an image based on information obtained from the received bitstream. The decoder 120 may obtain, from the bitstream, a syntax element for reconstructing the image. The decoder 120 may reconstruct the image based on the syntax element.

According to detailed descriptions of an operation of the image decoding apparatus 100, the bitstream obtainer 110 may receive the bitstream.

The image decoding apparatus 100 may perform an operation of obtaining, from a bitstream, a bin string corresponding to a split shape mode of a coding unit. The image decoding apparatus 100 may perform an operation of determining a split rule of the coding unit. Also, the image decoding apparatus 100 may perform an operation of splitting the coding unit into a plurality of coding units, based on at least one of the bin string corresponding to the split shape mode or the split rule. The image decoding apparatus 100 may determine an allowable first range of a size of the coding unit, according to a height to width ratio of the coding unit, so as to determine the split rule. The image decoding apparatus 100 may determine an allowable second range of the size of the coding unit, according to the split shape mode of the coding unit, so as to determine the split rule.

Hereinafter, splitting of a coding unit will be described in detail according to an embodiment of the present disclosure.

First, one picture may be split into one or more slices or one or more tiles. One slice or one tile may be a sequence of one or more largest coding units (coding tree units (CTUs)). According to an embodiment, one slice may include one or more tiles, or one slice may include one or more CTUs. A slice including one or more tiles may be determined within a picture.

There is a largest coding block (coding tree block (CTB)) conceptually compared to a largest coding unit (CTU). The largest coding block (CTB) indicates an N×N block including N×N samples (where, N is an integer). Each color component may be split into one or more largest coding blocks.

A largest coding unit (CTU) of a case where a picture includes three sample arrays (sample arrays for Y, Cr, and Cb components) is a unit including a largest coding block of a luma sample, two corresponding largest coding blocks of chroma samples, and syntax structures used to encode the luma sample and the chroma samples. A largest coding unit of a case where a picture is a monochrome picture is a unit including a largest coding block of a monochrome sample and syntax structures used to encode the monochrome samples. A largest coding unit of a case where a picture is a picture encoded in color planes separated according to color components is a unit including syntax structures used to encode the picture and samples of the picture.

One largest coding block (CTB) may be split into MxN coding blocks including M×N samples (where, M and N are integers).

A coding unit (CU) of a case where a picture has sample arrays for Y, Cr, and Cb components is a unit including a coding block of a luma sample, two corresponding coding blocks of chroma samples, and syntax structures used to encode the luma sample and the chroma samples. A coding unit of a case where a picture is a monochrome picture is a unit including a coding block of a monochrome sample and syntax structures used to encode the monochrome samples. A coding unit of a case where a picture is a picture encoded in color planes separated according to color components is a unit including syntax structures used to encode the picture and samples of the picture.

As described above, a largest coding block and a largest coding unit are conceptually distinguished from each other, and a coding block and a coding unit are conceptually distinguished from each other. That is, a (largest) coding unit refers to a data structure including a (largest) coding block including a corresponding sample and a syntax structure corresponding to the (largest) coding block. However, because it is understood by one of ordinary skill in the art that a (largest) coding unit or a (largest) coding block refers to a block of a preset size including a preset number of samples, a largest coding block and a largest coding unit, or a coding block and a coding unit are mentioned in the following specification without being distinguished unless otherwise described.

An image may be split into largest coding units (coding tree units (CTUs)). A size of each largest coding unit may be determined based on information obtained from a bitstream. A shape of each largest coding unit may be a square shape of the same size. However, the present disclosure is not limited thereto.

For example, information about a largest size of a luma coding block may be obtained from a bitstream. For example, the largest size of the luma coding block indicated by the information about the largest size of the luma coding block may be one of 4×4, 8×8, 16×16, 32×32, 64×64, 128×128, and 256×256.

For example, information about a luma block size difference and a largest size of a luma coding block that may be split into two may be obtained from a bitstream. The information about the luma block size difference may refer to a size difference between a luma largest coding unit and a largest luma coding block that may be split into two. Accordingly, when the information about the largest size of the luma coding block that may be split into two and the information about the luma block size difference obtained from the bitstream are combined with each other, a size of the luma largest coding unit may be determined. A size of a chroma largest coding unit may be determined by using the size of the luma largest coding unit. For example, when a Y:Cb:Cr ratio is 4:2:0 according to a color format, a size of a chroma block may be half a size of a luma block, and a size of a chroma largest coding unit may be half a size of a luma largest coding unit.

According to an embodiment, because information about a largest size of a luma coding block that is binary splittable is obtained from a bitstream, the largest size of the luma coding block that is binary splittable may be variably determined. In contrast, a largest size of a luma coding block that is ternary splittable may be fixed. For example, the largest size of the luma coding block that is ternary splittable in an I-picture may be 32×32, and the largest size of the luma coding block that is ternary splittable in a P-picture or a B-picture may be 64×64.

Also, a largest coding unit may be hierarchically split into coding units based on split shape mode information obtained from a bitstream. At least one of information indicating whether to perform quad splitting, information indicating whether to perform multi-splitting, split direction information, and split type information may be obtained as the split shape mode information from the bitstream.

For example, the information indicating whether to perform quad splitting may indicate whether a current coding unit is to be quad split (QUAD_SPLIT) or not.

When the current coding unit is not quad split, the information indicating whether to perform multi-splitting may indicate whether the current coding unit is to be no longer split (NO_SPLIT) or to be binary/ternary split.

When the current coding unit is binary split or ternary split, the split direction information indicates that the current coding unit is split in one of a horizontal direction and a vertical direction.

When the current coding unit is split in the horizontal direction or the vertical direction, the split type information indicates that the current coding unit is binary split or ternary split.

A split mode of the current coding unit may be determined according to the split direction information and the split type information. A split mode when the current coding unit is binary split in the horizontal direction may be determined to be a binary horizontal split mode (SPLIT_BT_HOR), a split mode when the current coding unit is ternary split in the horizontal direction may be determined to be a ternary horizontal split mode (SPLIT_TT_HOR), a split mode when the current coding unit is binary split in the vertical direction may be determined to be a binary vertical split mode (SPLIT_BT_VER), and a split mode when the current coding unit is ternary split in the vertical direction may be determined to be a ternary vertical split mode SPLIT_TT_VER.

The image decoding apparatus 100 may obtain, from the bitstream, the bin string of the split shape mode information. A form of the bitstream received by the image decoding apparatus 100 may include fixed length binary code, unary code, truncated unary code, pre-determined binary code, or the like. The bin string is information in a binary number. The bin string may include at least one bit. The image decoding apparatus 100 may obtain the split shape mode information corresponding to the bin string, based on the split rule. The image decoding apparatus 100 may determine whether to quad-split a coding unit, whether not to split a coding unit, a split direction, and a split type, based on one bin string.

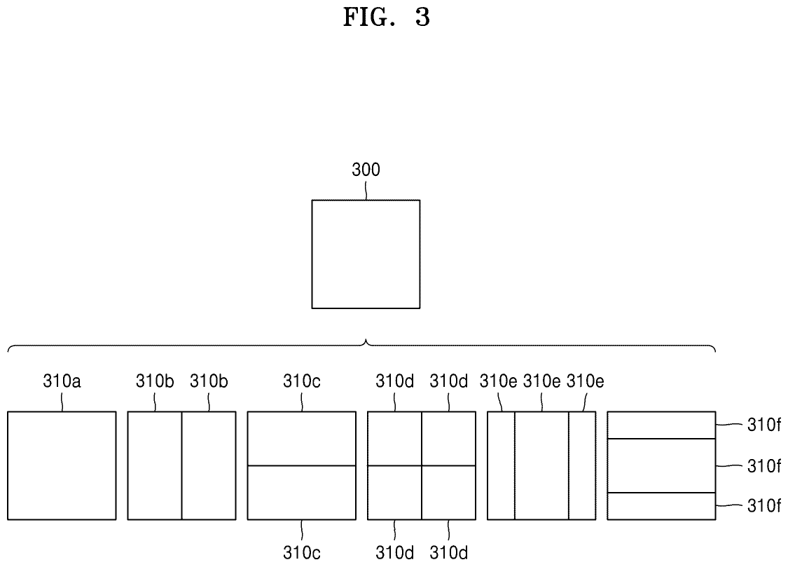

The coding unit may be smaller than or equal to the largest coding unit. For example, because a largest coding unit is a coding unit having a largest size, the largest coding unit is one of coding units. When split shape mode information about a largest coding unit indicates that splitting is not performed, a coding unit determined in the largest coding unit has the same size as that of the largest coding unit. When split shape mode information about a largest coding unit indicates that splitting is performed, the largest coding unit may be split into coding units. Also, when split shape mode information about a coding unit indicates that splitting is performed, the coding unit may be split into smaller coding units. However, the splitting of the image is not limited thereto, and the largest coding unit and the coding unit may not be distinguished. The splitting of the coding unit will be described in detail with reference to FIGS. 3 to 16.

Also, one or more prediction blocks for prediction may be determined from a coding unit. The prediction block may be equal to or smaller than the coding unit. Also, one or more transform blocks for transformation may be determined from a coding unit. The transform block may be equal to or smaller than the coding unit.

The shapes and sizes of the transform block and prediction block may not be related to each other.

In another embodiment, prediction may be performed by using a coding unit as a prediction unit. Also, transformation may be performed by using a coding unit as a transform block.

The splitting of the coding unit will be described in detail with reference to FIGS. 3 to 16. A current block and a neighboring block of the present disclosure may indicate one of the largest coding unit, the coding unit, the prediction block, and the transform block. Also, the current block of the current coding unit is a block that is currently being decoded or encoded or a block that is currently being split. The neighboring block may be a block reconstructed before the current block. The neighboring block may be spatially or temporally adjacent to the current block. The neighboring block may be located at one of bottom-left, left, top-left, top, top-right, right, bottom-right of the current block.

FIG. 3 illustrates a process, performed by the image decoding apparatus 100, of determining at least one coding unit by splitting a current coding unit, according to an embodiment.

A block shape may include 4N×4N, 4N×2N, 2N×4N, 4N×N, N×4N, 32N×N, N×32N, 16N×N, N×16N, 8N×N, or N×8N. Here, N may be a positive integer. Block shape information is information indicating at least one of a shape, a direction, a height to width ratio, or size of a coding unit.

The shape of the coding unit may include a square and a non-square. When the lengths of the width and height of the coding unit are the same (i.e., when the block shape of the coding unit is 4N×4N), the image decoding apparatus 100 may determine the block shape information of the coding unit to be a square. The image decoding apparatus 100 may determine the shape of the coding unit to be a non-square.

When the width and the height of the coding unit are different from each other (i.e., when the block shape of the coding unit is 4N×2N, 2N×4N, 4N×N, N×4N, 32N×N, N×32N, 16N×N, N×16N, 8N×N, or N×8N), the image decoding apparatus 100 may determine the block shape information of the coding unit to be a non-square shape. When the shape of the coding unit is non-square, the image decoding apparatus 100 may determine the height to width ratio among the block shape information of the coding unit to be at least one of 1:2, 2:1, 1:4, 4:1, 1:8, 8:1, 1:16, 16:1, 1:32, or 32:1. Also, the image decoding apparatus 100 may determine whether the coding unit is in a horizontal direction or a vertical direction, based on the length of the width and the length of the height of the coding unit. Also, the image decoding apparatus 100 may determine the size of the coding unit, based on at least one of the length of the width, the length of the height, or the area of the coding unit.

According to an embodiment, the image decoding apparatus 100 may determine the shape of the coding unit by using the block shape information, and may determine a splitting method of the coding unit by using the split shape mode information. That is, a coding unit splitting method indicated by the split shape mode information may be determined based on a block shape indicated by the block shape information used by the image decoding apparatus 100.

The image decoding apparatus 100 may obtain the split shape mode information from a bitstream. However, an embodiment is not limited thereto, and the image decoding apparatus 100 and the image encoding apparatus 200 may determine pre-agreed split shape mode information, based on the block shape information. The image decoding apparatus 100 may determine the pre-agreed split shape mode information with respect to a largest coding unit or a smallest coding unit. For example, the image decoding apparatus 100 may determine split shape mode information with respect to the largest coding unit to be a quad split. Also, the image decoding apparatus 100 may determine split shape mode information regarding the smallest coding unit to be “no split”. In particular, the image decoding apparatus 100 may determine the size of the largest coding unit to be 256×256. The image decoding apparatus 100 may determine the pre-agreed split shape mode information to be a quad split. The quad split is a split shape mode in which the width and the height of the coding unit are both bisected. The image decoding apparatus 100 may obtain a coding unit of a 128×128 size from the largest coding unit of a 256×256 size, based on the split shape mode information. Also, the image decoding apparatus 100 may determine the size of the smallest coding unit to be 4×4. The image decoding apparatus 100 may obtain split shape mode information indicating “no split” with respect to the smallest coding unit.

According to an embodiment, the image decoding apparatus 100 may use the block shape information indicating that the current coding unit has a square shape. For example, the image decoding apparatus 100 may determine whether not to split a square coding unit, whether to vertically split the square coding unit, whether to horizontally split the square coding unit, or whether to split the square coding unit into four coding units, based on the split shape mode information. Referring to FIG. 3, when the block shape information of a current coding unit 300 indicates a square shape, the decoder 120 may determine that a coding unit 310a having the same size as the current coding unit 300 is not split, based on the split shape mode information indicating no split, or may determine coding units 310b, 310c, 310d, 310e, 310f, etc. split based on the split shape mode information indicating a preset splitting method.

Referring to FIG. 3, according to an embodiment, the image decoding apparatus 100 may determine two coding units 310b obtained by splitting the current coding unit 300 in a vertical direction, based on the split shape mode information indicating to perform splitting in a vertical direction. The image decoding apparatus 100 may determine two coding units 310c obtained by splitting the current coding unit 300 in a horizontal direction, based on the split shape mode information indicating to perform splitting in a horizontal direction. The image decoding apparatus 100 may determine four coding units 310d obtained by splitting the current coding unit 300 in vertical and horizontal directions, based on the split shape mode information indicating to perform splitting in vertical and horizontal directions. According to an embodiment, the image decoding apparatus 100 may determine three coding units 310e obtained by splitting the current coding unit 300 in a vertical direction, based on the split shape mode information indicating to perform ternary-splitting in a vertical direction. The image decoding apparatus 100 may determine three coding units 310f obtained by splitting the current coding unit 300 in a horizontal direction, based on the split shape mode information indicating to perform ternary-splitting in a horizontal direction. However, splitting methods of the square coding unit are not limited to the above-described methods, and the split shape mode information may indicate various methods. Preset splitting methods of splitting the square coding unit will be described in detail below in relation to various embodiments.

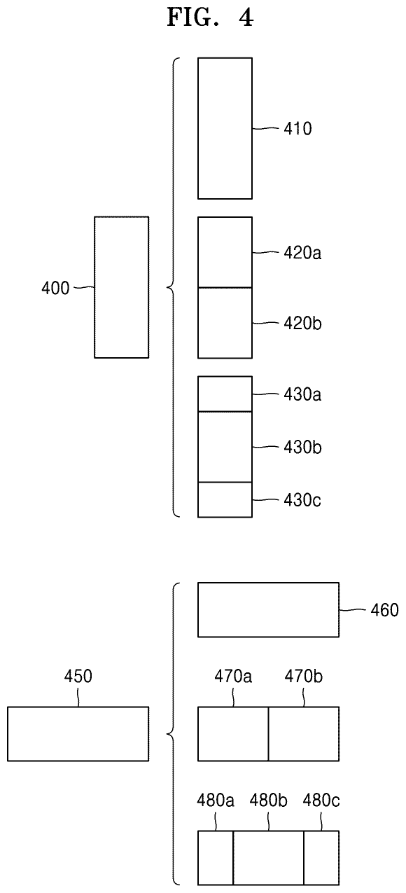

FIG. 4 illustrates a process, performed by the image decoding apparatus 100, of determining at least one coding unit by splitting a non-square coding unit, according to an embodiment.

According to an embodiment, the image decoding apparatus 100 may use block shape information indicating that a current coding unit has a non-square shape. The image decoding apparatus 100 may determine whether not to split the non-square current coding unit or whether to split the non-square current coding unit by using a preset splitting method, based on split shape mode information. Referring to FIG. 4, when the block shape information of a current coding unit 400 or 450 indicates a non-square shape, the image decoding apparatus 100 may determine that a coding unit 410 or 460 having the same size as the current coding unit 400 or 450 is not split, based on the split shape mode information indicating no split, or may determine coding units 420a, 420b, 430a, 430b, 430c, 470a, 470b, 480a, 480b, and 480c split based on the split shape mode information indicating a preset splitting method. Preset splitting methods of splitting a non-square coding unit will be described in detail below in relation to various embodiments.

According to an embodiment, the image decoding apparatus 100 may determine a splitting method of a coding unit by using the split shape mode information and, in this case, the split shape mode information may indicate the number of one or more coding units generated by splitting a coding unit. Referring to FIG. 4, when the split shape mode information indicates to split the current coding unit 400 or 450 into two coding units, the image decoding apparatus 100 may determine two coding units 420a and 420b, or 470a and 470b included in the current coding unit 400 or 450, by splitting the current coding unit 400 or 450 based on the split shape mode information.

According to an embodiment, when the image decoding apparatus 100 splits the non-square current coding unit 400 or 450 based on the split shape mode information, the image decoding apparatus 100 may consider the location of a long side of the non-square current coding unit 400 or 450 so as to split a current coding unit. For example, the image decoding apparatus 100 may determine a plurality of coding units by splitting the current coding unit 400 or 450 in a direction of splitting a long side of the current coding unit 400 or 450, in consideration of the shape of the current coding unit 400 or 450.

According to an embodiment, when the split shape mode information indicates to split (ternary-split) a coding unit into an odd number of blocks, the image decoding apparatus 100 may determine an odd number of coding units included in the current coding unit 400 or 450. For example, when the split shape mode information indicates to split the current coding unit 400 or 450 into three coding units, the image decoding apparatus 100 may split the current coding unit 400 or 450 into three coding units 430a, 430b, and 430c, or 480a, 480b, and 480c.

According to an embodiment, a height to width ratio of the current coding unit 400 or 450 may be 4:1 or 1:4. When the height to width ratio is 4:1, the block shape information may be a horizontal direction because the length of the width is longer than the length of the height. When the height to width ratio is 1:4, the block shape information may be a vertical direction because the length of the width is shorter than the length of the height. The image decoding apparatus 100 may determine to split a current coding unit into the odd number of blocks, based on the split shape mode information. Also, the image decoding apparatus 100 may determine a split direction of the current coding unit 400 or 450, based on the block shape information of the current coding unit 400 or 450. For example, when the current coding unit 400 is in the vertical direction, the image decoding apparatus 100 may determine the coding units 430a, 430b, and 430c by splitting the current coding unit 400 in the horizontal direction. Also, when the current coding unit 450 is in the horizontal direction, the image decoding apparatus 100 may determine the coding units 480a, 480b, and 480c by splitting the current coding unit 450 in the vertical direction.

According to an embodiment, the image decoding apparatus 100 may determine the odd number of coding units included in the current coding unit 400 or 450, and not all the determined coding units may have the same size. For example, a preset coding unit 430b or 480b from among the determined odd number of coding units 430a, 430b, and 430c, or 480a, 480b, and 480c may have a size different from the size of the other coding units 430a and 430c, or 480a and 480c. That is, coding units that may be determined by splitting the current coding unit 400 or 450 may have multiple sizes and, in some cases, all of the odd number of coding units 430a, 430b, and 430c, or 480a, 480b, and 480c may have different sizes.

According to an embodiment, when the split shape mode information indicates to split a coding unit into the odd number of blocks, the image decoding apparatus 100 may determine the odd number of coding units included in the current coding unit 400 or 450, and in addition, may put a preset restriction on at least one coding unit from among the odd number of coding units generated by splitting the current coding unit 400 or 450. Referring to FIG. 4, the image decoding apparatus 100 may set a decoding process regarding the coding unit 430b or 480b to be different from that of the other coding units 430a and 430c, or 480a or 480c, the coding unit 430b or 480b being located at the center among the three coding units 430a, 430b, and 430c or 480a, 480b, and 480c generated as the current coding unit 400 or 450 is split. For example, the image decoding apparatus 100 may restrict the coding unit 430b or 480b at the center location to be no longer split or to be split only a preset number of times, unlike the other coding units 430a and 430c, or 480a and 480c.

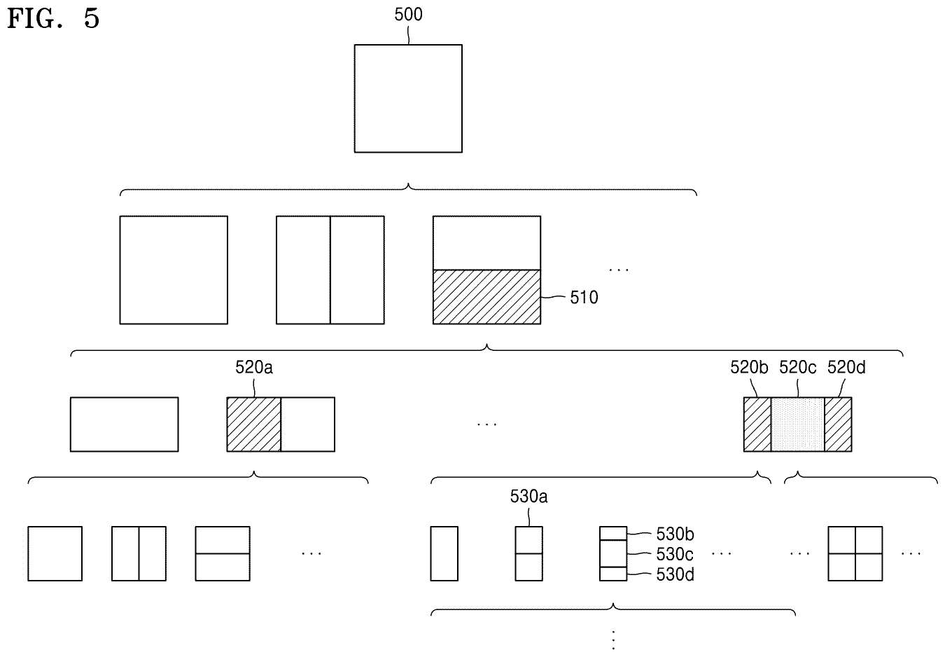

FIG. 5 illustrates a process, performed by the image decoding apparatus 100, of splitting a coding unit based on at least one of block shape information and split shape mode information, according to an embodiment.

According to an embodiment, the image decoding apparatus 100 may determine to split or not to split a square first coding unit 500 into coding units, based on at least one of the block shape information and the split shape mode information. According to an embodiment, when the split shape mode information indicates to split the first coding unit 500 in a horizontal direction, the image decoding apparatus 100 may determine a second coding unit 510 by splitting the first coding unit 500 in a horizontal direction. A first coding unit, a second coding unit, and a third coding unit used according to an embodiment are terms used to understand a relation before and after a coding unit is split. For example, a second coding unit may be determined by splitting a first coding unit, and a third coding unit may be determined by splitting the second coding unit. Hereinafter, it will be understood that the structure of the first coding unit, the second coding unit, and the third coding unit follows the above descriptions.

According to an embodiment, the image decoding apparatus 100 may determine to split or not to split the determined second coding unit 510 into coding units, based on the split shape mode information. Referring to FIG. 5, the image decoding apparatus 100 may or may not split the non-square second coding unit 510, which is determined by splitting the first coding unit 500, into one or more third coding units 520a, or 520b, 520c, and 520d based on the split shape mode information. The image decoding apparatus 100 may obtain the split shape mode information, and may obtain a plurality of various-shaped second coding units (e.g., the second coding unit 510) by splitting the first coding unit 500, based on the obtained split shape mode information, and the second coding unit 510 may be split by using a splitting method of the first coding unit 500 based on the split shape mode information. According to an embodiment, when the first coding unit 500 is split into the second coding units 510 based on the split shape mode information of the first coding unit 500, the second coding unit 510 may also be split into the third coding units (e.g., 520a, or 520b, 520c, and 520d) based on the split shape mode information of the second coding unit 510. That is, a coding unit may be recursively split based on the split shape mode information of each coding unit. Therefore, a square coding unit may be determined by splitting a non-square coding unit, and a non-square coding unit may be determined by recursively splitting the square coding unit.

Referring to FIG. 5, a preset coding unit from among the odd number of third coding units 520b, 520c, and 520d determined by splitting the non-square second coding unit 510 (e.g., a coding unit at a center location or a square coding unit) may be recursively split. According to an embodiment, the square third coding unit 520b from among the odd number of third coding units 520b, 520c, and 520d may be split in a horizontal direction into a plurality of fourth coding units. A non-square fourth coding unit 530b or 530d from among a plurality of fourth coding units 530a, 530b, 530c, and 530d may be split into a plurality of coding units again. For example, the non-square fourth coding unit 530b or 530d may be split into the odd number of coding units again. A method that may be used to recursively split a coding unit will be described below in relation to various embodiments.

According to an embodiment, the image decoding apparatus 100 may split each of the third coding units 520a, or 520b, 520c, and 520d into coding units, based on the split shape mode information. Also, the image decoding apparatus 100 may determine not to split the second coding unit 510 based on the split shape mode information. According to an embodiment, the image decoding apparatus 100 may split the non-square second coding unit 510 into the odd number of third coding units 520b, 520c, and 520d. The image decoding apparatus 100 may put a preset restriction on a preset third coding unit from among the odd number of third coding units 520b, 520c, and 520d. For example, the image decoding apparatus 100 may restrict the third coding unit 520c at a center location from among the odd number of third coding units 520b, 520c, and 520d to be no longer split or to be split a settable number of times.

Referring to FIG. 5, the image decoding apparatus 100 may restrict the third coding unit 520c, which is at the center location from among the odd number of third coding units 520b, 520c, and 520d included in the non-square second coding unit 510, to be no longer split, to be split by using a preset splitting method (e.g., split into only four coding units or split by using a splitting method of the second coding unit 510), or to be split only a preset number of times (e.g., split only n times (where n>0)). However, the restrictions on the third coding unit 520c at the center location are not limited to the above-described examples, and may include various restrictions for decoding the third coding unit 520c at the center location differently from the other third coding units 520b and 520d.

According to an embodiment, the image decoding apparatus 100 may obtain the split shape mode information, which is used to split a current coding unit, from a preset location in the current coding unit.

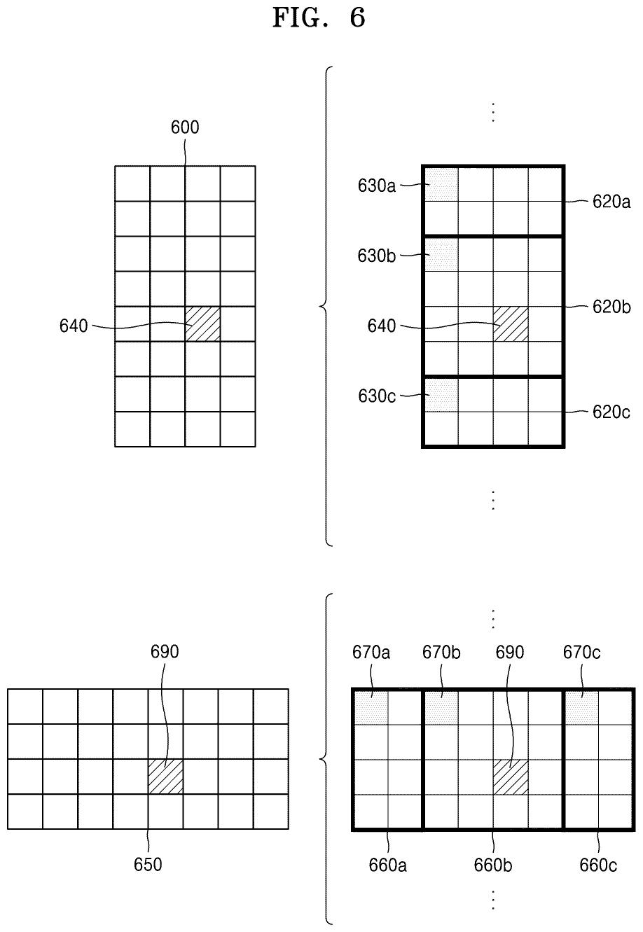

FIG. 6 illustrates a method, performed by the image decoding apparatus 100, of determining a preset coding unit from among an odd number of coding units, according to an embodiment.

Referring to FIG. 6, split shape mode information of a current coding unit 600 or 650 may be obtained from a sample of a preset location (e.g., a sample 640 or 690 of a center location) from among a plurality of samples included in the current coding unit 600 or 650. However, the preset location in the current coding unit 600, from which at least one piece of the split shape mode information may be obtained, is not limited to the center location in FIG. 6, and may include various locations included in the current coding unit 600 (e.g., top, bottom, left, right, top-left, bottom-left, top-right, and bottom-right locations). The image decoding apparatus 100 may obtain the split shape mode information from the preset location and may determine to split or not to split the current coding unit into various-shaped and various-sized coding units.

According to an embodiment, when the current coding unit is split into a preset number of coding units, the image decoding apparatus 100 may select one of the coding units. Various methods may be used to select one of a plurality of coding units, and descriptions of the methods will be described below in relation to various embodiments.

According to an embodiment, the image decoding apparatus 100 may split the current coding unit into a plurality of coding units, and may determine a coding unit at a preset location.

According to an embodiment, image decoding apparatus 100 may use information indicating locations of the odd number of coding units so as to determine a coding unit at a center location from among the odd number of coding units. Referring to FIG. 6, the image decoding apparatus 100 may determine the odd number of coding units 620a, 620b, and 620c or the odd number of coding units 660a, 660b, and 660c by splitting the current coding unit 600 or the current coding unit 650. The image decoding apparatus 100 may determine the middle coding unit 620b or the middle coding unit 660b by using information about the locations of the odd number of coding units 620a, 620b, and 620c or the odd number of coding units 660a, 660b, and 660c. For example, the image decoding apparatus 100 may determine the coding unit 620b of the center location by determining the locations of the coding units 620a, 620b, and 620c based on information indicating locations of preset samples included in the coding units 620a, 620b, and 620c. In detail, the image decoding apparatus 100 may determine the coding unit 620b at the center location by determining the locations of the coding units 620a, 620b, and 620c based on information indicating locations of top-left samples 630a, 630b, and 630c of the coding units 620a, 620b, and 620c.

According to an embodiment, the information indicating the locations of the top-left samples 630a, 630b, and 630c, which are included in the coding units 620a, 620b, and 620c, respectively, may include information about locations or coordinates of the coding units 620a, 620b, and 620c in a picture. According to an embodiment, the information indicating the locations of the top-left samples 630a, 630b, and 630c, which are included in the coding units 620a, 620b, and 620c, respectively, may include information indicating widths or heights of the coding units 620a, 620b, and 620c included in the current coding unit 600, and the widths or heights may correspond to information indicating differences between the coordinates of the coding units 620a, 620b, and 620c in the picture. That is, the image decoding apparatus 100 may determine the coding unit 620b at the center location by directly using the information about the locations or coordinates of the coding units 620a, 620b, and 620c in the picture, or by using the information about the widths or heights of the coding units, which correspond to the difference values between the coordinates.

According to an embodiment, information indicating the location of the top-left sample 630a of the upper coding unit 620a may include coordinates (xa, ya), information indicating the location of the top-left sample 630b of the middle coding unit 620b may include coordinates (xb, yb), and information indicating the location of the top-left sample 630c of the lower coding unit 620c may include coordinates (xc, yc). The image decoding apparatus 100 may determine the middle coding unit 620b by using the coordinates of the top-left samples 630a, 630b, and 630c which are included in the coding units 620a, 620b, and 620c, respectively. For example, when the coordinates of the top-left samples 630a, 630b, and 630c are sorted in an ascending or descending order, the coding unit 620b including the coordinates (xb, yb) of the sample 630b at a center location may be determined as a coding unit at a center location from among the coding units 620a, 620b, and 620c determined by splitting the current coding unit 600. However, the coordinates indicating the locations of the top-left samples 630a, 630b, and 630c may include coordinates indicating absolute locations in the picture, or may use coordinates (dxb, dyb) indicating a relative location of the top-left sample 630b of the middle coding unit 620b and coordinates (dxc, dyc) indicating a relative location of the top-left sample 630c of the lower coding unit 620c with reference to the location of the top-left sample 630a of the upper coding unit 620a. A method of determining a coding unit at a preset location by using coordinates of a sample included in the coding unit, as information indicating a location of the sample, is not limited to the above-described method, and may include various arithmetic methods of using the coordinates of the sample.

According to an embodiment, the image decoding apparatus 100 may split the current coding unit 600 into a plurality of coding units 620a, 620b, and 620c, and may select one of the coding units 620a, 620b, and 620c based on a preset criterion. For example, the image decoding apparatus 100 may select the coding unit 620b that has a size different from that of the others, from among the coding units 620a, 620b, and 620c.

According to an embodiment, the image decoding apparatus 100 may determine the width or height of each of the coding units 620a, 620b, and 620c by using the coordinates (xa, ya) that is the information indicating the location of the top-left sample 630a of the upper coding unit 620a, the coordinates (xb, yb) that is the information indicating the location of the top-left sample 630b of the middle coding unit 620b, and the coordinates (xc, yc) that is the information indicating the location of the top-left sample 630c of the lower coding unit 620c. The image decoding apparatus 100 may determine the respective sizes of the coding units 620a, 620b, and 620c by using the coordinates (xa, ya), (xb, yb), and (xc, yc) indicating the locations of the coding units 620a, 620b, and 620c. According to an embodiment, the image decoding apparatus 100 may determine the width of the upper coding unit 620a to be the width of the current coding unit 600. The image decoding apparatus 100 may determine the height of the upper coding unit 620a to be yb-ya. According to an embodiment, the image decoding apparatus 100 may determine the width of the middle coding unit 620b to be the width of the current coding unit 600. The image decoding apparatus 100 may determine the height of the middle coding unit 620b to be yc-yb. According to an embodiment, the image decoding apparatus 100 may determine the width or height of the lower coding unit by using the width or height of the current coding unit or the widths or heights of the upper and middle coding units 620a and 620b. The image decoding apparatus 100 may determine a coding unit that has a size different from that of the others, based on the determined widths and heights of the coding units 620a, 620b, and 620c. Referring to FIG. 6, the image decoding apparatus 100 may determine the middle coding unit 620b that has a size different from the size of the upper and lower coding units 620a and 620c, as the coding unit of the preset location. However, the above-described method, performed by the image decoding apparatus 100, of determining a coding unit having a size different from the size of the other coding units merely corresponds to an example of determining a coding unit at a preset location by using the sizes of coding units that are determined based on coordinates of samples, and thus, various methods of determining a coding unit at a preset location by comparing the sizes of coding units that are determined based on coordinates of preset samples may be used.

The image decoding apparatus 100 may determine the width or height of each of the coding units 660a, 660b, and 660c by using the coordinates (xd, yd) that is information indicating the location of a top-left sample 670a of the left coding unit 660a, the coordinates (xe, ye) that is information indicating the location of a top-left sample 670b of the middle coding unit 660b, and the coordinates (xf, yf) that is information indicating a location of the top-left sample 670c of the right coding unit 660c. The image decoding apparatus 100 may determine the respective sizes of the coding units 660a, 660b, and 660c by using the coordinates (xd, yd), (xe, ye), and (xf, yf) indicating the locations of the coding units 660a, 660b, and 660c.

According to an embodiment, the image decoding apparatus 100 may determine the width of the left coding unit 660a to be xe-xd. The image decoding apparatus 100 may determine the height of the left coding unit 660a to be the height of the current coding unit 650. According to an embodiment, the image decoding apparatus 100 may determine the width of the middle coding unit 660b to be xf-xe. The image decoding apparatus 100 may determine the height of the middle coding unit 660b to be the height of the current coding unit 600. According to an embodiment, the image decoding apparatus 100 may determine the width or height of the right coding unit 660c by using the width or height of the current coding unit 650 or the widths or heights of the left and middle coding units 660a and 660b. The image decoding apparatus 100 may determine a coding unit that has a size different from that of the others, based on the determined widths and heights of the coding units 660a, 660b, and 660c. Referring to FIG. 6, the image decoding apparatus 100 may determine the middle coding unit 660b that has a size different from the sizes of the left and right coding units 660a and 660c, as the coding unit of the certain location. However, the above-described method, performed by the image decoding apparatus 100, of determining a coding unit having a size different from the size of the other coding units merely corresponds to an example of determining a coding unit at a preset location by using the sizes of coding units that are determined based on coordinates of samples, and thus, various methods of determining a coding unit at a preset location by comparing the sizes of coding units that are determined based on coordinates of certain samples may be used.

However, locations of samples considered to determine locations of coding units are not limited to the above-described top-left locations, and information about arbitrary locations of samples included in the coding units may be used.

According to an embodiment, the image decoding apparatus 100 may select a coding unit at a preset location from among an odd number of coding units determined by splitting the current coding unit, by considering the shape of the current coding unit. For example, when the current coding unit has a non-square shape, a width of which is longer than a height, the image decoding apparatus 100 may determine the coding unit at the preset location in a horizontal direction. That is, the image decoding apparatus 100 may determine one of coding units at different locations in a horizontal direction and may put a restriction on the coding unit. When the current coding unit has a non-square shape, a height of which is longer than a width, the image decoding apparatus 100 may determine the coding unit at the preset location in a vertical direction. That is, the image decoding apparatus 100 may determine one of coding units at different locations in a vertical direction and may put a restriction on the coding unit.

According to an embodiment, the image decoding apparatus 100 may use information indicating respective locations of an even number of coding units so as to determine the coding unit at the preset location from among the even number of coding units. The image decoding apparatus 100 may determine an even number of coding units by splitting (binary-splitting) the current coding unit, and may determine the coding unit at the preset location by using the information about the locations of the even number of coding units. An operation related thereto may correspond to the operation of determining a coding unit at a preset location (e.g., a center location) from among an odd number of coding units, which has been described in detail above in relation to FIG. 6, and thus, detailed descriptions thereof are not provided here.

According to an embodiment, when a non-square current coding unit is split into a plurality of coding units, preset information about a coding unit at a preset location may be used in a splitting operation to determine the coding unit at the preset location from among the plurality of coding units. For example, the image decoding apparatus 100 may use at least one of block shape information and split shape mode information, which is stored in a sample included in a middle coding unit, in a splitting operation to determine a coding unit at a center location from among the plurality of coding units determined by splitting the current coding unit.

Referring to FIG. 6, the image decoding apparatus 100 may split the current coding unit 600 into the plurality of coding units 620a, 620b, and 620c based on the split shape mode information, and may determine the coding unit 620b at a center location from among the plurality of the coding units 620a, 620b, and 620c. Furthermore, the image decoding apparatus 100 may determine the coding unit 620b at the center location, in consideration of a location from which the split shape mode information is obtained. That is, the split shape mode information of the current coding unit 600 may be obtained from the sample 640 at a center location of the current coding unit 600 and, when the current coding unit 600 is split into the plurality of coding units 620a, 620b, and 620c based on the split shape mode information, the coding unit 620b including the sample 640 may be determined as the coding unit at the center location. However, information used to determine the coding unit at the center location is not limited to the split shape mode information, and various types of information may be used to determine the coding unit at the center location.

According to an embodiment, preset information for identifying the coding unit at the preset location may be obtained from a preset sample included in a coding unit to be determined. Referring to FIG. 6, the image decoding apparatus 100 may use the split shape mode information that is obtained from a sample at a preset location in the current coding unit 600 (e.g., a sample at a center location of the current coding unit 600) to determine a coding unit at a preset location from among the plurality of the coding units 620a, 620b, and 620c determined by splitting the current coding unit 600 (e.g., a coding unit at a center location from among a plurality of split coding units). That is, the image decoding apparatus 100 may determine the sample at the preset location by considering a block shape of the current coding unit 600, may determine the coding unit 620b including a sample, from which certain information (e.g., the split shape mode information) may be obtained, from among the plurality of coding units 620a, 620b, and 620c determined by splitting the current coding unit 600, and may put a preset restriction on the coding unit 620b. Referring to FIG. 6, according to an embodiment, the image decoding apparatus 100 may determine the sample 640 at the center location of the current coding unit 600 as the sample from which the preset information may be obtained, and may put a preset restriction on the coding unit 620b including the sample 640, in a decoding operation. However, the location of the sample from which the preset information may be obtained is not limited to the above-described location, and may include arbitrary locations of samples included in the coding unit 620b to be determined for a restriction.

According to an embodiment, the location of the sample from which the preset information may be obtained may be determined based on the shape of the current coding unit 600. According to an embodiment, the block shape information may indicate whether the current coding unit has a square or non-square shape, and the location of the sample from which the preset information may be obtained may be determined based on the shape. For example, the image decoding apparatus 100 may determine a sample located on a boundary for splitting at least one of a width and height of the current coding unit in half, as the sample from which the preset information may be obtained, by using at least one of information about the width of the current coding unit and information about the height of the current coding unit. As another example, when the block shape information of the current coding unit indicates a non-square shape, the image decoding apparatus 100 may determine one of samples adjacent to a boundary for splitting a long side of the current coding unit in half, as the sample from which the preset information may be obtained.

According to an embodiment, when the current coding unit is split into a plurality of coding units, the image decoding apparatus 100 may use the split shape mode information so as to determine a coding unit at a preset location from among the plurality of coding units. According to an embodiment, the image decoding apparatus 100 may obtain the split shape mode information from a sample at a preset location in a coding unit, and may split the plurality of coding units, which are generated by splitting the current coding unit, by using the split shape mode information, which is obtained from the sample of the preset location in each of the plurality of coding units. That is, a coding unit may be recursively split based on the split shape mode information that is obtained from the sample at the preset location in each coding unit. An operation of recursively splitting a coding unit has been described above in relation to FIG. 5, and thus, detailed descriptions thereof are not provided here.

According to an embodiment, the image decoding apparatus 100 may determine one or more coding units by splitting the current coding unit, and may determine an order of decoding the one or more coding units, based on a preset block (e.g., the current coding unit).

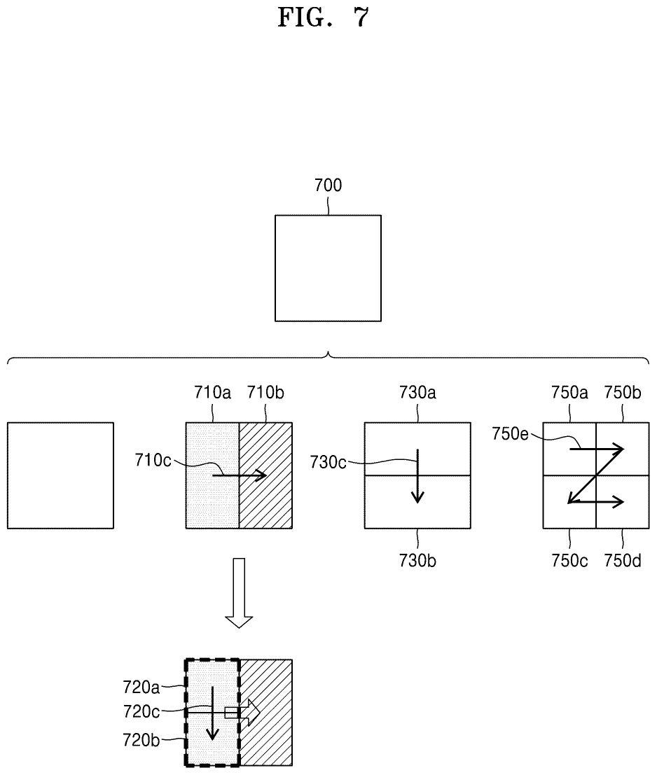

FIG. 7 illustrates an order of processing a plurality of coding units when the image decoding apparatus 100 determines the plurality of coding units by splitting a current coding unit, according to an embodiment.

According to an embodiment, the image decoding apparatus 100 may determine second coding units 710a and 710b by splitting a first coding unit 700 in a vertical direction, may determine second coding units 730a and 730b by splitting the first coding unit 700 in a horizontal direction, or may determine second coding units 750a, 750b, 750c, and 750d by splitting the first coding unit 700 in vertical and horizontal directions, based on split shape mode information.

Referring to FIG. 7, the image decoding apparatus 100 may determine to process the second coding units 710a and 710b that are determined by splitting the first coding unit 700 in a vertical direction, in a horizontal direction order 710c. The image decoding apparatus 100 may determine to process the second coding units 730a and 730b that are determined by splitting the first coding unit 700 in a horizontal direction, in a vertical direction order 730c. The image decoding apparatus 100 may determine to process the second coding units 750a, 750b, 750c, and 750d that are determined by splitting the first coding unit 700 in vertical and horizontal directions, in a preset order for processing coding units in a row and then processing coding units in a next row (e.g., in a raster scan order or Z-scan order 750e).

According to an embodiment, the image decoding apparatus 100 may recursively split coding units. Referring to FIG. 7, the image decoding apparatus 100 may determine the plurality of coding units 710a, 710b, 730a, 730b, 750a, 750b, 750c, and 750d by splitting the first coding unit 700, and may recursively split each of the determined plurality of coding units 710a, 710b, 730a, 730b, 750a, 750b, 750c, and 750d. A splitting method of the plurality of coding units 710a, 710b, 730a, 730b, 750a, 750b, 750c, and 750d may correspond to a splitting method of the first coding unit 700. Accordingly, each of the plurality of coding units 710a, 710b, 730a, 730b, 750a, 750b, 750c, and 750d may be independently split into a plurality of coding units. Referring to FIG. 7, the image decoding apparatus 100 may determine the second coding units 710a and 710b by splitting the first coding unit 700 in a vertical direction, and may determine to independently split or not to split each of the second coding units 710a and 710b.

According to an embodiment, the image decoding apparatus 100 may determine third coding units 720a and 720b by splitting the left second coding unit 710a in a horizontal direction, and may not split the right second coding unit 710b.

According to an embodiment, a processing order of coding units may be determined based on an operation of splitting a coding unit. In other words, a processing order of split coding units may be determined based on a processing order of coding units immediately before being split. The image decoding apparatus 100 may determine a processing order of the third coding units 720a and 720b determined by splitting the left second coding unit 710a, independently of the right second coding unit 710b. Because the third coding units 720a and 720b are determined by splitting the left second coding unit 710a in a horizontal direction, the third coding units 720a and 720b may be processed in a vertical direction order 720c. As the left and right second coding units 710a and 710b are processed in the horizontal direction order 710c, the right second coding unit 710b may be processed after the third coding units 720a and 720b included in the left second coding unit 710a are processed in the vertical direction order 720c. An operation of determining a processing order of coding units based on a coding unit before being split is not limited to the above-described example, and it should be understood that various methods may be used to independently process coding units that are split and determined to various shapes, in a preset order.

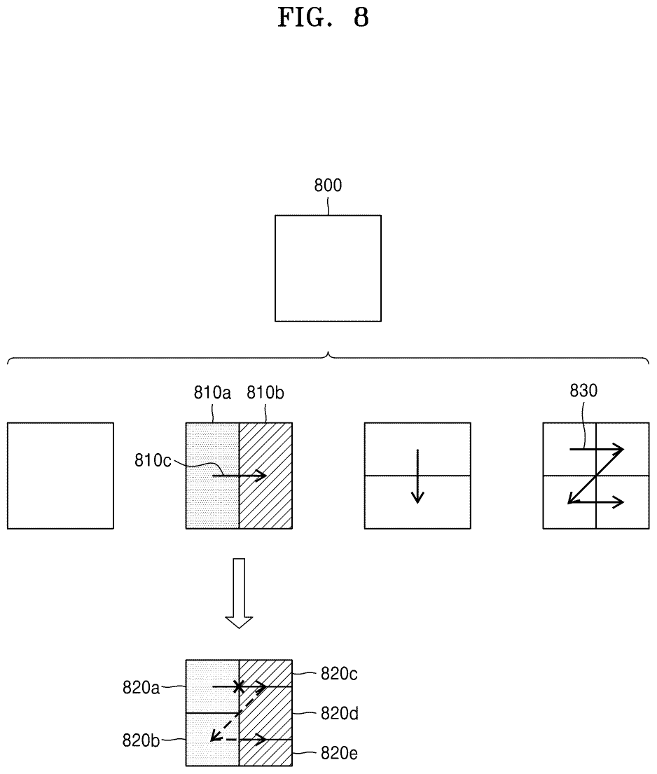

FIG. 8 illustrates a process, performed by the image decoding apparatus 100, of determining that a current coding unit is to be split into an odd number of coding units, when the coding units are not processable in a preset order, according to an embodiment.

According to an embodiment, the image decoding apparatus 100 may determine whether the current coding unit is split into an odd number of coding units, based on obtained split shape mode information. Referring to FIG. 8, a square first coding unit 800 may be split into non-square second coding units 810a and 810b in the direction order 810c, and the second coding units 810a and 810b may be independently split into third coding units 820a and 820b, and 820c, 820d and 820e. According to an embodiment, the image decoding apparatus 100 may determine the plurality of third coding units 820a and 820b by splitting the left second coding unit 810a in a horizontal direction, and may split the right second coding unit 810b into the odd number of third coding units 820c to 820e.

According to an embodiment, the image decoding apparatus 100 may determine whether that is any coding unit being split into an odd number of coding units, by determining whether the third coding units 820a and 820b, and 820c, 820d, and 820e are processable in a preset order. Referring to FIG. 8, the image decoding apparatus 100 may determine the third coding units 820a and 820b, and 820c, 820d and 820e by recursively splitting the first coding unit 800. The image decoding apparatus 100 may determine whether any of the first coding unit 800, the second coding units 810a and 810b, and the third coding units 820a and 820b, and 820c, 820d and 820e are split into an odd number of coding units, based on at least one of the block shape information and the split shape mode information. For example, the right second coding unit 810b among the second coding units 810a and 810b may be split into an odd number of third coding units 820c, 820d, and 820e. A processing order of a plurality of coding units included in the first coding unit 800 may be a preset order (e.g., a Z-scan order 830), and the image decoding apparatus 100 may determine whether the third coding units 820c, 820d, and 820e, which are determined by splitting the right second coding unit 810b into an odd number of coding units, satisfy a condition for processing in the preset order.

According to an embodiment, the image decoding apparatus 100 may determine whether the third coding units 820a and 820b, and 820c, 820d and 820e included in the first coding unit 800 satisfy the condition for processing in the preset order, and the condition relates to whether at least one of a width and height of the second coding units 810a and 810b is split in half along a boundary of the third coding units 820a and 820b, and 820c, 820d and 820e. For example, the third coding units 820a and 820b that are determined when the height of the left second coding unit 810a of the non-square shape is split in half may satisfy the condition. It may be determined that the third coding units 820c, 820d, and 820e do not satisfy the condition because the boundaries of the third coding units 820c, 820d, and 820e that are determined when the right second coding unit 810b is split into three coding units are unable to split the width or height of the right second coding unit 810b in half. When the condition is not satisfied as described above, the image decoding apparatus 100 may determine disconnection of a scan order, and may determine that the right second coding unit 810b is split into an odd number of coding units, based on a result of the determination. According to an embodiment, when a coding unit is split into an odd number of coding units, the image decoding apparatus 100 may put a preset restriction on a coding unit at a preset location from among the split coding units, and the restriction or the preset location is described above in relation to various embodiments, and thus, detailed descriptions thereof are not provided here.

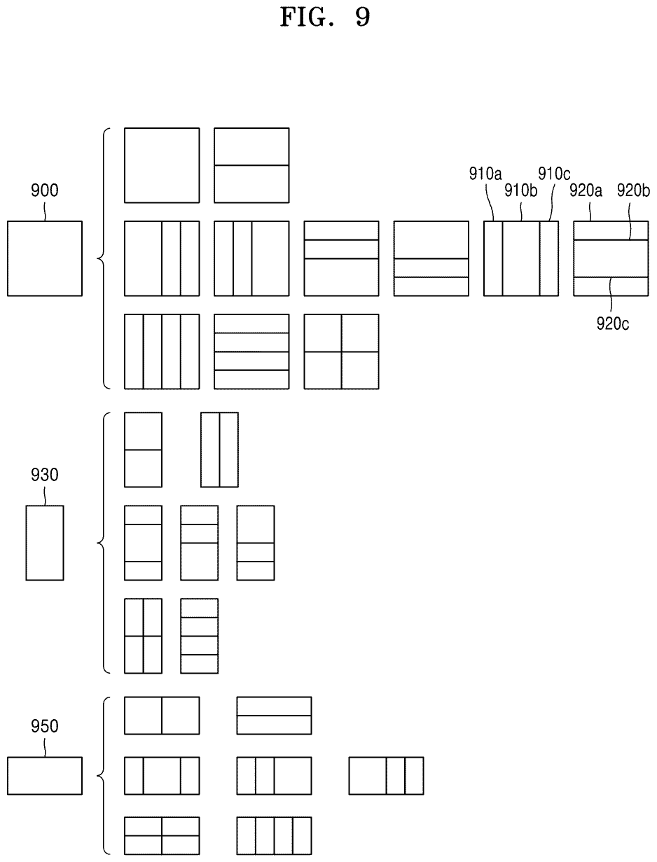

FIG. 9 illustrates a process, performed by the image decoding apparatus 100, of determining at least one coding unit by splitting a first coding unit 900, according to an embodiment.

According to an embodiment, the image decoding apparatus 100 may split the first coding unit 900, based on split shape mode information obtained via the bitstream obtainer 110. The square first coding unit 900 may be split into four square coding units, or may be split into a plurality of non-square coding units. For example, referring to FIG. 9, when the split shape mode information indicates to split the first coding unit 900 into non-square coding units, the image decoding apparatus 100 may split the first coding unit 900 into a plurality of non-square coding units. In detail, when the split shape mode information indicates to determine an odd number of coding units by splitting the first coding unit 900 in a horizontal direction or a vertical direction, the image decoding apparatus 100 may split the square first coding unit 900 into an odd number of coding units that are second coding units 910a, 910b, and 910c determined by splitting the square first coding unit 900 in a vertical direction or second coding units 920a, 920b, and 920c determined by splitting the square first coding unit 900 in a horizontal direction.

According to an embodiment, the image decoding apparatus 100 may determine whether the second coding units 910a, 910b, 910c, 920a, 920b, and 920c included in the first coding unit 900 satisfy a condition for processing in a preset order, and the condition relates to whether at least one of a width and height of the first coding unit 900 is split in half along a boundary of the second coding units 910a, 910b, 910c, 920a, 920b, and 920c. Referring to FIG. 9, as boundaries of the second coding units 910a, 910b, and 910c determined by splitting the square first coding unit 900 in a vertical direction do not split the width of the first coding unit 900 in half, it may be determined that the first coding unit 900 does not satisfy the condition for processing in the preset order. In addition, as boundaries of the second coding units 920a, 920b, and 920c determined by splitting the square first coding unit 900 in a horizontal direction do not split the height of the first coding unit 900 in half, it may be determined that the first coding unit 900 does not satisfy the condition for processing in the preset order. When the condition is not satisfied as described above, the image decoding apparatus 100 may determine disconnection of a scan order, and may determine that the first coding unit 900 is split into an odd number of coding units, based on a result of the determination. According to an embodiment, when a coding unit is split into an odd number of coding units, the image decoding apparatus 100 may put a preset restriction on a coding unit at a preset location from among the split coding units, and the restriction or the preset location is described above in relation to various embodiments, and thus, detailed descriptions thereof are not provided here.

According to an embodiment, the image decoding apparatus 100 may determine various-shaped coding units by splitting a first coding unit.

Referring to FIG. 9, the image decoding apparatus 100 may split the square first coding unit 900 or a non-square first coding unit 930 or 950 into various-shaped coding units.

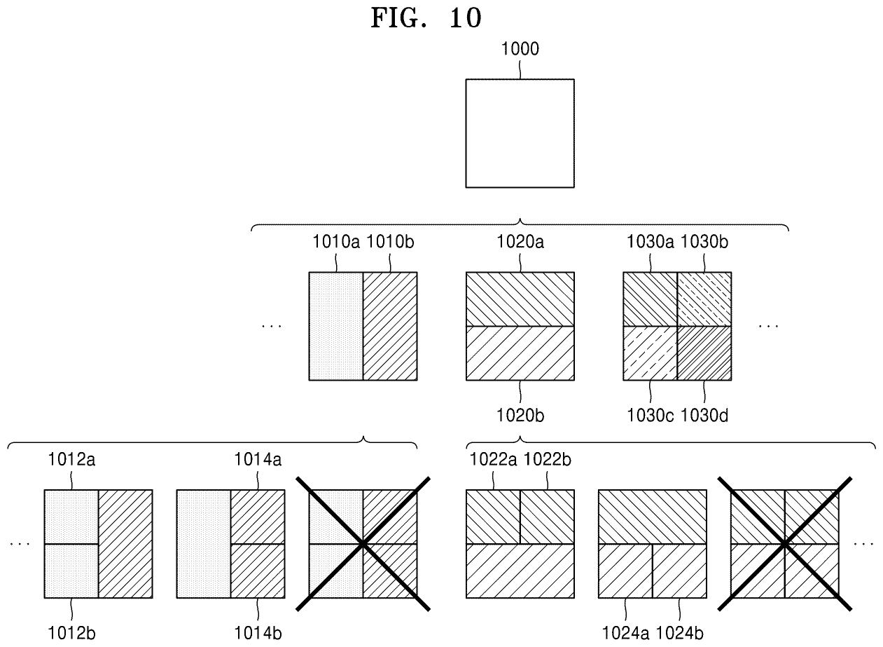

FIG. 10 illustrates that a shape into which a second coding unit is splittable is restricted when the second coding unit having a non-square shape, which is determined when the image decoding apparatus 100 splits a first coding unit 1000, satisfies a preset condition, according to an embodiment.

According to an embodiment, the image decoding apparatus 100 may determine to split the square first coding unit 1000 into non-square second coding units 1010a, 1010b, 1020a, and 1020b, based on split shape mode information obtained via the bitstream obtainer 110. The second coding units 1010a, 1010b, 1020a, and 1020b may be independently split. Accordingly, the image decoding apparatus 100 may determine to split or not to split each of the second coding units 1010a, 1010b, 1020a, and 1020b into a plurality of coding units, based on the split shape mode information of each of the second coding units 1010a, 1010b, 1020a, and 1020b. According to an embodiment, the image decoding apparatus 100 may determine third coding units 1012a and 1012b by splitting the non-square left second coding unit 1010a that is determined by splitting the first coding unit 1000 in a vertical direction, in a horizontal direction. However, when the left second coding unit 1010a is split in a horizontal direction, the image decoding apparatus 100 may restrict the right second coding unit 1010b not to be split in a horizontal direction in which the left second coding unit 1010a is split. When third coding units 1014a and 1014b are determined by splitting the right second coding unit 1010b in a same direction, the third coding units 1012a and 1012b or 1014a and 1014b may be determined in a manner that the left and right second coding units 1010a and 1010b are independently split in a horizontal direction. However, this case serves equally as a case in which the image decoding apparatus 100 splits the first coding unit 1000 into four square second coding units 1030a, 1030b, 1030c, and 1030d, based on the split shape mode information, and may be inefficient in terms of image decoding.

According to an embodiment, the image decoding apparatus 100 may determine third coding units 1022a and 1022b or 1024a and 1024b by splitting the non-square second coding unit 1020a or 1020b which is determined by splitting the first coding unit 1000 in a horizontal direction, in a vertical direction. However, when a second coding unit (e.g., the upper second coding unit 1020a) is split in a vertical direction, for the above-described reason, the image decoding apparatus 100 may restrict the other second coding unit (e.g., the lower second coding unit 1020b) not to be split in a vertical direction in which the upper second coding unit 1020a is split.

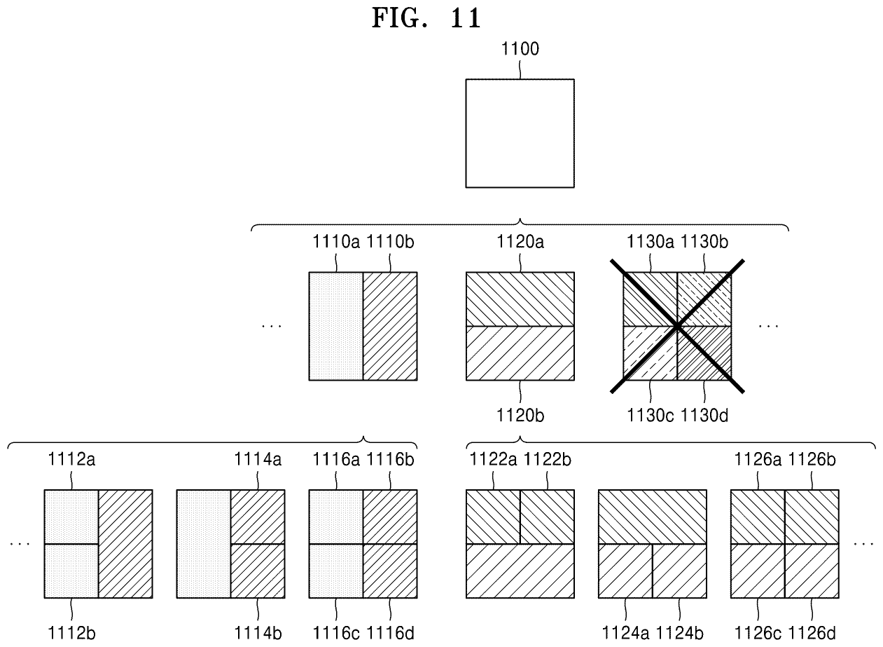

FIG. 11 illustrates a process, performed by the image decoding apparatus 100, of splitting a square coding unit when split shape mode information is unable to indicate that the square coding unit is split into four square coding units, according to an embodiment.

According to an embodiment, the image decoding apparatus 100 may determine second coding units 1110a, 1110b, 1120a, 1120b, etc. by splitting a first coding unit 1100, based on split shape mode information. The split shape mode information may include information about various methods of splitting a coding unit but, the information about various splitting methods may not include information for splitting a coding unit into four square coding units. According to such split shape mode information, the image decoding apparatus 100 may not split the square first coding unit 1100 into four square second coding units 1130a, 1130b, 1130c, and 1130d. Based on the split shape mode information, the image decoding apparatus 100 may determine the non-square second coding units 1110a, 1110b, 1120a, 1120b, etc.

According to an embodiment, the image decoding apparatus 100 may independently split the non-square second coding units 1110a, 1110b, 1120a, 1120b, etc. Each of the second coding units 1110a, 1110b, 1120a, 1120b, etc. may be recursively split in a preset order, and this splitting method may correspond to a method of splitting the first coding unit 1100, based on the split shape mode information.

For example, the image decoding apparatus 100 may determine square third coding units 1112a and 1112b by splitting the left second coding unit 1110a in a horizontal direction, and may determine square third coding units 1114a and 1114b by splitting the right second coding unit 1110b in a horizontal direction. Furthermore, the image decoding apparatus 100 may determine square third coding units 1116a, 1116b, 1116c, and 1116d by splitting both of the left and right second coding units 1110a and 1110b in a horizontal direction. In this case, coding units having the same shape as the four square second coding units 1130a, 1130b, 1130c, and 1130d split from the first coding unit 1100 may be determined.

As another example, the image decoding apparatus 100 may determine square third coding units 1122a and 1122b by splitting the upper second coding unit 1120a in a vertical direction, and may determine square third coding units 1124a and 1124b by splitting the lower second coding unit 1120b in a vertical direction. Furthermore, the image decoding apparatus 100 may determine square third coding units 1126a, 1126b, 1126c, and 1126d by splitting both of the upper and lower second coding units 1120a and 1120b in a vertical direction. In this case, coding units having the same shape as the four square second coding units 1130a, 1130b, 1130c, and 1130d split from the first coding unit 1100 may be determined.

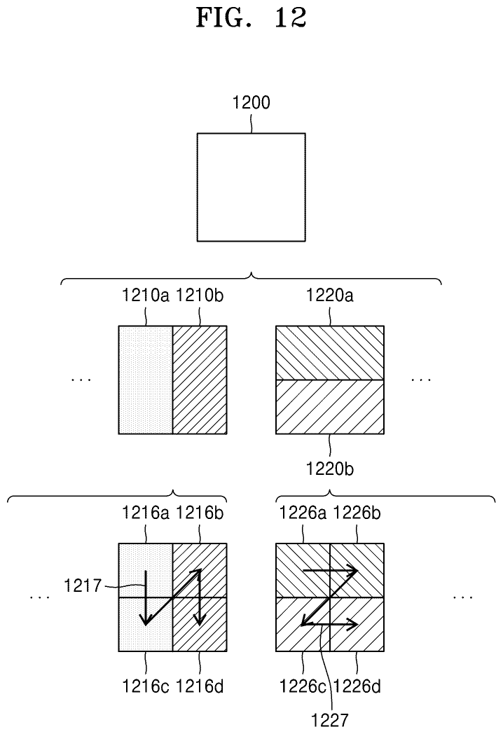

FIG. 12 illustrates that a processing order between a plurality of coding units may be changed depending on a process of splitting a coding unit, according to an embodiment.

According to an embodiment, the image decoding apparatus 100 may split a first coding unit 1200, based on split shape mode information. When a block shape indicates a square shape and the split shape mode information indicates to split the first coding unit 1200 in at least one of a horizontal direction and a vertical direction, the image decoding apparatus 100 may determine second coding units (for examples, second coding units 1210a, 1210b, 1220a, 1220b, etc.) by splitting the first coding unit 1200. Referring to FIG. 12, the non-square second coding units 1210a, 1210b, 1220a, and 1220b determined by splitting the first coding unit 1200 in only a horizontal direction or vertical direction may be independently split based on the split shape mode information of each coding unit. For example, the image decoding apparatus 100 may determine third coding units 1216a, 1216b, 1216c, and 1216d by splitting the second coding units 1210a and 1210b, which are generated by splitting the first coding unit 1200 in a vertical direction, in a horizontal direction, and may determine third coding units 1226a, 1226b, 1226c, and 1226d by splitting the second coding units 1220a and 1220b, which are generated by splitting the first coding unit 1200 in a horizontal direction, in a vertical direction. An operation of splitting the second coding units 1210a, 1210b, 1220a, and 1220b is described above with reference to FIG. 11, and thus, detailed descriptions thereof are not provided here.

According to an embodiment, the image decoding apparatus 100 may process coding units in a preset order. An operation of processing coding units in a predetermined order is described above with reference to FIG. 7, and thus, detailed descriptions thereof are not provided here. Referring to FIG. 12, the image decoding apparatus 100 may determine four square third coding units 1216a, 1216b, 1216c, and 1216d, and 1226a, 1226b, 1226c, and 1226d by splitting the square first coding unit 1200. According to an embodiment, the image decoding apparatus 100 may determine processing orders of the third coding units 1216a, 1216b, 1216c, and 1216d, and 1226a, 1226b, 1226c, and 1226d, based on a splitting method of the first coding unit 1200.

According to an embodiment, the image decoding apparatus 100 may determine the third coding units 1216a, 1216b, 1216c, and 1216d by splitting the second coding units 1210a and 1210b generated by splitting the first coding unit 1200 in a vertical direction, in a horizontal direction, and may process the third coding units 1216a, 1216b, 1216c, and 1216d in a processing order 1217 for initially processing the third coding units 1216a and 1216c, which are included in the left second coding unit 1210a, in a vertical direction and then processing the third coding unit 1216b and 1216d, which are included in the right second coding unit 1210b, in a vertical direction.

According to an embodiment, the image decoding apparatus 100 may determine the third coding units 1226a, 1226b, 1226c, and 1226d by splitting the second coding units 1220a and 1220b generated by splitting the first coding unit 1200 in a horizontal direction, in a vertical direction, and may process the third coding units 1226a, 1226b, 1226c, and 1226d in a processing order 1227 for initially processing the third coding units 1226a and 1226b, which are included in the upper second coding unit 1220a, in a horizontal direction and then processing the third coding unit 1226c and 1226d, which are included in the lower second coding unit 1220b, in a horizontal direction.

Referring to FIG. 12, the square third coding units 1216a, 1216b, 1216c, and 1216d, and 1226a, 1226b, 1226c, and 1226d may be determined by splitting the second coding units 1210a and 1210b, and 1220a and 1220b, respectively. Although the second coding units 1210a and 1210b are determined by splitting the first coding unit 1200 in a vertical direction differently from the second coding units 1220a and 1220b which are determined by splitting the first coding unit 1200 in a horizontal direction, the third coding units 1216a, 1216b, 1216c, and 1216d, and 1226a, 1226b, 1226c, and 1226d split therefrom eventually show same-shaped coding units split from the first coding unit 1200. Accordingly, by recursively splitting a coding unit in different manners based on the split shape mode information, the image decoding apparatus 100 may process a plurality of coding units in different orders even when the coding units are eventually determined to be the same shape.

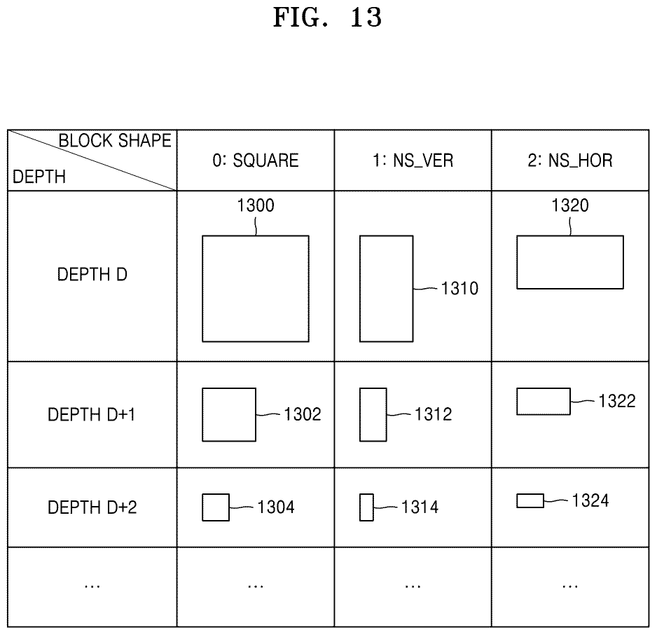

FIG. 13 illustrates a process of determining a depth of a coding unit as a shape and size of the coding unit change, when the coding unit is recursively split such that a plurality of coding units are determined, according to an embodiment.

According to an embodiment, the image decoding apparatus 100 may determine the depth of the coding unit, based on a preset criterion. For example, the preset criterion may be the length of a long side of the coding unit. When the length of a long side of a coding unit before being split is 2n times (n>0) the length of a long side of a split current coding unit, the image decoding apparatus 100 may determine that a depth of the current coding unit is increased from a depth of the coding unit before being split, by n. Hereinafter, a coding unit having an increased depth is expressed as a coding unit of a deeper depth.

Referring to FIG. 13, according to an embodiment, the image decoding apparatus 100 may determine a second coding unit 1302 and a third coding unit 1304 of deeper depths by splitting a square first coding unit 1300 based on block shape information indicating a square shape (for example, the block shape information may be expressed as ‘0: SQUARE’). Assuming that the size of the square first coding unit 1300 is 2N×2N, the second coding unit 1302 determined by splitting a width and height of the first coding unit 1300 in ½ may have a size of N×N. Furthermore, the third coding unit 1304 determined by splitting a width and height of the second coding unit 1302 in ½ may have a size of N/2×N/2. In this case, a width and height of the third coding unit 1304 are ¼ times those of the first coding unit 1300. When a depth of the first coding unit 1300 is D, a depth of the second coding unit 1302, the width and height of which are ½ times those of the first coding unit 1300, may be D+1, and a depth of the third coding unit 1304, the width and height of which are ¼ times those of the first coding unit 1300, may be D+2.

According to an embodiment, the image decoding apparatus 100 may determine a second coding unit 1312 or 1322 and a third coding unit 1314 or 1324 of deeper depths by splitting a non-square first coding unit 1310 or 1320 based on block shape information indicating a non-square shape (e.g., the block shape information may be expressed as ‘1: NS_VER’ indicating a non-square shape, a height of which is longer than a width, or as ‘2: NS_HOR’ indicating a non-square shape, a width of which is longer than a height).

The image decoding apparatus 100 may determine a second coding unit 1302, 1312, or 1322 by splitting at least one of a width and a height of the first coding unit 1310 having a size of N×2N. That is, the image decoding apparatus 100 may determine the second coding unit 1302 having a size of N×N or the second coding unit 1322 having a size of N×N/2 by splitting the first coding unit 1310 in a horizontal direction, or may determine the second coding unit 1312 having a size of N/2×N by splitting the first coding unit 1310 in horizontal and vertical directions.

According to an embodiment, the image decoding apparatus 100 may determine the second coding unit (e.g., the second coding unit 1302, 1312, 1322, etc.) by splitting at least one of a width and a height of the first coding unit 1320 having a size of 2N×N. That is, the image decoding apparatus 100 may determine the second coding unit 1302 having a size of N×N or the second coding unit 1312 having a size of N/2×N by splitting the first coding unit 1320 in a vertical direction, or may determine the second coding unit 1322 having a size of N×N/2 by splitting the first coding unit 1320 in horizontal and vertical directions.

According to an embodiment, the image decoding apparatus 100 may determine a third coding unit 1304, 1314, or 1324 by splitting at least one of a width and a height of the second coding unit 1302 having a size of N×N. That is, the image decoding apparatus 100 may determine the third coding unit 1304 having a size of N/2×N/2, the third coding unit 1314 having a size of N/4×N/2, or the third coding unit 1324 having a size of N/2×N/4 by splitting the second coding unit 1302 in vertical and horizontal directions.

According to an embodiment, the image decoding apparatus 100 may determine the third coding unit (e.g., the third coding unit 1304, 1314, 1324, etc.) by splitting at least one of a width and a height of the second coding unit 1312 having a size of N/2×N. That is, the image decoding apparatus 100 may determine the third coding unit 1304 having a size of N/2×N/2 or the third coding unit 1324 having a size of N/2×N/4 by splitting the second coding unit 1312 in a horizontal direction, or may determine the third coding unit 1314 having a size of N/4×N/2 by splitting the second coding unit 1312 in vertical and horizontal directions.

According to an embodiment, the image decoding apparatus 100 may determine the third coding unit (e.g., the third coding unit 1304, 1314, 1324, etc.) by splitting at least one of a width and a height of the second coding unit 1322 having a size of N×N/2. That is, the image decoding apparatus 100 may determine the third coding unit 1304 having a size of N/2×N/2 or the third coding unit 1314 having a size of N/4×N/2 by splitting the second coding unit 1322 in a vertical direction, or may determine the third coding unit 1324 having a size of N/2×N/4 by splitting the second coding unit 1322 in vertical and horizontal directions.

According to an embodiment, the image decoding apparatus 100 may split the square coding unit 1300, 1302, or 1304 in a horizontal or vertical direction. For example, the image decoding apparatus 100 may determine the first coding unit 1310 having a size of N×2N by splitting the first coding unit 1300 having a size of 2N×2N in a vertical direction, or may determine the first coding unit 1320 having a size of 2N×N by splitting the first coding unit 1300 in a horizontal direction. According to an embodiment, when a depth is determined based on the length of the longest side of a coding unit, a depth of a coding unit determined by splitting the first coding unit 1300 having a size of 2N×2N in a horizontal or vertical direction may be the same as the depth of the first coding unit 1300.

According to an embodiment, a width and height of the third coding unit 1314 or 1324 may be ¼ times those of the first coding unit 1310 or 1320. When a depth of the first coding unit 1310 or 1320 is D, a depth of the second coding unit 1312 or 1322, the width and height of which are ½ times those of the first coding unit 1310 or 1320, may be D+1, and a depth of the third coding unit 1314 or 1324, the width and height of which are ¼ times those of the first coding unit 1310 or 1320, may be D+2.

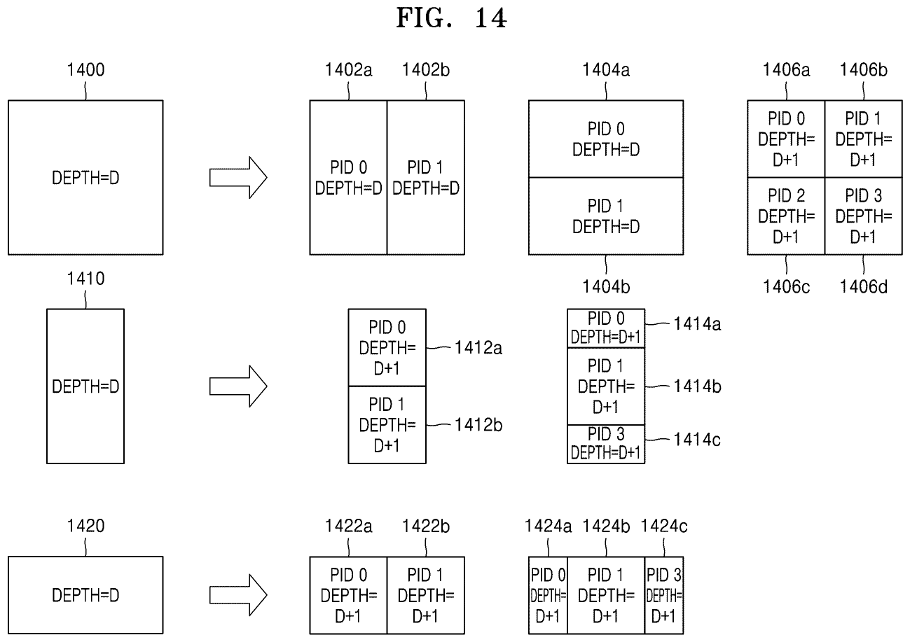

FIG. 14 illustrates depths that are determinable based on shapes and sizes of coding units, and part indexes (PIDs) that are for distinguishing the coding units, according to an embodiment.

According to an embodiment, the image decoding apparatus 100 may determine various-shape second coding units by splitting a square first coding unit 1400. Referring to FIG. 14, the image decoding apparatus 100 may determine second coding units 1402a and 1402b, 1404a and 1404b, and 1406a, 1406b, 1406c, and 1406d by splitting the first coding unit 1400 in at least one of a vertical direction and a horizontal direction based on split shape mode information. That is, the image decoding apparatus 100 may determine the second coding units 1402a and 1402b, 1404a and 1404b, and 1406a, 1406b, 1406c, and 1406d, based on the split shape mode information of the first coding unit 1400.

According to an embodiment, a depth of the second coding units 1402a and 1402b, 1404a and 1404b, and 1406a, 1406b, 1406c, and 1406d, which are determined based on the split shape mode information of the square first coding unit 1400, may be determined based on the length of a long side thereof. For example, because the length of a side of the square first coding unit 1400 equals the length of a long side of the non-square second coding units 1402a and 1402b, and 1404a and 1404b, the first coding unit 1400 and the non-square second coding units 1402a and 1402b, and 1404a and 1404b may have the same depth, e.g., D. However, when the image decoding apparatus 100 splits the first coding unit 1400 into the four square second coding units 1406a, 1406b, 1406c, and 1406d based on the split shape mode information, because the length of a side of the square second coding units 1406a, 1406b, 1406c, and 1406d is ½ times the length of a side of the first coding unit 1400, a depth of the second coding units 1406a, 1406b, 1406c, and 1406d may be D+1 which is deeper than the depth D of the first coding unit 1400 by 1.

According to an embodiment, the image decoding apparatus 100 may determine a plurality of second coding units 1412a and 1412b, and 1414a, 1414b, and 1414c by splitting a first coding unit 1410, a height of which is longer than a width, in a horizontal direction based on the split shape mode information. According to an embodiment, the image decoding apparatus 100 may determine a plurality of second coding units 1422a and 1422b, and 1424a, 1424b, and 1424c by splitting a first coding unit 1420, a width of which is longer than a height, in a vertical direction based on the split shape mode information.

According to an embodiment, depths of the second coding units 1412a and 1412b, and 1414a, 1414b, and 1414c, or 1422a and 1422b, and 1424a, 1424b, and 1424c that are determined based on the split shape mode information of the non-square first coding unit 1410 or 1420 may be determined based on the length of a long side thereof. For example, because the length of a side of the square second coding units 1412a and 1412b is ½ times the length of a long side of the first coding unit 1410 having a non-square shape, a height of which is longer than a width, a depth of the square second coding units 1412a and 1412b is D+1 which is deeper than the depth D of the non-square first coding unit 1410 by 1.

Furthermore, the image decoding apparatus 100 may split the non-square first coding unit 1410 into an odd number of second coding units 1414a, 1414b, and 1414c based on the split shape mode information. The odd number of second coding units 1414a, 1414b, and 1414c may include the non-square second coding units 1414a and 1414c and the square second coding unit 1414b. In this case, because the length of a long side of the non-square second coding units 1414a and 1414c and the length of a side of the square second coding unit 1414b are ½ times the length of a long side of the first coding unit 1410, a depth of the second coding units 1414a, 1414b, and 1414c may be D+1 which is deeper than the depth D of the non-square first coding unit 1410 by 1. The image decoding apparatus 100 may determine depths of coding units split from the first coding unit 1420 having a non-square shape, a width of which is longer than a height, by using the above-described method of determining depths of coding units split from the first coding unit 1410.

According to an embodiment, the image decoding apparatus 100 may determine PIDs for identifying split coding units, based on a size ratio between the coding units when an odd number of split coding units do not have equal sizes. Referring to FIG. 14, a coding unit 1414b of a center location among an odd number of split coding units 1414a, 1414b, and 1414c may have a width equal to that of the other coding units 1414a and 1414c and a height which is two times that of the other coding units 1414a and 1414c. That is, in this case, the coding unit 1414b at the center location may include two of the other coding unit 1414a or 1414c. Therefore, when a PID of the coding unit 1414b at the center location is 1 based on a scan order, a PID of the coding unit 1414c located next to the coding unit 1414b may be increased by 2 and thus, may be 3. That is, discontinuity in PID values may be present. According to an embodiment, the image decoding apparatus 100 may determine whether an odd number of split coding units do not have equal sizes, based on whether discontinuity is present in PIDs for identifying the split coding units.

According to an embodiment, the image decoding apparatus 100 may determine whether to use a specific splitting method, based on PID values for identifying a plurality of coding units determined by splitting a current coding unit. Referring to FIG. 14, the image decoding apparatus 100 may determine an even number of coding units 1412a and 1412b or an odd number of coding units 1414a, 1414b, and 1414c by splitting the first coding unit 1410 having a rectangular shape, a height of which is longer than a width. The image decoding apparatus 100 may use PIDs indicating respective coding units so as to identify the respective coding units. According to an embodiment, the PID may be obtained from a sample of a preset location of each coding unit (e.g., a top-left sample).

According to an embodiment, the image decoding apparatus 100 may determine a coding unit at a preset location from among the split coding units, by using the PIDs for distinguishing the coding units. According to an embodiment, when the split shape mode information of the first coding unit 1410 having a rectangular shape, a height of which is longer than a width, indicates to split a coding unit into three coding units, the image decoding apparatus 100 may split the first coding unit 1410 into three coding units 1414a, 1414b, and 1414c. The image decoding apparatus 100 may assign a PID to each of the three coding units 1414a, 1414b, and 1414c. The image decoding apparatus 100 may compare PIDs of an odd number of split coding units so as to determine a coding unit at a center location from among the coding units. The image decoding apparatus 100 may determine the coding unit 1414b having a PID corresponding to a middle value among the PIDs of the coding units, as the coding unit at the preset location from among the coding units determined by splitting the first coding unit 1410. According to an embodiment, the image decoding apparatus 100 may determine PIDs for distinguishing split coding units, based on a size ratio between the coding units when the split coding units do not have equal sizes. Referring to FIG. 14, the coding unit 1414b generated by splitting the first coding unit 1410 may have a width equal to that of the other coding units 1414a and 1414c and a height which is two times that of the other coding units 1414a and 1414c. In this case, when the PID of the coding unit 1414b at the center location is 1, the PID of the coding unit 1414c located next to the coding unit 1414b may be increased by 2 and thus, may be 3. When the PID is not uniformly increased as described above, the image decoding apparatus 100 may determine that a coding unit is split into a plurality of coding units including a coding unit having a size different from that of the other coding units. According to an embodiment, when the split shape mode information indicates to split a coding unit into an odd number of coding units, the image decoding apparatus 100 may split a current coding unit in such a manner that a coding unit of a preset location among an odd number of coding units (e.g., a coding unit of a center location) has a size different from that of the other coding units. In this case, the image decoding apparatus 100 may determine the coding unit of the center location, which has a different size, by using PIDs of the coding units. However, the PIDs and the size or location of the coding unit of the preset location are not limited to the above-described examples, and various PIDs and various locations and sizes of coding units may be used.

According to an embodiment, the image decoding apparatus 100 may use a preset data unit where a coding unit starts to be recursively split.

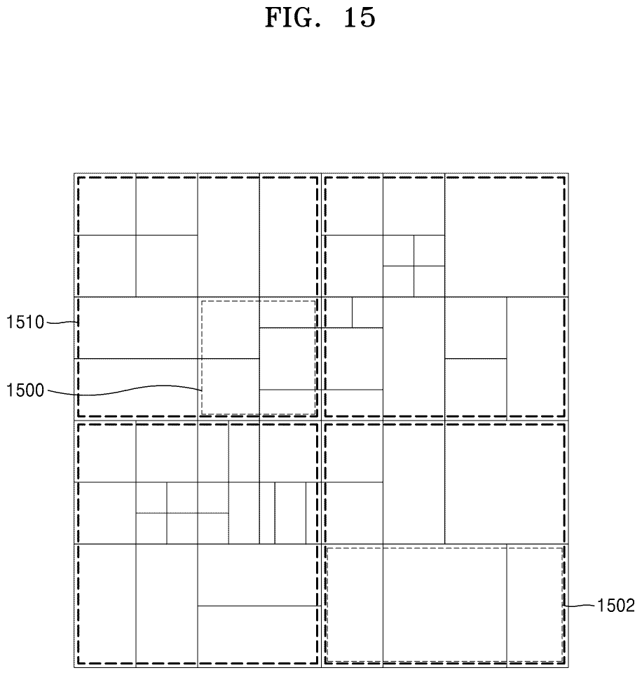

FIG. 15 illustrates that a plurality of coding units are determined based on a plurality of preset data units included in a picture, according to an embodiment.

According to an embodiment, a certain data unit may be defined as a data unit where a coding unit starts to be recursively split by using split shape mode information. That is, the preset data unit may correspond to a coding unit of an uppermost depth, which is used to determine a plurality of coding units split from a current picture. In the following descriptions, for convenience of descriptions, the preset data unit is referred to as a reference data unit.

According to an embodiment, the reference data unit may have a preset size and a preset size shape. According to an embodiment, the reference data unit may include M×N samples. Herein, M and N may be equal to each other, and may be integers expressed as powers of 2. That is, the reference data unit may have a square or non-square shape, and may be split into an integer number of coding units.

According to an embodiment, the image decoding apparatus 100 may split the current picture into a plurality of reference data units. According to an embodiment, the image decoding apparatus 100 may split the plurality of reference data units, which are split from the current picture, by using the split shape mode information of each reference data unit. The operation of splitting the reference data unit may correspond to a splitting operation using a quadtree structure.

According to an embodiment, the image decoding apparatus 100 may previously determine the smallest size allowed for the reference data units included in the current picture. Accordingly, the image decoding apparatus 100 may determine various reference data units having sizes equal to or greater than the smallest size, and may determine one or more coding units by using the split shape mode information with reference to the determined reference data unit.

Referring to FIG. 15, the image decoding apparatus 100 may use a square reference coding unit 1500 or a non-square reference coding unit 1502. According to an embodiment, the shape and size of reference coding units may be determined based on various data units capable of including one or more reference coding units (e.g., sequences, pictures, slices, slice segments, tiles, tile groups, largest coding units, or the like).

According to an embodiment, the bitstream obtainer 110 of the image decoding apparatus 100 may obtain, from a bitstream, at least one of reference coding unit shape information and reference coding unit size information with respect to each of the various data units. An operation of splitting the square reference coding unit 1500 into one or more coding units is described above with reference to the operation of splitting the current coding unit 300 of FIG. 3, and an operation of splitting the non-square reference coding unit 1502 into one or more coding units is described above with reference to the operation of splitting the current coding unit 400 or 450 of FIG. 4. Thus, detailed descriptions thereof are not provided here.

According to an embodiment, the image decoding apparatus 100 may use a PID for identifying the size and shape of reference coding units, to determine the size and shape of reference coding units according to some data units previously determined based on a preset condition. That is, the bitstream obtainer 110 may obtain, from the bitstream, only the PID for identifying the size and shape of reference coding units with respect to each slice, slice segment, tile, tile group, or largest coding unit which is a data unit satisfying a preset condition (e.g., a data unit having a size equal to or smaller than a slice) among the various data units (e.g., sequences, pictures, slices, slice segments, tiles, tile groups, largest coding units, or the like). The image decoding apparatus 100 may determine the size and shape of reference data units with respect to each data unit, which satisfies the preset condition, by using the PID. When the reference coding unit shape information and the reference coding unit size information are obtained and used from the bitstream according to each data unit having a relatively small size, efficiency of using the bitstream may not be high, and therefore, only the PID may be obtained and used instead of directly obtaining the reference coding unit shape information and the reference coding unit size information. In this case, at least one of the size and shape of reference coding units corresponding to the PID for identifying the size and shape of reference coding units may be previously determined. That is, the image decoding apparatus 100 may determine at least one of the size and the shape of reference coding units included in a data unit serving as a unit for obtaining the PID, by selecting the previously determined at least one of the size and the shape of reference coding units based on the PID.

According to an embodiment, the image decoding apparatus 100 may use one or more reference coding units included in a largest coding unit 1510. That is, a largest coding unit split from a picture may include one or more reference coding units, and coding units may be determined by recursively splitting each reference coding unit. According to an embodiment, at least one of a width and a height of the largest coding unit may be integer times at least one of the width and the height of the reference coding units. According to an embodiment, the size of reference coding units may be obtained by splitting the largest coding unit n times based on a quadtree structure. That is, the image decoding apparatus 100 may determine the reference coding units by splitting the largest coding unit n times based on a quadtree structure, and may split the reference coding unit based on at least one of the block shape information and the split shape mode information according to various embodiments.

According to an embodiment, the image decoding apparatus 100 may obtain block shape information indicating the shape of a current coding unit or split shape mode information indicating a splitting method of the current coding unit, from the bitstream, and may use the obtained information. The split shape mode information may be included in the bitstream related to various data units. For example, the image decoding apparatus 100 may use the split shape mode information included in a sequence parameter set, a picture parameter set, a video parameter set, a slice header, a slice segment header, a tile header, or a tile group header. Furthermore, the image decoding apparatus 100 may obtain, from the bitstream, a syntax element corresponding to the block shape information or the split shape mode information according to each largest coding unit or each reference coding unit, and may use the obtained syntax element.

Hereinafter, a method of determining a split rule, according to an embodiment of the present disclosure, will be described in detail.

The image decoding apparatus 100 may determine a split rule of an image. The split rule may be previously determined between the image decoding apparatus 100 and the image encoding apparatus 200. The image decoding apparatus 100 may determine the split rule of the image, based on information obtained from a bitstream. The image decoding apparatus 100 may determine the split rule based on the information obtained from at least one of a sequence parameter set, a picture parameter set, a video parameter set, a slice header, a slice segment header, a tile header, or a tile group header. The image decoding apparatus 100 may determine the split rule differently according to frames, slices, tiles, temporal layers, largest coding units, or coding units.

The image decoding apparatus 100 may determine the split rule based on a block shape of a coding unit. The block shape may include a size, shape, a height to width ratio, and a direction of the coding unit. The image encoding apparatus 200 and the image decoding apparatus 100 may previously determine to determine the split rule based on block shape information of a coding unit. However, the present disclosure is not limited thereto. The image decoding apparatus 100 may determine the split rule, based on information obtained from a bitstream received from the image encoding apparatus 200.

The shape of the coding unit may include a square and a non-square. When the lengths of the width and height of the coding unit are the same, the image decoding apparatus 100 may determine the shape of the coding unit to be a square. Also, when the lengths of the width and height of the coding unit are not the same, the image decoding apparatus 100 may determine the shape of the coding unit to be a non-square.

A size of the coding unit may include various sizes such as 4×4, 8×4, 4×8, 8×8, 16×4, 16×8, . . . , 256×256. The size of the coding unit may be classified based on the length of a long side of the coding unit, the length of a short side, or the area. The image decoding apparatus 100 may apply the same split rule to coding units classified as the same group. For example, the image decoding apparatus 100 may classify coding units having the same lengths of the long sides as having the same size. Also, the image decoding apparatus 100 may apply the same split rule to coding units having the same lengths of long sides.

The height to width ratio of the coding unit may include 1:2, 2:1, 1:4, 4:1, 1:8, 8:1, 1:16, 16:1, 32:1, 1:32, or the like. Also, a direction of the coding unit may include a horizontal direction and a vertical direction. The horizontal direction may indicate a case in which the length of the width of the coding unit is longer than the length of the height thereof. The vertical direction may indicate a case in which the length of the width of the coding unit is shorter than the length of the height thereof.

The image decoding apparatus 100 may adaptively determine the split rule based on the size of the coding unit. The image decoding apparatus 100 may differently determine an allowable split shape mode based on the size of the coding unit. For example, the image decoding apparatus 100 may determine whether splitting is allowed based on the size of the coding unit. The image decoding apparatus 100 may determine a split direction according to the size of the coding unit. The image decoding apparatus 100 may determine an allowable split type according to the size of the coding unit.

To determine the split rule, based on the size of the coding unit, may be a split rule pre-determined between the image encoding apparatus 200 and the image decoding apparatus 100. Also, the image decoding apparatus 100 may determine the split rule based on the information obtained from the bitstream.

The image decoding apparatus 100 may adaptively determine the split rule based on a location of the coding unit. The image decoding apparatus 100 may adaptively determine the split rule based on the location of the coding unit in the image.

Also, the image decoding apparatus 100 may determine the split rule such that coding units generated via different splitting paths do not have the same block shape. However, the present disclosure is not limited thereto, and the coding units generated via different splitting paths have the same block shape. The coding units generated via the different splitting paths may have different decoding processing orders. As the decoding processing orders are described above with reference to FIG. 12, details thereof are not provided here.

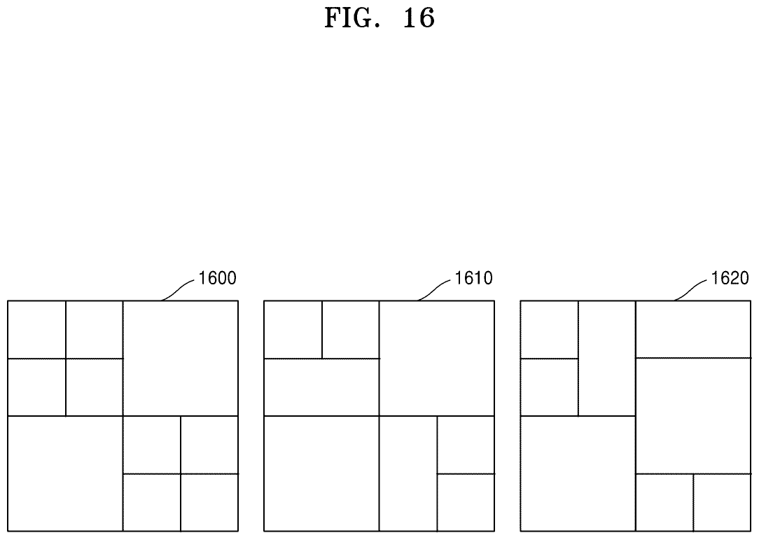

FIG. 16 illustrates coding units that may be determined in each picture when a combination of shapes into which a coding unit is splittable is different for each picture, according to an embodiment.

Referring to FIG. 16, the image decoding apparatus 100 may determine a combination of split shapes into which a coding unit is splittable to be different in each picture. For example, the image decoding apparatus 100 may decode an image by using a picture 1600 being splittable into four coding units, a picture 1610 being splittable into two or four coding units, and a picture 1620 being splittable into two, three, or four coding units among one or more pictures included in the image. In order to split the picture 1600 into a plurality of coding units, the image decoding apparatus 100 may use only split shape information indicating a split into four square coding units. In order to split the picture 1610, the image decoding apparatus 100 may use only split shape information indicating a split into two or four coding units. In order to split the picture 1620, the image decoding apparatus 100 may use only split shape information indicating a split into two, three, or four coding units. The combination of split shapes is merely an embodiment for describing an operation of the image decoding apparatus 100, and thus, should not be interpreted only for the embodiment, and it should be interpreted that a combination of various split shapes may be used in each preset data unit.

According to an embodiment, the bitstream obtainer 110 of the image decoding apparatus 100 may obtain a bitstream including an index indicating a combination of split shape information for each preset data unit (e.g., each sequence, each picture, each slice, each slice segment, each tile, each tile group, etc.). For example, the bitstream obtainer 110 may obtain an index indicating a combination of split shape information from a sequence parameter set, a picture parameter set, a slice header, a tile header, or a tile group header. The image decoding apparatus 100 may determine, by using the obtained index, a combination of split shapes into which a coding unit is splittable in each preset data unit, and thus, may use a combination of different split shapes in each preset data unit.

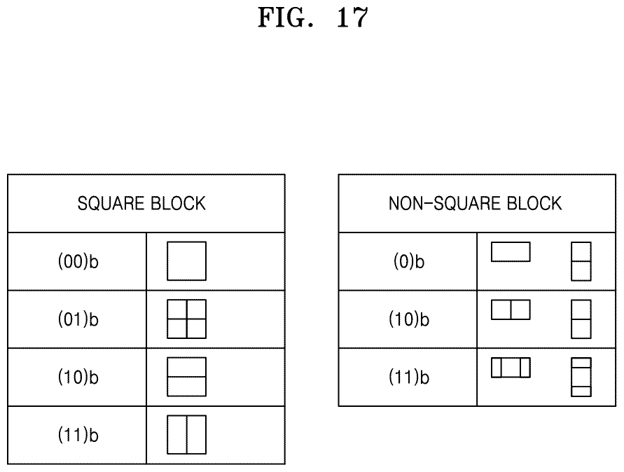

FIG. 17 illustrates various shapes of a coding unit which may be determined based on split shape mode information that may be represented in binary code, according to an embodiment.

According to an embodiment, the image decoding apparatus 100 may split a coding unit into various shapes by using block shape information and split shape mode information obtained via the bitstream obtainer 110. A shape into which a coding unit is splittable may correspond to various shapes including shapes described above in the embodiments.

Referring to FIG. 17, the image decoding apparatus 100 may split a square coding unit in at least one direction among a horizontal direction and a vertical direction, based on the split shape mode information, and may split a non-square coding unit in a horizontal direction or a vertical direction.

According to an embodiment, when it is possible for the image decoding apparatus 100 to split a square coding unit into four square coding units in a horizontal direction and a vertical direction, split shapes for the square coding unit which may be indicated by the split shape mode information may be four shapes. According to an embodiment, the split shape mode information may be represented in 2-bit binary code, and binary code may be allocated to each split shape. For example, when a coding unit is not split, split shape mode information may be represented as (00)b, when a coding unit is split in a horizontal direction and a vertical direction, split shape mode information may be represented as (01)b, when a coding unit is split in a horizontal direction, split shape mode information may be represented as (10)b, and when a coding unit is split in a vertical direction, split shape mode information may be represented as (11)b.

According to an embodiment, when the image decoding apparatus 100 splits a non-square coding unit in a horizontal direction or a vertical direction, split shape types that may be indicated by split shape mode information may be determined based on the number of splits into which a coding unit is divided. Referring to FIG. 17, according to an embodiment, the image decoding apparatus 100 may split a non-square coding unit into three coding units. The image decoding apparatus 100 may split a coding unit into two coding units, and in this case, split shape mode information may be represented as (10)b. The image decoding apparatus 100 may split a coding unit into three coding units, and in this case, split shape mode information may be represented as (11)b. The image decoding apparatus 100 may determine not to split a coding unit, and in this case, split shape mode information may be represented as (0)b. That is, the image decoding apparatus 100 may not use fixed length coding (FLC) but may use variable length coding (VLC) so as to use binary code indicating split shape mode information.

According to an embodiment, referring to FIG. 17, binary code of split shape mode information indicating no split of a coding unit may be represented as (0)b. In a case where binary code of split shape mode information indicating no split of a coding unit is set in (00)b, even when there is no split shape mode information set in (01)b, binary code of 2-bit split shape mode information has to be all used. However, as shown in FIG. 17, in a case where three split shapes for a non-square coding unit are used, the image decoding apparatus 100 may determine no split of a coding unit even when 1-bit binary code (0)b is used as split shape mode information, a bitstream may be efficiently used. However, it should not be interpreted that a split shape of a non-square coding unit which is indicated by split shape mode information is limited to three shapes shown in FIG. 17, and it should be interpreted that the split shape corresponds to various shapes including the embodiments described above.

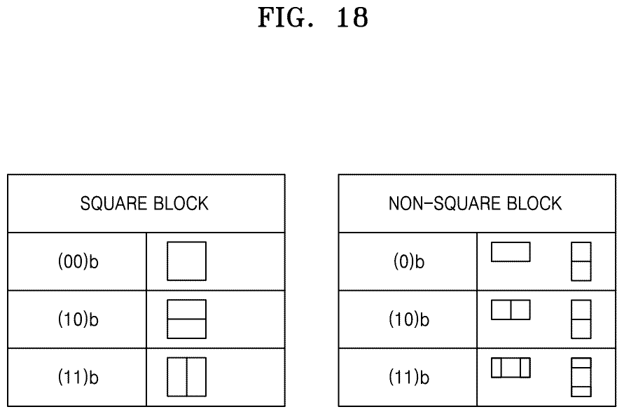

FIG. 18 illustrates other shapes of a coding unit which may be determined based on split shape mode information that may be represented in binary code, according to an embodiment.

Referring to FIG. 18, the image decoding apparatus 100 may split a square coding unit in a horizontal direction or a vertical direction, based on the split shape mode information, and may split a non-square coding unit in a horizontal direction or a vertical direction. That is, the split shape mode information may indicate that a square coding unit is split in one direction. In this case, binary code of split shape mode information indicating no split of a square coding unit may be represented as (0)b. In a case where binary code of split shape mode information indicating no split of a coding unit is set in (00)b, even when there is no split shape mode information set in (01)b, binary code of 2-bit split shape mode information has to be all used. However, as shown in FIG. 18, in a case where three split shapes for a square coding unit are used, the image decoding apparatus 100 may determine no split of a coding unit even when 1-bit binary code (0)b is used as split shape mode information, a bitstream may be efficiently used. However, it should not be interpreted that a split shape of a square coding unit which is indicated by split shape mode information is limited to three shapes shown in FIG. 18, and it should be interpreted that the split shape corresponds to various shapes including the embodiments described above.

According to an embodiment, block shape information or split shape mode information may be represented by using binary code, and such information may be immediately generated as a bitstream. Alternatively, block shape information or split shape mode information that may be represented in binary code may not be immediately generated as a bitstream and may be used as binary code to be input in context adaptive binary arithmetic coding (CABAC).

According to an embodiment, a process in which the image decoding apparatus 100 obtains syntax of block shape information or split shape mode information via CABAC will now be described. A bitstream including binary code for the syntax may be obtained via the bitstream obtainer 110. The image decoding apparatus 100 may detect a syntax element indicating block shape information or split shape mode information by inversely binarizing a bin string included in the obtained bit stream. According to an embodiment, the image decoding apparatus 100 may calculate a binary bin string set corresponding to a syntax element to be decoded, and may decode each bin by using probability information. The image decoding apparatus 100 may repeat decoding until a bin string configured with such decoded bins becomes equal to one of pre-calculated bin strings. The image decoding apparatus 100 may determine the syntax element by performing inverse binarization on the bin string.

According to an embodiment, the image decoding apparatus 100 may determine a syntax of a bin string by performing a decoding process of adaptive binary arithmetic coding. The image decoding apparatus 100 may update a probability model for bins obtained via the bitstream obtainer 110. Referring to FIG. 17, according to an embodiment, the bitstream obtainer 110 of the image decoding apparatus 100 may obtain a bitstream indicating binary code indicating split shape mode information. The image decoding apparatus 100 may determine syntax of split shape mode information by using binary code having 1 bit or 2 bits. In order to determine syntax of split shape mode information, the image decoding apparatus 100 may update probability of each bit in 2-bit binary code. That is, depending on whether a value of a first bin in 2-bit binary code is 0 or 1, the image decoding apparatus 100 may update probability that a next bit has a value of 0 or 1 in decoding.

According to an embodiment, in a process of determining syntax, the image decoding apparatus 100 may update probability of bins used in a process of decoding the bins of a bin string with respect to the syntax, the image decoding apparatus 100 may determine that probability is not updated in a particular bit of the bin string and the particular bit has the same probability.

Referring to FIG. 17, in a process of determining syntax by using a bin string indicating split shape mode information about a non-square coding unit, when the non-square coding unit is not split, the image decoding apparatus 100 may determine the syntax of the split shape mode information by using one bin having the value of 0. That is, in a case where block shape information indicates that a current coding unit has a non-square coding unit, a first bin of a bin string about split shape mode information may be 0 when the non-square coding unit is not split, and may be 1 when the non-square coding unit is split into two or three coding units. Accordingly, probability that the first bin of the bin string of the split shape mode information about the non-square coding unit is 0 may be ⅓ and the probability that the first bin is 1 may be ⅔. As described above, split shape mode information indicating that a non-square coding unit is not split may be represented by only a bin string having a zero-value 1 bit, the image decoding apparatus 100 may determine syntax of the split shape mode information by determining whether a second bin is 0 or 1 only when a first bin of the split shape mode information is 1. According to an embodiment, when the first bin of the split shape mode information is 1, the image decoding apparatus 100 may decode a bin by determining that probability that the second bin is 0 or 1 is the same.

According to an embodiment, the image decoding apparatus 100 may use various probabilities of each bin in a process of determining a bin of a bin string about split shape mode information. According to an embodiment, the image decoding apparatus 100 may determine probability of a bin about split shape mode information to differ according to directions of a non-square block. According to an embodiment, the image decoding apparatus 100 may determine probability of a bin about split shape mode information to differ according to an area or a length of a long side of a current coding unit. According to an embodiment, the image decoding apparatus 100 may determine probability of a bin about split shape mode information to differ according to at least one of a shape and a length of a long side of a current coding unit.

According to an embodiment, the image decoding apparatus 100 may determine that probability of a bin about split shape mode information is equal with respect to coding units with a preset size or more. For example, it may be determined that probability of a bin about split shape mode information is equal with respect to coding units with a size of 64 samples or more.

According to an embodiment, the image decoding apparatus 100 may determine initial probability of bins constituting a bin string of split shape mode information, based on a slice type (e.g., I slice, P slice, or B slice).

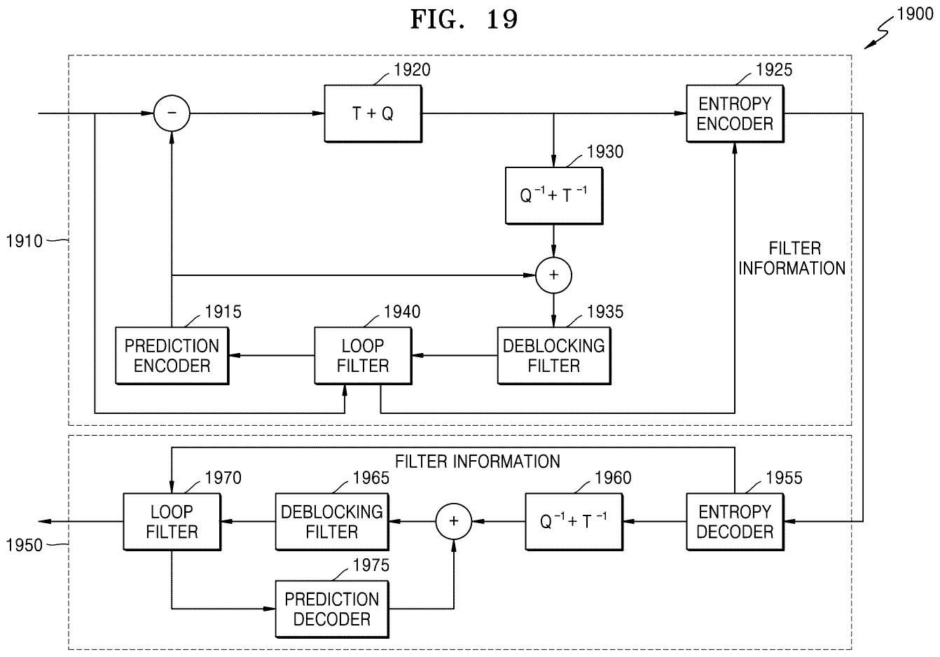

FIG. 19 is a block diagram of an image encoding and decoding system that performs loop filtering.

An encoding end 1910 of an image encoding and decoding system 1900 transmits an encoded bitstream of an image and a decoding end 1950 outputs a reconstructed image by receiving and decoding the bitstream. Here, the encoding end 1910 may have a similar configuration as the image encoding apparatus 200, and the decoding end 1950 may have a similar configuration as the image decoding apparatus 100.

At the encoding end 1910, a prediction encoder 1915 outputs a reference image via inter-prediction and intra-prediction, and a transformer and quantizer 1920 outputs a quantized transform coefficient of residual data between prediction data and a current input image. An entropy encoder 1925 transforms the quantized transform coefficient by encoding the quantized transform coefficient, and outputs the transformed quantized transform coefficient as a bitstream. The quantized transform coefficient is reconstructed as data of a spatial domain via an inverse quantizer and inverse transformer 1930, and the data of the spatial domain is output as a reconstructed image via a deblocking filter 1935 and a loop filter 1940. The reconstructed image may be used as a reference image of a next input image via the prediction encoder 1915.

Encoded image data among the bitstream received by the decoding end 1950 is reconstructed as residual data of a spatial domain via an entropy decoder 1955 and an inverse quantizer and inverse transformer 1960. Image data of a spatial domain is configured when a reference image and residual data output from a prediction decoder 1975 are combined, and a deblocking filter 1965 and a loop filter 1970 may output a reconstructed image regarding a current original image by performing filtering on the image data of the spatial domain. The reconstructed image may be used by the prediction decoder 1975 as a reference image for a next original image.

The loop filter 1940 of the encoding end 1910 performs loop filtering by using filter information input according to a user input or system setting. The filter information used by the loop filter 1940 is output to the entropy encoder 1925 and then is transmitted to the decoding end 1950 together with the encoded image data. The loop filter 1970 of the decoding end 1950 may perform loop filtering based on the filter information input from the decoding end 1950.

In various embodiments described above, an operation related to an image decoding method performed by the image decoding apparatus 100 is described. Hereinafter, an operation of the image encoding apparatus 200 that performs an image encoding method corresponding to an inverse process of the image decoding method will now be described in various embodiments.

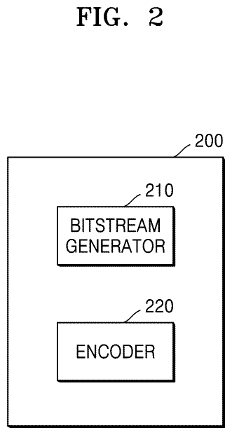

FIG. 2 illustrates a block diagram of the image encoding apparatus 200 capable of encoding an image based on at least one of block shape information and split shape mode information, according to an embodiment.

The image encoding apparatus 200 may include an encoder 220 and a bitstream generator 210. The encoder 220 may receive an input image and then may encode the input image. The encoder 220 may obtain at least one syntax element by encoding the input image. A syntax element may include at least one of a skip flag, a prediction mode, a motion vector difference, a motion vector prediction method (or index), a transform quantized coefficient, a coded block pattern, coded block flag, an intra prediction mode, a direct flag, a merge flag, delta QP, a reference index, a prediction direction, or a transform index. The encoder 220 may determine a context model, based on block shape information including at least one of a shape, a direction, a ratio of a width and a height, or a size of a coding unit.

The bitstream generator 210 may generate a bitstream, based on the encoded input image. For example, the bitstream generator 210 may generate the bitstream by entropy encoding a syntax element, based on the context model. Also, the image encoding apparatus 200 may transmit the bitstream to the image decoding apparatus 100.

According to an embodiment, the encoder 220 of the image encoding apparatus 200 may determine a shape of a coding unit. For example, the coding unit may have a square shape or a non-square shape, and information indicating the shape may be included in the block shape information.

According to an embodiment, the encoder 220 may determine into which shape the coding unit is to be split. The encoder 220 may determine a shape of at least one coding unit included in the coding unit, and the bitstream generator 210 may generate a bitstream including split shape mode information including information about a shape of the coding unit.

According to an embodiment, the encoder 220 may determine whether the coding unit is to be split or is not to be split. When the encoder 220 determines that only one coding unit is included in the coding unit or the coding unit is not to be split, the bitstream generator 210 may generate a bitstream including split shape mode information indicating that the coding unit is not to be split. Also, the encoder 220 may split a coding unit into a plurality of coding units included in the coding unit, and the bitstream generator 210 may generate a bitstream including split shape mode information indicating that the coding unit is to be split into a plurality of coding units.

According to an embodiment, information indicating how many coding units the coding unit is split into or in which direction the coding unit is split may be included in the split shape mode information. For example, the split shape mode information may indicate a split in at least one direction of a vertical direction and a horizontal direction or may indicate no split.

The image encoding apparatus 200 may determine the split shape mode information, based on a split shape mode of the coding unit. The image encoding apparatus 200 determines a context model, based on at least one of a shape, a direction, a ratio of a width and a height, or a size of the coding unit. Then, the image encoding apparatus 200 generates, as a bitstream, the split shape mode information for splitting the coding unit, based on the context model.

In order to determine the context model, the image encoding apparatus 200 may obtain an array for corresponding at least one of a shape, a direction, a ratio of a width and a height, or a size of the coding unit and an index for the context model. The image encoding apparatus 200 may obtain, from the array, the index for the context model, based on at least one of a shape, a direction, a ratio of a width and a height, or a size of the coding unit. The image encoding apparatus 200 may determine the context model, based on the index for the context model.

In order to determine the context model, the image encoding apparatus 200 may determine the context model, further based on block shape information including at least one of a shape, a direction, a ratio of a width and a height, or a size of a neighboring coding unit adjacent to the coding unit. Also, the neighboring coding unit may include at least one of coding units located at bottom-left, left, top-left, top, top-right, right, or bottom-right of the coding unit.

Also, in order to determine the context model, the image encoding apparatus 200 may compare a length of a width of a top neighboring coding unit with a length of a width of the coding unit. Also, the image encoding apparatus 200 may compare lengths of heights of left and right neighboring coding units with a length of a height of the coding unit. Also, the image encoding apparatus 200 may determine the context model, based on results of the comparisons.

As an operation of the image encoding apparatus 200 includes similar content as an operation of the image decoding apparatus 100 described with reference to FIGS. 3 to 19, detailed descriptions thereof are not provided here.

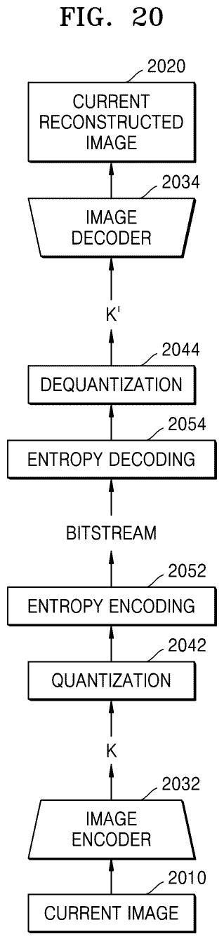

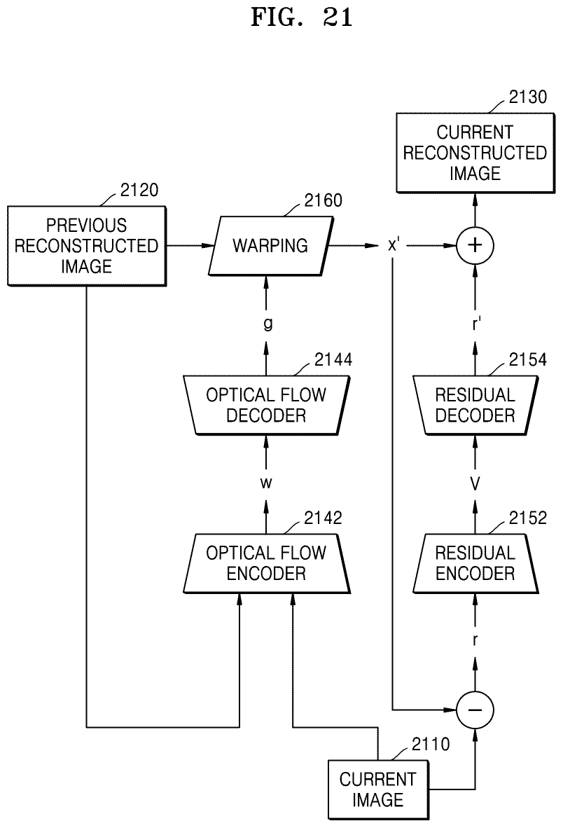

Referring to FIGS. 20 and 21, intra prediction and inter prediction performed by an AI-based end-to-end encoding/decoding system according to an embodiment of the present disclosure will now be described.

FIG. 20 is a diagram for describing a process of encoding and decoding a current image, based on intra prediction, according to an embodiment of the present disclosure.

In an embodiment, intra prediction may involve an image encoder 2032 and an image decoder 2034. The image encoder 2032 and the image decoder 2034 may each be implemented as a neural network. In the present disclosure, an apparatus including the image encoder 2032 may be referred to as an image encoding apparatus, and an apparatus including the image decoder 2034 may be referred to as an image decoding apparatus.

In an embodiment, the image encoder 2032 may output a latent tensor K of a current image 2010 by processing the current image 2010 according to a parameter set via training. Also, a latent tensor may correspond to data that is extracted from a current image and includes patterns, redundancy, etc. in an included image which are usable for intra prediction. The image encoder 2032 may be a neural network trained to maintain a balance between quality and compression of an image, and may output, as a latent tensor, necessary information for decoding a current image.

In an embodiment, quantization 2042 and entropy encoding 2052 may be applied to the latent tensor K of the current image 2010 so as to generate a bitstream, and the bitstream may be transmitted from the image encoding apparatus to the image decoding apparatus.

In an embodiment, quantization 2042 may correspond to a process of increasing a compression possibility for data by decreasing precision of a latent tensor, and may be performed by mapping the latent tensor according to a determined quantization step size. Via quantization 2042 on the latent tensor, a bit depth necessary for representing the latent tensor may be decreased, and important information may be maximally maintained.

In an embodiment, entropy encoding 2052 may correspond to a process of further compressing data by using a statistical characteristic of a quantized latent tensor, and may be performed by allocating short code to a quantized latent tensor of high frequency and allocating relatively long code to a quantized latent tensor of low frequency, thereby minimizing an entire bit transmission rate.

In an embodiment, the reconstructed latent tensor K′ may be obtained by applying entropy decoding 2054 and dequantization 2044 on the bitstream.

In an embodiment, entropy decoding 2054 may correspond to a process of reconstructing data, which is encoded via entropy encoding, to a quantized latent tensor, and may be performed by inversely applying a statistical characteristic and an encoding method used in entropy encoding. For example, in entropy decoding 2054, the data, which is encoded via entropy encoding, may be converted to the quantized latent tensor by using code allocated via entropy encoding.

In an embodiment, dequantization 2044 may correspond to a process of reconstructing precision of data which is decreased in an encoding process, and may correspond to an operation of reconstructing the latent tensor, which is mapped according to the determined quantization step size, to a value range of the latent tensor K which is obtained from the image encoder. For example, in dequantization 2044, a reconstructed latent tensor K′ having a value close to an original latent tensor K that corresponds to the latent tensor mapped by using the quantization step size.

In an embodiment, the latent tensor K′ that is reconstructed by applying entropy decoding 2054 and dequantization 2044 to a bitstream may be input to the image decoder 2034.

The image decoder 2034 may process the latent tensor K′ according to a parameter set via training, and thus, may output a current reconstructed image 2020.

In intra prediction, a spatial characteristic in the current image 2010 is considered, and thus, only the current image 2010 may be input to the image encoder 2032, unlike to inter prediction shown in FIG. 2.

FIG. 21 is a diagram for describing a process of encoding and decoding a current image, based on inter prediction, according to an embodiment of the present disclosure.

In an embodiment, in inter prediction, an optical flow encoder 2142, an optical flow decoder 2144, a residual encoder 2152, and a residual decoder 2154 may be used. An apparatus including the optical flow encoder 2142 and the residual encoder 2152 may be referred to as an image encoding apparatus, and an apparatus including the optical flow decoder 2144 and the residual decoder 2154 may be referred to as an image decoding apparatus.

In an embodiment, the optical flow encoder 2142, the optical flow decoder 2144, the residual encoder 2152, and the residual decoder 2154 may each be implemented as a neural network.

In an embodiment, the optical flow encoder 2142 and the optical flow decoder 2144 may each be understood as a neural network for extracting an optical flow g from a current image 2110 and a previous reconstructed image 2120.

In an embodiment, the residual encoder 2152 and the residual decoder 2154 may each be understood as a neural network for encoding and decoding a residual image r.

In an embodiment, inter prediction corresponds to a process of encoding and decoding the current image 2110 by using temporal redundancy between the current image 2110 and the previous reconstructed image 2120. The previous reconstructed image 2120 may be an image obtained by decoding a previous image that is a processing target before the current image 2110 is processed.

In an embodiment, a positional difference (or a motion vector) between blocks or samples in the current image 2110 and reference blocks or reference samples in the previous reconstructed image 2120 may be used in encoding and decoding of the current image 2110. The positional difference may be referred to as an optical flow. An optical flow may be defined as a set of motion vectors that correspond to samples or blocks in an image.

In an embodiment, the optical flow g may indicate how positions of samples are changed from the previous reconstructed image 2120 to the current image 2110, or where samples that are equal/similar to samples of the current image 2110 are located in the previous reconstructed image 2120.

For example, when a sample that is equal or most similar to a sample located at (1, 1) in the current image 2110 is located at (2, 1) in the previous reconstructed image 2120, the optical flow g or a motion vector of the sample may be calculated as (1(=2-1), 0(=1-1)).

In an embodiment, for encoding of the current image 2110, the previous reconstructed image 2120 and the current image 2110 may be input to the optical flow encoder 2142.

In an embodiment, the optical flow encoder 2142 may process the current image 2110 and the previous reconstructed image 2120 according to a parameter set as a training result, and thus, may output a latent tensor w of the optical flow g.

As described with reference to FIG. 20, quantization 2042 and entropy encoding 2052 may be applied to the latent tensor w of the optical flow g so as to generate a bitstream, and entropy decoding 2054 and dequantization 2044 may be applied to the bitstream, such that the latent tensor w of the optical flow g may be reconstructed.

In an embodiment, the latent tensor w of the optical flow g may be input to the optical flow decoder 2144 The optical flow decoder 2144 may process the input latent tensor w according to a parameter set as a training result, and thus, may output the optical flow g.

In an embodiment, the previous reconstructed image 2120 may be warped via warping 2160 based on the optical flow g, and a current prediction image x′ may be obtained as a result of warping 2160. Warping 2160 is one type of geometric transformations of moving positions of samples in an image.

In an embodiment, warping 2160 may be applied to the previous reconstructed image 2120 according to the optical flow g indicating a relative positional relation between samples in the previous reconstructed image 2120 and samples in the current image 2110, such that the current prediction image x′ similar to the current image 2110 may be obtained.

For example, when a sample located at (1, 1) in the previous reconstructed image 2120 is most similar to a sample located at (2, 1) in the current image 2110, a position of the sample located at (1, 1) in the previous reconstructed image 2120 may be changed to (2, 1) via warping 2160.

In an embodiment, as the current prediction image x′ generated from the previous reconstructed image 2120 is not the current image 2110, a residual image r between the current prediction image x′ and the current image 2110 may be obtained.

For example, the residual image r may be obtained by subtracting sample values in the current prediction image x′ from sample values in the current image 2110.

In an embodiment, the residual image r may be input to the residual encoder 2152. The residual encoder 2152 may output a latent tensor v of the residual image r by processing the residual image r according to a parameter set as a training result.

As described with reference to FIG. 20, quantization 2042 and entropy encoding 2052 may be applied to the latent tensor v of the residual image r so as to generate a bitstream, and entropy decoding 2054 and dequantization 2044 may be applied to the bitstream, such that the latent tensor v of the residual image r may be reconstructed.

In an embodiment, the latent tensor v of the residual image r may be input to the residual decoder 2154. The residual decoder 2154 may process the input latent tensor v according to a parameter set as a training result, and thus, may output a reconstructed residual image r′.

In an embodiment, the current prediction image x′ and the reconstructed residual image r′ may be combined, such that a current reconstructed image 2130 may be obtained.

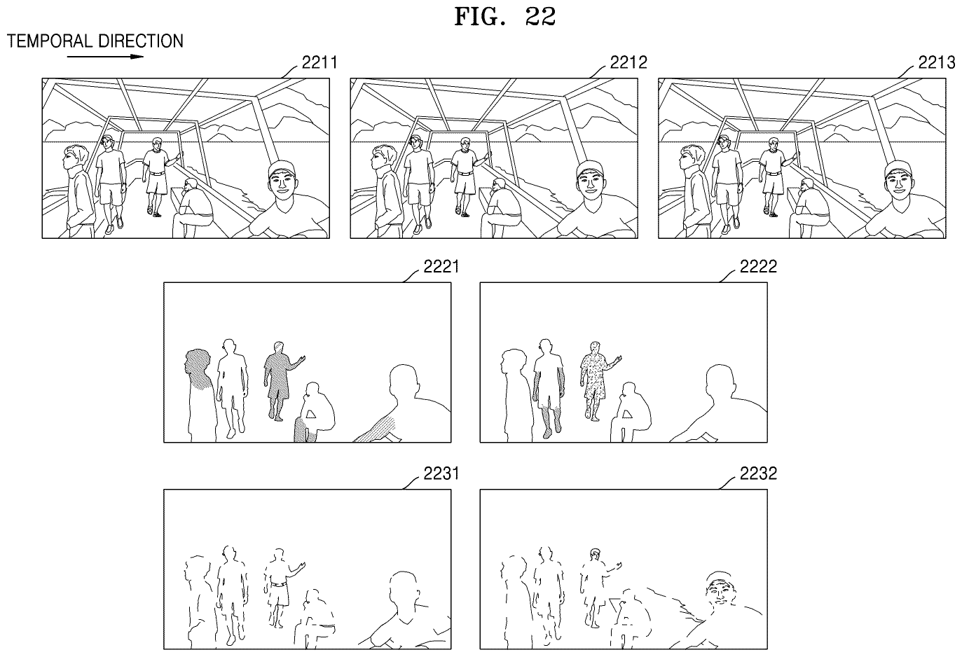

Hereinafter, with reference to FIG. 22, optical flows obtained between consecutive images and a relation between residual images will now be described.

FIG. 22 is a diagram illustrating consecutive images, an optical flow between the consecutive images, and a residual image between the consecutive images.

Referring to FIG. 22, a first optical flow 2222 may be obtained between a current image 2213 and a first previous image 2212, and a second optical flow 2221 is obtained between the first previous image 2212 and a second previous image 2211.

The first optical flow 2222 and the second optical flow 2221 shown in FIG. 22 are visualized according to a size of samples or magnitude of motion vectors included in each optical flow. The first optical flow 2222 may be referred to as a current optical flow, and the second optical flow 2221 may be referred to as a previous optical flow.

In an embodiment, a first residual image 2232 is obtained based on the current image 2213 and the first previous image 2212, and a second residual image 2231 is obtained based on the first previous image 2212 and the second previous image 2211.

For example, the first residual image 2232 that corresponds to a difference between the current image 2213 and an image obtained by processing (e.g., warping processing) the first previous image 2212 according to the first optical flow 2222 may be obtained. Also, the second residual image 2231 that corresponds to a difference between the first previous image 2212 and an image obtained by processing (e.g., warping processing) the second previous image 2211 according to the second optical flow 2221 may be obtained.

The first residual image 2232 may be referred to as a current residual image, and the second residual image 2231 may be referred to as a previous residual image.

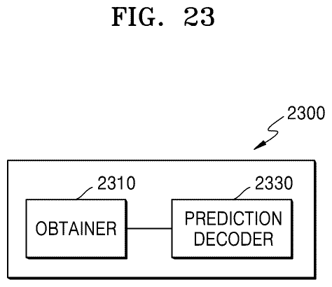

FIG. 23 is a block diagram illustrating a configuration of an image decoding apparatus according to an embodiment of the present disclosure.

In an embodiment, an image decoding apparatus 2300 may be distinguished between a case of performing image encoding/decoding based on block split and a case of performing image encoding/decoding based on a neural network. An operation in the case of performing image encoding/decoding based on block split will be first described, and then, an operation in the case of performing image encoding/decoding based on a neural network will be described.

In the case of performing image encoding/decoding based on block split, according to an embodiment, referring to FIG. 23, the image decoding apparatus 2300 may include an obtainer 2310 and a prediction decoder 2330. The obtainer 2310 shown in FIG. 23 may correspond to the bitstream obtainer 110 shown in FIG. 1, and the prediction decoder 2330 may correspond to the decoder 120 shown in FIG. 1. Also, the obtainer 2310 may correspond to the entropy decoder 1955 shown in FIG. 19, and the prediction decoder 2330 may correspond to the prediction decoder 1975 shown in FIG. 19.

In an embodiment, the obtainer 2310 and the prediction decoder 2330 may be implemented as at least one processor. In an embodiment, the obtainer 2310 and the prediction decoder 2330 may operate according to an instruction stored in memory.

In an embodiment, the image decoding apparatus 2300 may include memory that stores input/output data of the obtainer 2310 and the prediction decoder 2330. Also, the image decoding apparatus 2300 may include a memory controller configured to control data input/output to/from the memory.

In an embodiment, the at least one processor may correspond to a configuration for controlling a series of processes to allow the image decoding apparatus 2300 to operate according to embodiments to be described below, and may include one or more processors. The one or more processors included in the processor may be circuitry such as an SoC, an IC, etc. The one or more processors included in the processor may be a general-purpose processor such as a CPU, an MPU, an AP, a DSP, etc., a graphic-dedicated processor such as a GPU, a vision processing unit (VPU), etc., an AI-dedicated processor such as an NPU, or a communication-dedicated processor such as a CP. When the one or more processors included in the processor is the AI-dedicated processor, the AI-dedicated processor may be designed to have a hardware structure specialized for processing of a particular AI model.

In an embodiment, the processor may record data onto memory or may read data from the memory, and may execute a program or at least one instruction stored in the memory to process data according to a predefined operation rule or an AI model. Therefore, the processor may execute operations described in embodiments of the present disclosure, and in embodiments of the present disclosure, operations described as being performed by the image decoding apparatus 2300 or detailed configurations (see reference numerals 2310 and 2330 of FIG. 23) included in the image decoding apparatus 2300 are performed by the processor, unless there are particular explanations therefor.

In an embodiment, memory may be a configuration for storing various programs or data, and may be implemented as a storage medium including a read only memory (ROM), a random access memory (RAM), a hard disk, a compact disc (CD)-ROM, a digital versatile disc (DVD), or the like, or any combination thereof. The memory may not be separately provided but may be included in the processor. The memory may be implemented as a volatile memory, a non-volatile memory, or a combination of a volatile memory and a non-volatile memory. The memory may store a program or at least one instruction for performing operations according to embodiments to be described below. The memory may provide stored data to the processor, according to a request of the processor.

In an embodiment, the obtainer 2310 may obtain a bitstream generated as an encoding result of an image.

In an embodiment, the bitstream may include an encoding result about a current block. The bitstream may include a plurality of pieces of information used to reconstruct the current block. The current block may be a largest coding unit, a coding unit, a transform unit, a prediction unit, or a filtering unit, which is split from a current image to be decoded. Also, the current block may be a block at a preset location which is processed in an encoding or decoding operation which is currently performed. A current sample may be any sample included in the current block.

In an embodiment, the prediction decoder 2330 may generate a prediction image so as to reconstruct a current image, and, in order to generate the prediction image, may generate or determine the prediction image for the current block, based on prediction information included in the bitstream, which corresponds to at least one level among a sequence parameter set, a picture parameter set, a video parameter set, a slice header, and a slice segment header. The prediction information may be information used to predict the current image.

In an embodiment, the obtainer 2310 may receive the bitstream from an image encoding apparatus via a network.

In an embodiment, the obtainer 2310 may obtain the bitstream from a data storage medium including a magnetic medium such as a hard disk, a floppy disk, and a magnetic tape, an optical recording medium such as compact disc read only memory (CD-ROM) and digital versatile disc (DVD), a magneto-optical medium such as a floptical disk, or the like.

In an embodiment, the obtainer 2310 may obtain, from the bitstream, syntax elements for decoding an image. Values corresponding to the syntax elements may be included in the bitstream, according to a hierarchical structure of the image. The obtainer 2310 may perform entropy decoding on the bitstream, and thus, may obtain bins corresponding to the syntax elements.

In an embodiment, the bitstream may include information indicating a slice type of a current slice including the current image. For example, the bitstream may include, as an index, information indicating a type of the current slice. The slice type of the current slice may indicate indices respectively corresponding to I slice, P slice, and B slice. I slice may indicate a slice that is independently encoded without using a reference and may indicate the slice to be encoded/decoded by using only data in a current image, P slice may indicate a slice that is encoded by using data predicted from a previous slice, and B slice may indicate a slice that uses at least two references among data previously predicted from a previous frame, a next frame, or the like.

In an embodiment, the bitstream may include prediction information used to predict a current image. For example, the bitstream may include information of a prediction mode of a current block in the current image. The prediction mode of the current block may be an intra mode or an inter mode. The intra mode may be a mode in which the current block is predicted or reconstructed by using a prediction sample or a direction in which neighboring samples similar to the current block are located, and the inter mode may refer to a mode in which the current block is predicted or reconstructed based on a reference image so as to decrease temporal redundancy between images.

In an embodiment, when the prediction mode of the current block is the intra mode, the prediction information may include information about a prediction direction of the current block.

In an embodiment, when the prediction mode of the current block is the inter mode, the prediction information may include information for determining a reference block. For example, the information for determining a reference block may include an index indicating a reference image in a reference picture list and motion information, but the present disclosure is not limited thereto.

In an embodiment, when the prediction decoder 2330 reconstructs the current block, based on a reference image, the prediction decoder 2330 may use one reference image (e.g., uni-direction prediction), or may use two reference images (e.g., bi-prediction). Whether the current block is uni-direction predicted or bi-predicted may be determined according to explicit information included in the bitstream, or may be implicitly determined from a prediction mode of neighboring blocks related to the current block.

In an embodiment, the prediction decoder 2330 may perform intra prediction or inter prediction on the current block according to the prediction mode of the prediction block, and thus, may generate a prediction block of the current block. Also, the prediction decoder 2330 may reconstruct the current block by using the prediction block. For example, the prediction decoder 2330 may reconstruct the current block by using the prediction block and a residual block. The prediction decoder 2330 may determine reconstructed samples of the current block by combining prediction samples and residual samples.

In an embodiment, the obtainer 2310 may obtain, from the bitstream, quantized transform coefficients of the current block. The image decoding apparatus 2300 may perform scaling on the quantized transform coefficients, based on a preset quantization parameter, and thus, may perform dequantization on the current block. The image decoding apparatus 2300 may obtain transform coefficients of the current block via dequantization.

In an embodiment, the image decoding apparatus 2300 may use a quantization parameter (QP) so as to perform dequantization. A QP may be set for each coding unit, and one QP may be applied to transform coefficients included in a coding unit.

In an embodiment, an image may include one or more slices, one slice may include one or more largest coding units (CTUs), and one largest coding unit may include one or more coding units. The image decoding apparatus 2300 may obtain, from the bitstream, a plurality of pieces of information requested to determine a QP for each image, each slice, each largest coding unit, or each coding unit. Hereinafter, a current block may indicate one of an image, a slice, a largest coding unit, and a coding unit, and indicates a unit to be processed in a corresponding operation.

In an embodiment, the obtainer 2310 may obtain, from a bitstream, information indicating a QP for the current block. The obtainer 2310 may obtain a differential QP from the bitstream, and may determine or obtain the QP for the current block by using a previous QP for a previous block and the differential QP.

In an embodiment, the obtainer 2310 may obtain, from the bitstream, a quantization index indicating one of a plurality of QPs included in a predetermined quantization list. Alternatively, the obtainer 2310 may obtain, from the bitstream, information about the plurality of QPs included in the quantization list, and may obtain a quantization index indicating one of the plurality of QPs. Alternatively, the obtainer 2310 may obtain information directly indicating a QP value.

However, information indicating a QP for a current block is not limited to the disclosed example.

In an embodiment, horizontal-axis locations and vertical-axis locations of transform coefficients included in the current block respectively correspond to a frequency band in a horizontal direction and a frequency band in a vertical direction of samples of a spatial region which corresponds to the current block. The transform coefficients included in the current block which are generated via transformation may be obtained by classifying values of the samples of the spatial region which corresponds to the current block. The transform coefficients in the current block may be inversely transformed, and thus, the samples at spatial locations in the current block may be reconstructed.

In an embodiment, the prediction decoder 2330 may obtain a transform coefficient of the current block by performing dequantization based on information indicating a QP. The prediction decoder 2330 may determine quantization offset, based on at least one of a prediction mode of the current block, a frequency band of the current block, or a QP of the current block. Also, the prediction decoder 2330 may change the obtained transform coefficient, by using the quantization offset.

In an embodiment, the obtainer 2310 may obtain, from the bitstream, transformation information about the current block. The transformation information about the current block may indicate entire information requested to perform inverse transformation on the current block. The transformation information about the current block may include at least one of information indicating a transform kernel or information indicating whether to perform a sub-block transform, a low frequency non-separable transform, or the like.

However, the transformation information about the current block is not limited to the disclosed example.

In an embodiment, the prediction decoder 2330 may perform inverse transformation on the transform coefficient of the current block, and thus, may obtain a residual block of the current block. For example, the image decoding apparatus 2300 may apply the transform kernel on the current block, and thus, may perform inverse transformation on the transform coefficient of the current block. The residual block may be reconstructed by performing inverse transformation.

In an embodiment, when the current block is decoded via a transformation skip mode, the prediction decoder 2330 does not need to obtain transform coefficients of the current block from the bitstream, and may determine a prediction block of the current block as a reconstructed block of the current block.

In an embodiment, when the image decoding apparatus 2300 performs image encoding/decoding based on a neural network, the obtainer 2310 may obtain a bitstream generated by performing neural network-based encoding on a current image. The bitstream may be generated via intra prediction described with reference to FIG. 20 or inter prediction described with reference to FIG. 21.

In an embodiment, the obtainer 2310 may obtain a quantized latent tensor from the bitstream. The quantized latent tensor may include at least one of a quantized latent tensor of the current image 2010 output from the image encoder 2032, the quantized latent tensor w of the optical flow g output from the optical flow encoder 2142, and the quantized latent tensor v of the residual image r output from the residual encoder 2152.

In an embodiment, the obtainer 2310 may include at least one of an entropy decoder and a dequantizer. The entropy decoder entropy codes bins included in a bitstream, and thus, obtains a quantized latent tensor.

In an embodiment, the obtainer 2310 may obtain, from a bitstream, information indicating a quantization step for a current block. For example, the obtainer 2310 may directly obtain a quantization step value from the bitstream. Alternatively, the obtainer 2310 may obtain a differential quantization step from the bitstream, and may obtain the quantization step for the current block by using the differential quantization step and a previous quantization step for a previous block previously processed.

In an embodiment, the obtainer 2310 may obtain, from the bitstream, a quantization index indicating one of a plurality of quantization steps included in a predetermined quantization list. The image decoding apparatus may determine or obtain a quantization step used to reconstruct a current image.

A quantization step in the case of performing image encoding/decoding based on a neural network indicates a quantization interval at which each sample value included in a latent tensor is quantized, and may be a value used to quantize each sample value included in the latent tensor. For example, when a preset sample value included in the latent tensor is 7 and the quantization step value is 3, a preset sample value of a quantized latent tensor which corresponds to the preset sample value included in the latent tensor may be determined to be 2. A quantization step used in encoding/decoding based on a neural network may be different from a quantization step associated with image encoding/decoding based on block split. For example, the quantization step used in encoding/decoding based on a neural network may indicate a quantization interval and may correspond to a QP in image encoding/decoding based on block split. However, the quantization step in encoding/decoding based on block split may be a value determined by using Equation 1 below. However, a method of calculating the quantization step in encoding/decoding based on block split is not limited to the disclosed example.

Quantization step=2\hat{ }((quantization parameter−4)/6)*2\hat{ }(bitdepth-8) [Equation 1]

In an embodiment, the dequantizer may dequantize at least one of a quantized latent tensor of a current image, a quantized latent tensor of an optical flow, and a quantized latent tensor of a residual image by using information indicating a quantization step, and thus, may obtain at least one of a latent tensor of the current image, a latent tensor of the optical flow, and a latent tensor of the residual image.

In an embodiment, a type of the current block may be information indicating whether a latent tensor to be processed is the latent tensor of the current image, the latent tensor of the optical flow, or the latent tensor of the residual image. The current block may indicate a block to be currently processed, and may correspond to a current image.0

In an embodiment, the latent tensor may have magnitude of H*W*C. H and W are values that respectively indicate a height of two-dimensional feature data and a width of the two-dimensional feature data, and C may indicate the number of channels respectively indicating different features. The latent tensor may indicate C feature data of H*W magnitude.

In an embodiment, H*W*C samples of the latent tensor may be quantized by using one quantization step, and H*W samples included in each of channels of the latent tensor may be quantized by using quantization steps respectively corresponding to the channels.

In an embodiment, among C channels of the latent tensor, C_low channel group may be a set of channels having a low frequency, C_mid channel group may be a set of channels having a middle frequency, and C_high channel group may be a set of channels having a high frequency. An index list of each channel group may include information about an index of channels having a corresponding frequency. For example, C_low channel group may be indicated as an index list. A characteristic indicated by each channel index may be information shared between the image decoding apparatus 2300 and an image encoding apparatus. The prediction decoder 2330 may determine a channel group index, according to an index indicating each channel group.

In an embodiment, the obtainer 2310 may further include an inverse transformer. The inverse transformer may inverse transform a latent tensor output from the dequantizer from a frequency domain to a spatial domain. When the image encoding apparatus to be described below transforms a latent tensor from spatial domain to a frequency domain, the inverse transformer may inverse transform the latent tensor output from the dequantizer from the frequency domain to the spatial domain.

In an embodiment, the latent tensor may be transmitted to the prediction decoder 2330, and the prediction decoder 2330 may obtain, by using the latent tensor, a current reconstructed image corresponding to the current image.

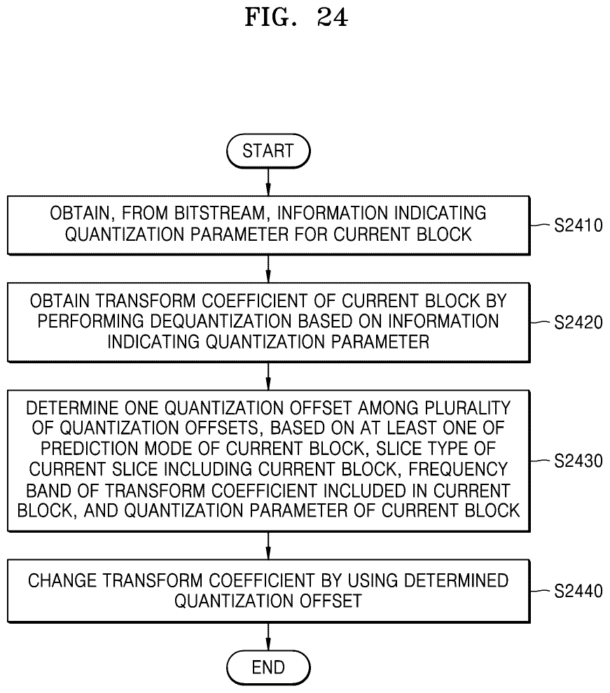

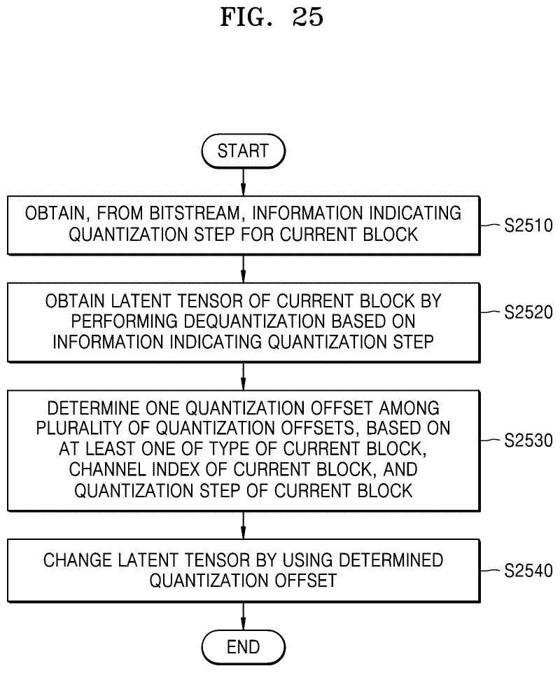

Hereinafter, in an embodiment, a particular operation of the image decoding apparatus 2300 in the case of performing image encoding/decoding based on block split will be described again below with reference to FIG. 24. In an embodiment, a particular operation of the image decoding apparatus 2300 in the case of performing image encoding/decoding based on a neural network will be described again below with reference to FIG. 25.

FIG. 24 is a flowchart of an image decoding method according to an embodiment of the present disclosure.

In an embodiment, a particular operation of the image decoding method performed by the image decoding apparatus 2300 in the case of performing image encoding/decoding based on block split will now be described.

In operation S2410, the image decoding apparatus may obtain, from a bitstream, information indicating a QP for a current block.

In an embodiment, the image decoding apparatus 2300 may obtain, from a bitstream, information indicating a QP for a current block. For example, the image decoding apparatus 2300 may directly obtain a QP value from the bitstream. The image decoding apparatus 2300 may obtain a differential QP value, and may determine the QP for the current block by using the differential QP value.

In an embodiment, the image decoding apparatus 2300 may obtain, from the bitstream, a quantization index indicating one of a plurality of QPs included in a predetermined quantization list. Alternatively, the image decoding apparatus 2300 may obtain, from the bitstream, information about a plurality of QPs included in a quantization list of at least one image, and may obtain a quantization index indicating one of the plurality of QPs.

However, the information indicating the QP for the current block is not limited to the disclosed example.

In operation S2420, the image decoding apparatus may obtain a transform coefficient of the current block by performing dequantization based on information indicating a QP.

In an embodiment, the image decoding apparatus 2300 may determine the QP, based on the information indicating the QP for the current block being obtained from the bitstream. For example, the image decoding apparatus 2300 may determine the QP, based on the QP being directly obtained from the bitstream. The image decoding apparatus 2300 may determine the QP by using the differential QP obtained from the bitstream and a previous QP for a previous block previously processed.

In an embodiment, the image decoding apparatus 2300 may obtain a quantization index indicating one of a plurality of QPs included in a quantization list, and thus, may determine a QP value corresponding to the quantization index as the QP for the current block.

In an embodiment, the image decoding apparatus 2300 may obtain, from the bitstream, a quantized transform coefficient of the current block. The image decoding apparatus 2300 may perform dequantization by performing scaling on the quantized transform coefficient by using the determined QP. The image decoding apparatus 2300 may obtain a transform coefficient of the current block via dequantization. At least one transform coefficient may correspond to the current block.

In operation S2430, the image decoding apparatus may determine one quantization offset among a plurality of quantization offsets, based on at least one of a prediction mode of the current block, a slice type of a current slice including the current block, a frequency band of a transform coefficient included in the current block, and a QP of the current block.

In an embodiment, the image decoding apparatus 2300 may determine a quantization offset for the current block by using a look-up table based on at least one of a prediction mode of the current block, a slice type of a current slice including the current block, a frequency band of a transform coefficient included in the current block, and a QP of the current block.

In an embodiment, the image decoding apparatus 2300 may obtain a quantization offset for the current block, based on index values being applied to the look-up table, the index values corresponding to one or more of a prediction mode of the current block, a slice type of a current slice including the current block, a frequency band of a transform coefficient included in the current block, and a QP of the current block. In the present disclosure, a frequency band of a transform coefficient included in the current block may indicate a frequency band including a frequency corresponding to the transform coefficient included in the current block, and may be referred to as a frequency band of the current block.

In an embodiment, the image decoding apparatus may determine one quantization offset among a plurality of quantization offsets, based on at least one of a prediction mode of the current block, a frequency band of a transform coefficient included in the current block, and a QP of the current block. Alternatively, the image decoding apparatus 2300 may determine one quantization offset among a plurality of quantization offsets, based on at least one of a slice type of a current slice including the current block, a frequency band of a transform coefficient included in the current block, and a QP of the current block.

However, the present disclosure is not limited to the disclosed example, and the image decoding apparatus 2300 may determine one quantization offset among a plurality of quantization offsets in a slice unit, or may determine one quantization offset among a plurality of quantization offsets in a sample unit.

In an embodiment, the image decoding apparatus 2300 may determine one quantization offset among a plurality of quantization offsets, based on a prediction mode of the current block. When the prediction mode of the current block is an intra mode, the image decoding apparatus 2300 may determine a prediction mode index value to be 0, when the prediction mode of the current block is an inter mode in which uni-direction prediction is performed, a prediction mode index value may be determined to be 1, and when the prediction mode of the current block is an inter mode in which bi-prediction is performed, a prediction mode index value may be determined to be 2.

In an embodiment, the image decoding apparatus 2300 may determine one quantization offset among a plurality of quantization offsets, based on a type of a current slice including the current block. When the type of the current slice is I slice, the image decoding apparatus 2300 may determine a slice type index value to be 0, when the type of the current slice is P slice, a slice type index value may be determined to be 1, and when the type of the current slice is B slice, a slice type index value may be determined to be 2. In an embodiment, the image decoding apparatus 2300 may determine one quantization offset among a plurality of quantization offsets, based on a frequency band of a transform coefficient included in the current block. The image decoding apparatus 2300 may classify the frequency band into a low frequency band, a mid frequency band, and a high frequency band, the frequency band including a frequency corresponding to the transform coefficient included in the current block. Also, the image decoding apparatus 2300 may determine a frequency index according to a determined frequency band. For example, when a frequency of a certain transform coefficient included in the current block is included in the low frequency band, a frequency index may be determined to be 0. When a frequency of a certain transform coefficient included in the current block is included in the mid frequency band, a frequency index may be determined to be 1. When a frequency of a certain transform coefficient included in the current block is included in the high frequency band, a frequency index may be determined to be 2.

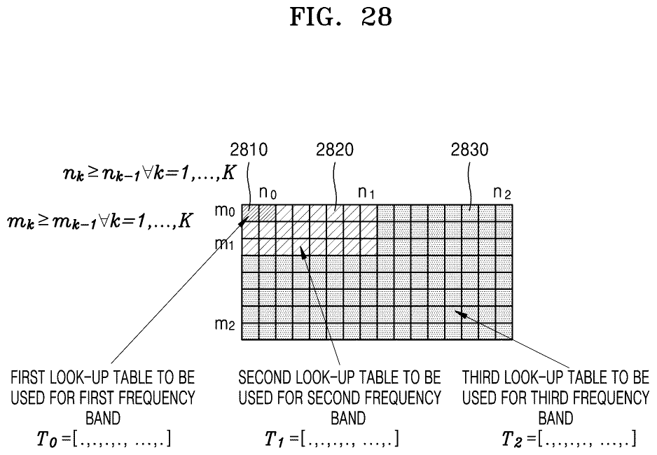

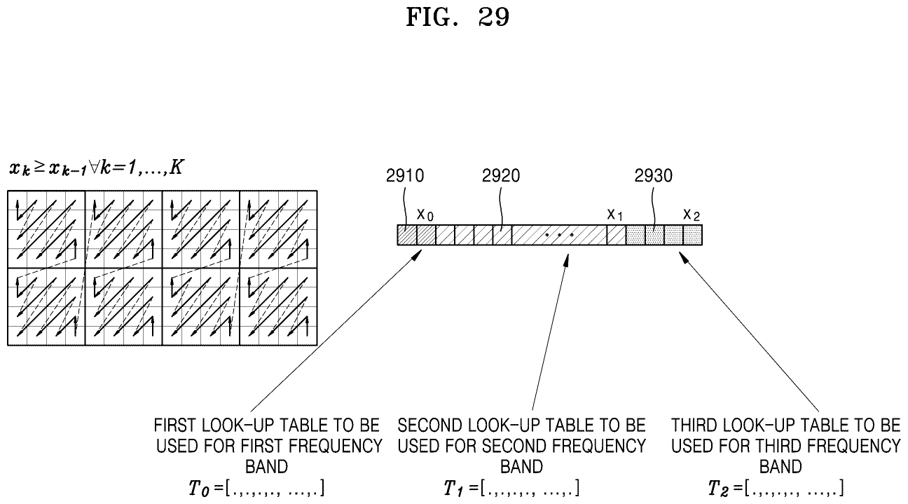

According to an embodiment, an operation of classifying a frequency band of a current block will be described in detail with reference to FIGS. 28 to 29.

In an embodiment, the image decoding apparatus 230 may determine a QP index for determining a quantization offset by using a look-up table, according to the determined QP value.

The look-up table may be information that has been predetermined and stored in the image decoding apparatus 2300 and the image encoding apparatus. Also, the look-up table may include an offset table or an offset parameter table. The offset table may be a table that is predetermined to output a value of offset, according to preset information. The offset parameter table may be a table that is predetermined to output a value of an offset parameter, according to preset information.

In an embodiment, a plurality of quantization offsets may be determined according to an offset table or an offset parameter table which is predetermined by using at least one of a prediction mode of the current block, a slice type of a current slice including the current block, a frequency band of a transform coefficient included in the current block, and a QP of the current block.

An embodiment of determining, according to the offset table, a quantization offset by using a prediction mode of the current block, a frequency band of the current block, and a QP of the current block is represented as Equation below. For convenience of explanation, Equation for determining a quantization offset based on a current slice type including the current block is omitted, but in the present disclosure, a prediction mode of the current block may be replaced by or correspond to a slice type of a current slice including the current block.

$$offset = offsetTable [ PredictionMode ] [ FrequencyBand ] [ QP ] [ quantizedMagnitude ]$$

In Equation above, offset may indicate quantization offset, offsetTable may indicate an offset table, PredictionMode may indicate a prediction mode of the current block, FrequencyBand may indicate a frequency band, QP may indicate a quantization parameter, and quantizedMagnitude may indicate a quantized transform coefficient.

An offset value may be determined by using only some factors. For example, in a transformation skip mode, an offset value may be determined by using Equation below.

offset=offsetTable[PredictionMode][QP][quantizedMagnitude]

However, the present disclosure is not limited thereto, and the image decoding apparatus 2300 may determine an offset parameter by using the offset parameter table, based on at least one of a prediction mode of the current block, a frequency band of the current block, and a QP of the current block. The image decoding apparatus 2300 may determine a quantization offset according to the offset parameter determined by using the offset table.

$$α = \text{} offsetParameterTable [ \text{} PredictionMode ] [ \text{} FrequencyBand ] [ \text{} QP ] offsetTable [ ] = \text{} [ 0 , α , \frac{α}{2} , \frac{α}{3} , \frac{α}{4} , … , \frac{α}{α} ]$$

In Equation above, a may indicate an offset parameter. The offset table indicates a table that is in inverse proportion to an offset parameter value, and the offset parameter value may have been predetermined. The image decoding apparatus 2300 may obtain the quantized transform coefficient as an index value, and may determine a quantization offset according to the offset table.

In an embodiment, the image decoding apparatus 2300 may determine a quantization offset to vary according to a prediction mode of the current block, by using the offset table. For example, when a prediction mode of the current block is an inter mode, the image decoding apparatus 2300 may determine a first quantization offset as a quantization offset for the current block, and when a prediction mode of the current block is an intra mode, the image decoding apparatus 2300 may determine a second quantization offset as a quantization offset for the current block. In this regard, a value of the first quantization offset may be greater than a value of the second quantization offset.

In an embodiment, the image decoding apparatus 2300 may determine, as a quantization offset for the current block, a quantization offset value that is of a case in which the prediction mode of the current block is an intra mode and that is less than a quantization offset value of a case in which the prediction mode of the current block is an inter mode.

In an embodiment, the image decoding apparatus 2300 may determine, as a quantization offset for the current block, a quantization offset that is of a case in which bi-direction prediction is performed on the current block and that has a value greater than a quantization offset of a case in which uni-direction prediction is performed on the current block.

In an embodiment, the image decoding apparatus 2300 may determine a quantization offset value to vary according to a frequency band of the current block by using the offset table. The image decoding apparatus 2300 may determine a quantization offset value to increase when a frequency band increases. For example, the image decoding apparatus 2300 may determine, as a quantization offset for the current block, a quantization offset value that is greater in a case in which a frequency band of the current block is a high frequency band than in a case in which the frequency band of the current block is a low frequency band.

In an embodiment, the image decoding apparatus 2300 may determine a quantization offset value to vary according to a QP of the current block by using the offset table. The image decoding apparatus 2300 may determine the quantization offset value to increase when a value of the QP increases. When the quantization offset value is a second QP greater than a first QP, the image decoding apparatus 2300 may determine a second quantization offset as a quantization offset for the current block, the second quantization offset being greater than a first quantization offset determined based on the first QP.

In an embodiment, the image decoding apparatus 2300 may determine a quantization offset value to vary according to a quantized transform coefficient of the current block by using the offset table. The image decoding apparatus 2300 may determine the quantization offset value to increase when the quantized transform coefficient of the current block decreases. For example, when a quantized transform coefficient value of the current block is a second quantized transform coefficient less than a first quantized transform coefficient, the image decoding apparatus 2300 may determine a second quantization offset as the quantization offset for the current block, the second quantization offset being greater than a first quantization offset determined based on the first quantized transform coefficient.

Hereinafter, in an embodiment, an operation in which the image decoding apparatus 2300 determines a quantization offset according to a QP of a current block by using an offset table will now be described in detail.

For example, the image decoding apparatus 2300 may determine a QP index according to a QP, by using Equation below, and may determine an offset parameter corresponding to the QP index.

$$qpIdx = \{ \begin{matrix}0 & if QP < 24 \\ 1 & if 24 <= QP < 29 \\ 2 & if 29 <= QP < 34 \\ 3 & if QP >= 34\end{matrix} offsetParameterTable [ ] = \{ 73 , 98 , 1 \; 16 , 139 \} {α}_{QP} = offsetParameterTable [ qpIdx ]$$

In Equation above, the image decoding apparatus 2300 may determine a first index according to the QP indicated as qpIdx, according to a value of a QP. Also, the image decoding apparatus 2300 may input the first index as an index value with respect to offsetparameterTable[ ] that is a predetermined offset parameter table, and thus, may determine or obtain an offset parameter. For example, when the QP is 25, the first index may be 1, and the offset parameter may be 98.

In Equation below, the image decoding apparatus 2300 may determine a second index according to a quantized transform coefficient, by using Equation below, and may determine a quantization offset corresponding to the second index according to the quantized transform coefficient with respect to the offset table.

$$yIdx = \{ \begin{matrix}abs ( {y}_{i} ) & if abs ( {y}_{i} ) \leq {α}_{QP} \\ {α}_{QP} & if abs ( {y}_{i} ) > {α}_{QP}\end{matrix} \\ offsetTable [ ] = [ 0 , {α}_{QP} , \frac{{α}_{QP}}{2} , … , \frac{{α}_{QP}}{{α}_{QP}} ] offset = offsetTable [ yIdx ]$$

In Equation above, the image decoding apparatus 2300 may determine the second index indicated as yIdx, according to a smaller value among the offset parameter and absolute value of the quantized transform coefficient. Also, the image decoding apparatus 2300 may input the second index as an index value with respect to offsetTable[ ] that is an offset table predetermined by the offset parameter, and thus, may determine or obtain quantization offset. For example, when the offset parameter is 16 and the quantized transform coefficient is 8, the second index may be 8 and the quantization offset may be 2.

In operation S2440, the image decoding apparatus may change a transform coefficient by using the determined quantization offset.

In an embodiment, the image decoding apparatus 2300 may change the obtained transform coefficient of the current block by using the determined quantization offset. For example, the image decoding apparatus 2300 may modify one or more transform coefficients for the current block which are obtained via dequantization, by using quantization offsets respectively corresponding to the one or more transform coefficients.

In an embodiment, the image decoding apparatus 2300 may perform a quantization shift by performing interpolation on the transform coefficient by using the determined quantization offset. An operation of changing the transform coefficient may correspond to an operation of performing the quantization shift. For example, the image decoding apparatus may perform the quantization shift by performing interpolation on a value of the transform coefficient and a value subsequent to the transform coefficient by using the quantization offset.

In an embodiment, the quantization shift may be performed by using the obtained transform coefficient and the value subsequent to the transform coefficient and a value of the quantization offset. For example, the quantization shift according to the quantization offset may be performed by using Equation 2 below.

$${\hat{x}}_{i} = [ ( 1 ≪ B - offset ) \times {Q}^{- 1} ( {y}_{i} ) + offset \times {Q}^{- 1} ( {{y}_{i}}^{′} ) ] ≫ B \qquad [ Equation 2 ]$$

In Equation above, \hat{x}ᵢ may indicate a value of a changed transform coefficient. B may be a constant that is a parameter for controlling precision of the quantization offset. yᵢ may be a quantized transform coefficient, and yᵢ′ may be a value determined based on the quantized transform coefficient. For example, yᵢ′ may be determined by using Equation 3 below.

$${{y}_{i}}^{′} = {y}_{i} + ( {y}_{i} > 0 ? 1 : - 1 ) \qquad [ Equation 3 ]$$

In an embodiment, Equation 2 may be differently expressed as Equation 4.

$${\hat{x}}_{i} ← ( ( 1024 - T [ \vert {y}_{i} \vert ] ) * {Q}^{- 1} ( {y}_{i} ) + T [ \vert {y}_{i} \vert ] * {Q}^{- 1} ( {{y}^{′}}_{i} ) ) >> 10 if \vert T \vert > \vert {y}_{i} \vert > 0 \qquad [ Equation 4 ]$$

However, a method of changing a transform coefficient by using a quantization offset is not limited to the disclosed example.

In an embodiment, the image decoding apparatus 2300 may change a transform coefficient obtained by performing dequantization, by using a quantization offset determined based on at least one of a prediction mode of a current block, a frequency band of the current block, or a QP of the current block.

FIG. 25 is a flowchart of an image decoding method according to an embodiment of the present disclosure.

In an embodiment, a particular operation of the image decoding method performed by the image decoding apparatus 2300 in the case of performing image encoding/decoding based on a neural network will now be described.

In operation S2510, the image decoding apparatus may obtain, from a bitstream, information indicating a quantization step for a current block.

In an embodiment, the image decoding apparatus 2300 may obtain, from a bitstream, information indicating a quantization step for a current block. For example, the image decoding apparatus 2300 may directly obtain a quantization step value from the bitstream. Alternatively, the image decoding apparatus 2300 may obtain a differential quantization step from the bitstream, and may obtain the quantization step for the current block by using the differential quantization step.

In an embodiment, the image decoding apparatus 2300 may obtain, from the bitstream, a quantization index indicating one of a plurality of quantization steps included in a predetermined quantization list. Alternatively, the image decoding apparatus 2300 may obtain, from the bitstream, information about a plurality of quantization steps included in a quantization list of at least one image, and may obtain a quantization index indicating one of the plurality of quantization steps.

However, the information indicating the quantization step for the current block is not limited to the disclosed example.

In operation S2520, the image decoding apparatus may obtain a latent tensor of the current block by performing dequantization based on the information indicating the quantization step.

In an embodiment, the image decoding apparatus 2300 may determine the quantization step, based on the information indicating the quantization step for the current block being obtained from the bitstream. For example, the image decoding apparatus 2300 may determine the quantization step, based on the quantization step value being directly obtained from the bitstream. The image decoding apparatus 2300 may determine the quantization step by using a previous quantization step and the differential quantization step.

In an embodiment, the image decoding apparatus 2300 may determine a quantization step value corresponding to the quantization index, as the quantization step for the current block by obtaining a quantization index indicating one of a plurality of quantization steps included in a quantization list.

In an embodiment, the image decoding apparatus 2300 may obtain, from the bitstream, a quantized latent tensor of the current block. The image decoding apparatus 2300 may perform dequantization by performing scaling on the quantized latent tensor by using the determined quantization step. The image decoding apparatus 2300 may obtain the latent tensor of the current block via dequantization. The current block may be a current image or a block obtained by splitting the current image into a plurality of blocks, and may be a target to be processed by the image decoding apparatus 2300.

In operation S2530, the image decoding apparatus may determine one quantization offset among a plurality of quantization offsets, based on at least one of a type of the current block, a channel index of the current block, and a quantization step of the current block.

In an embodiment, the image decoding apparatus 2300 may determine a quantization offset corresponding to the current block, by using a look-up table based on at least one of a type of the current block, a channel index of the current block, and a quantization step of the current block.

In an embodiment, the image decoding apparatus 2300 may obtain a quantization offset corresponding to the current block, based on index values being applied to the look-up table, the index values corresponding to one or more of a type of the current block, a channel index of the current block, and a quantization step of the current block.

In an embodiment, the type of the current block may indicate information as to whether the quantized latent tensor obtained from the bitstream is the quantized latent tensor of the current image 2010 output from the image encoder 2032, the quantized latent tensor w of the optical flow g output from the optical flow encoder 2142, and the quantized latent tensor v of the residual image r output from the residual encoder 2152. For example, when the type of the current block is the quantized latent tensor of the current image 2010 output from the image encoder 2032, a type index of the current block may be 0. When the type of the current block is the quantized latent tensor w of the optical flow g output from the optical flow encoder 2142, a type index of the current block may be 1. When the type of the current block is the quantized latent tensor v of the residual image r output from the residual encoder 2152, a type index of the current block may be 2.

In an embodiment, the channel index of the current block may indicate an index of a channel corresponding to the latent tensor or may be an index indicating a channel group (e.g., C_low, C_mid, C_high) according to a frequency. However, the present disclosure is not limited to the disclosed example.

In an embodiment, the image decoding apparatus 2300 may determine, according to the determined quantization step value, a QP index for determining a quantization offset by using a look-up table.

The look-up table may be information that has been predetermined and stored in the image decoding apparatus 2300 and the image encoding apparatus. Also, the look-up table may include an offset table or an offset parameter table. An embodiment of determining, according to the offset table, a quantization offset by using the type of the current block, the channel index of the current block, and the quantization step of the current block is represented as Equation below.

offset=offsetTable[Type][ChannelIndex][QuantizationStep][quantizedMagnitude]

In Equation above, offset may indicate quantization offset, offsetTable may indicate an offset table, PredictionMode may indicate the type of the current block, FrequencyBand may indicate the channel index, QP may indicate the quantization step, and quantizedMagnitude may indicate a quantized latent tensor.

An offset value may be determined by using only some factors. For example, the look-up table may have been determined without consideration of the type of the current block. In this case, an offset value may be determined by using Equation below.

offset=offsetTable[ChannelIndex][QuantizationStep][quantizedMagnitude]

However, the present disclosure is not limited to the disclosed example, and the image decoding apparatus 2300 may determine an offset parameter by using the offset parameter table based on at least one of the type of the current block, the channel index of the current block, and the quantization step of the current block, and may determine a quantization offset according to the offset parameter by using the offset table.

$$α = offsetParameterTable [ ChannelIndex ] [ QuantizationStep ] \\ offsetTable [ ] = [ \begin{matrix}0 , & α , & \frac{α}{2} , & \frac{α}{3} , & \frac{α}{4} , & … , & \frac{α}{α}\end{matrix} ]$$

In Equation above, a may indicate an offset parameter. The offset table indicates a table that is in inverse proportion to an offset parameter value, and the offset parameter value may have been predetermined. The image decoding apparatus 2300 may obtain an index value corresponding to a sample value of the quantized latent tensor, and thus, may determine a quantization offset according to the offset table.

In an embodiment, the image decoding apparatus 2300 may determine a quantization offset value to vary according to a type of the current block by using the offset table. For example, by using the offset table, the image decoding apparatus 2300 may determine a first quantization offset as the quantization offset for the current block when a type of the current block is the quantized latent tensor of the current image 2010, may determine a second quantization offset as the quantization offset for the current block when a type of the current block is the quantized latent tensor w of the optical flow g output from the optical flow encoder 2142, and may determine a third quantization offset as the quantization offset for the current block when a type of the current block is the quantized latent tensor v of the residual image r output from the residual encoder 2152. A value of the second quantization offset or a value of the third quantization offset may be greater than a value of the first quantization offset.

In an embodiment, the image decoding apparatus 2300 may determine, as the quantization offset for the current block, a quantization offset value that is of a case in which the current block is decoded based on intra prediction and that is less than a quantization offset value of a case in which the current block is decoded based on inter prediction.

In an embodiment, when the current block is decoded based on inter prediction, the image decoding apparatus 2300 may determine, as the quantization offset for the current block, a quantization offset value that is of a case in which the type of the current block is the quantized latent tensor v of the residual image r output from the residual encoder 2152 and that is greater than a quantization offset value of a case in which the type of the current block is the quantized latent tensor w of the optical flow g output from the optical flow encoder 2142.

In an embodiment, when the current block is decoded based on inter prediction, the image decoding apparatus 2300 may determine, as the quantization offset for the current block, a quantization offset value that is of a case in which the type of the current block is the quantized latent tensor v of the residual image r output from the residual encoder 2152 and that is less than a quantization offset value of a case in which the type of the current block is the quantized latent tensor w of the optical flow g output from the optical flow encoder 2142.

In an embodiment, the image decoding apparatus 2300 may determine a quantization offset value to vary according to a frequency band of a channel group including a channel index of the current block by using the offset table. The image decoding apparatus 2300 may determine the quantization offset value to decrease when a frequency band indicated by the channel index decreases, and may determine the quantization offset value to increase when a frequency band indicated by the channel index increases.

In an embodiment, the image decoding apparatus 2300 may determine a quantization offset value to vary according to a quantization step of the current block by using the offset table. The image decoding apparatus 2300 may determine the quantization offset value to increase when a value of the quantization step increases. When the quantization step has a second quantization step value greater than a first quantization step value, the image decoding apparatus 2300 may determine, as the quantization offset for the current block, a second quantization offset that is a value greater than a first quantization offset determined based on the first quantization step.

In an embodiment, the image decoding apparatus 2300 may determine a quantization offset value to vary according to a sample value included in the quantized latent tensor of the current block by using the offset table. The image decoding apparatus 2300 may determine the quantization offset value to increase when the sample value included in the quantized latent tensor of the current block decreases. For example, a preset sample value included in the quantized latent tensor of the current block has a second sample value less than a first sample value, the image decoding apparatus 2300 may determine, as the quantization offset for the current block, a second quantization offset determined based on the second sample value greater than a first quantization offset determined based on the first sample value.

Hereinafter, in an embodiment, an operation in which the image decoding apparatus 2300 determines a quantization offset according to a quantization step of a current block by using an offset table will be described in detail.

Operation S2530 may correspond to operation S2430, and as a prediction mode of a current block in operation S2430 corresponds to a type of the current block, a frequency band of the current block corresponds to a channel index of the current block, a QP of the current block corresponds to a quantization step of the current block, and a transform coefficient corresponds to a latent tensor, the same descriptions are omitted.

In operation S2540, the image decoding apparatus 2300 may change the latent tensor by using the determined quantization offset.

In an embodiment, the image decoding apparatus 2300 may change the obtained latent tensor of the current block by using the determined quantization offset. For example, the image decoding apparatus 2300 may modify sample values of one or more latent tensors for the current block which are obtained via dequantization, by using quantization offsets respectively corresponding to the one or more latent tensors.

In an embodiment, the image decoding apparatus 2300 may perform a quantization shift by performing interpolation on the transform coefficient by using the determined quantization offset. An operation of changing the latent tensor may be referred to as operation of performing the quantization shift. The quantization shift may be performed by using a sample value of the latent tensor obtained in operation S2520 and a value subsequent to the sample value of the latent tensor and a value of the quantization offset. For example, the quantization shift according to the quantization offset may be performed by using Equation 5 below.

$${\hat{x}}_{i} = [ ( 1 ≪ B - offset ) \times {Q}^{- 1} ( {y}_{i} ) + offset ⨯ {Q}^{- 1} ( {{y}_{i}}^{′} ) ] ≫ B \qquad [ Equation 5 ]$$

In Equation above, \hat{x}ᵢ may indicate a sample value of a changed latent tensor. B may be a constant that is a parameter for controlling precision of the quantization offset. yᵢ may be a sample value of a quantized latent tensor, and yᵢ′ may be a value determined based on the sample value of the quantized latent tensor. For example, yᵢ′ may be determined by using Equation 6 below.

$${{y}_{i}}^{′} = {y}_{i} + ( {y}_{i} > 0 ? 1 : - 1 ) \qquad [ Equation 6 ]$$

In an embodiment, Equation 5 may be differently expressed as Equation 7.

$${\hat{x}}_{i} ← ( ( 1024 - T [ \vert {y}_{i} \vert ] ) * {Q}^{- 1} ( {y}_{i} ) + T [ \vert {y}_{i} \vert ] * {Q}^{- 1} ( {{y}^{′}}_{i} ) ) >> 10 if \vert T \vert > \vert {y}_{i} \vert > 0 \qquad [ Equation 7 ]$$

However, a method of changing or modifying a sample value of a latent tensor by using a quantization offset is not limited to the disclosed example.

In an embodiment, the image decoding apparatus 2300 may change or modify a latent tensor obtained by performing dequantization, by using a quantization offset determined based on at least one of a type of a current block, a channel index of the current block, or a quantization step of the current block.

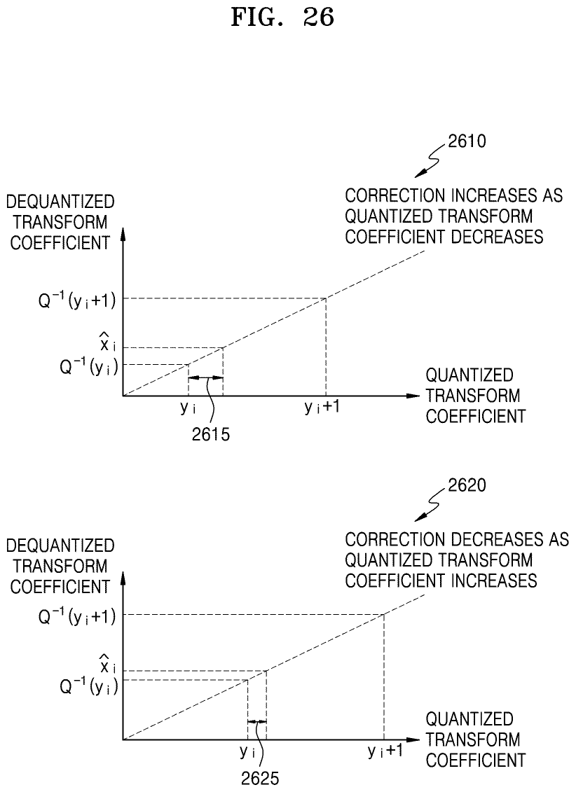

FIG. 26 is a diagram for describing a quantization offset according to an embodiment of the present disclosure.

In an embodiment, a quantization offset for a dequantized transform coefficient or a dequantized latent tensor may be a value determined by using Equation 8 and Equation 9.

$$R ( {y}_{i} ) ≅ a \cdot {log}_{2} ( \vert {y}_{i} \vert ) + b \qquad [ Equation 8 ]$$

yᵢ above indicates a dequantized transform coefficient or a dequantized latent tensor. R may be a function for calculating rate modeling. According to Equation above, the rate modelling may be the function determined based on only the dequantized transform coefficient or the dequantized latent tensor.

$$offset = {∇}_{{y}_{i}} ( R ( {y}_{i} ) ) ≅ \frac{a / ln ( 2 )}{{y}_{i}} = \frac{α}{{y}_{i}} \qquad [ Equation 9 ]$$

In an embodiment, a quantization offset may be calculated by using Equation 9, offset parameter α may be determined according to the calculated quantization offset, and an offset table may be constructed by using the offset parameter. By inputting the dequantized transform coefficient or the dequantized latent tensor as an index value to the offset table, a changed transform coefficient or a changed latent tensor may be obtained by using Equation 10 below.

$${\hat{x}}_{i} ← ( ( 1024 - T [ \vert {y}_{i} \vert ] ) * {Q}^{- 1} ( {y}_{i} ) + T [ \vert {y}_{i} \vert ] * {Q}^{- 1} ( {{y}^{′}}_{i} ) ) >> 10 if \vert T \vert > \vert {y}_{i} \vert > 0 \qquad [ Equation 10 ]$$

In an embodiment, when the transform coefficient or the latent tensor is changed by performing a quantization shift by using Equations 8 to 10, a quantization offset used to change the transform coefficient or the latent tensor may be a function dependent only on the quantized transform coefficient or the quantized latent tensor.

In an embodiment, according to the graph 2610 and the second graph 2620 with reference to FIG. 26, the dequantized transform coefficient or the dequantized latent tensor may be interpolated a value between Q⁻¹(yᵢ) that is dequantized from yᵢ to and Q⁻¹ (yᵢ+1) dequantized from yᵢ₊₁ subsequent to yᵢ or may be adjusted via a quantization shift. The quantization offset used to perform the quantization shift is the function dependent only on the quantized transform coefficient or the quantized latent tensor, and thus, when the quantized transform coefficient or the quantized latent tensor increases, variation in the transform coefficient or the latent tensor due to the quantization shift may be small.

For example, first variation 2615 of a transform coefficient or a latent tensor according to a quantization shift according to the quantization shift in the first graph 2610 may be greater than second variation 2625 in a transform coefficient or a latent tensor according to the quantization shift in the second graph 2620 in which magnitude of the transform coefficient or the latent tensor is great.

In an embodiment, in order to minimize a loss that has substantially occurred as quantization is performed on a transform coefficient or a latent tensor, a quantization offset has to be adjusted or changed according to multiple factors. Therefore, the present disclosure aims to adjust or change a quantization offset according to at least one of a prediction mode, a frequency band, and a QP or at least one of a type, a channel index, and a quantization step, rather than to change or adjust the quantization offset according to a quantized transform coefficient or a quantized latent tensor.

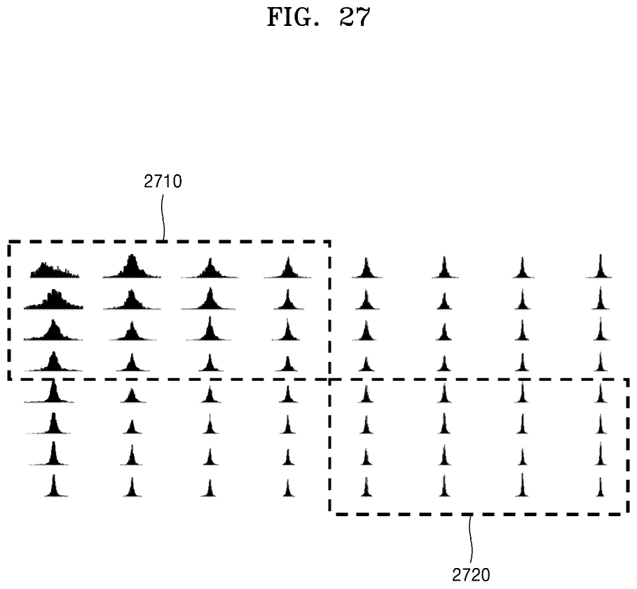

FIG. 27 is a diagram for describing a quantization offset according to an embodiment of the present disclosure.

In an embodiment, the image decoding apparatus 2300 may configure rate modelling in a manner different from the rate modelling as in FIG. 26. For example, the rate modelling may be modeled to depend on a distribution of QPs (or quantization steps) or transform coefficients or may be modeled to depend on a distribution of quantization steps or latent tensors.

$$p ( y ) = {\int }_{q ( y - 0.5 )}^{q ( y + 0.5 )} p ( Y ) dY = {\int }_{a}^{b} p ( Y ) dY ; y = Q ( Y ) \qquad [ Equation 11 ]$$

In Equation above, when y is a value quantized from Y, p (y) may be approximated as the integral of P (Y) within a preset range. Accordingly, p (y) may be expressed by using Equation 11. Also, q may indicate a quantization step.

In an embodiment, when using the Laplacian distribution in which an average is 0 and a standard deviation is σ, Laplacian modelling with respect to a transform coefficient or a latent tensor may be expressed by using Equation 12 and Equation 13.

$$p ( Y ) = \frac{1}{2 b} exp ( \frac{- Y}{b} ) = α {e}^{β Y} \qquad [ Equation 12 ]$$

$${p ( y ) = {\int }_{a}^{b} α {e}^{β Y} dY = \frac{α}{β} {e}^{β Y} \vert}_{a}^{b} = \frac{α}{β} ( {e}^{β b} - {e}^{β a} ) \qquad [ Equation 13 ]$$

In an embodiment, by using Equations 11 to 13, the rate modelling as a function for entropy may be expressed by using Equation 14.

$$[ Equation 14 ] \\ \frac{\partial H ( y )}{\partial y} = \frac{\partial - {log}_{2} ( p ( y ) )}{\partial y} = - \frac{{log}_{2} e}{p ( y )} \frac{\partial p ( y )}{\partial y} = - \frac{{log}_{2} e}{( {e}^{β b} - {e}^{β a} )} \frac{\partial ( {e}^{β b} - {e}^{β a} )}{\partial y} = - {log}_{2} e \frac{{e}^{β b} \frac{\partial β b}{\partial y} - {e}^{β a} \frac{\partial β a}{\partial y}}{{e}^{β b} - {e}^{β a}} = - ( {log}_{2} e ) \frac{{e}^{β b} β q - {e}^{β a} β q}{{e}^{β b} - {e}^{β a}} = ( {log}_{2} e ) β q = \sqrt{2} ( {log}_{2} e ) \frac{q}{σ}$$

In an embodiment, referring to FIG. 27, a distribution of transform coefficients or a distribution of latent tensors may be checked. Referring to a first distribution set 2710, it is apparent that the standard deviation σ with respect to the distribution of transform coefficients or the distribution of latent tensors is relatively great. Referring to a second distribution set 2720, it is apparent that the standard deviation σ with respect to the distribution of transform coefficients or the distribution of latent tensors is relatively small.

In an embodiment, as at least one of a prediction mode of a current block, a frequency band of the current block, and a QP of the current block corresponds to parameters related to the distribution of transform coefficients, the image decoding apparatus 2300 may determine a quantization offset by using at least one of the prediction mode of the current block, the frequency band of the current block, and the QP of the current block.

In an embodiment, in consideration of Equation 14 that is the rate modelling function for entropy, the quantization offset may be in inverse proportion toa standard deviation or a distribution.

In an embodiment, when a prediction mode of a current block is an intra mode, a standard deviation with respect to a transform coefficient may be greater than a case in which the prediction mode of the current block is an inter mode. Therefore, when the prediction mode of the current block is the inter mode, the image decoding apparatus 2300 may obtain or determine a quantization offset that is greater than the case in which the prediction mode of the current block is the intra mode.

In an embodiment, when a prediction mode of a current block is an inter mode, a standard deviation with respect to a transform coefficient may be great in a case in which the current block is predicted via uni-direction prediction than a case in which the current block is predicted via bi-prediction. Therefore, when the current block is predicted via uni-direction prediction, the image decoding apparatus 2300 may obtain or determine a quantization offset less than the case in which the current block is predicted via bi-prediction.

In an embodiment, a standard deviation with respect to a transform coefficient may be small in a case in which a frequency band of a current block is a low frequency band than a case in which the frequency band of the current block is a high frequency band. Therefore, when the frequency band of the current block is the high frequency band, the image decoding apparatus 2300 may obtain or determine a quantization offset greater than the case in which the frequency band of the current block is the low frequency band.

In an embodiment, a QPof a current block may be great at a high rate. Therefore, the image decoding apparatus 2300 may obtain or determine a large quantization offset in a case in which the QP of the current block is great, compared to a case in which the QP of the current block is small.

In an embodiment, as at least one of a type of a current block, a channel index of the current block, and a quantization step of the current block corresponds to parameters related to the distribution of latent tensors, the image decoding apparatus 2300 may determine a quantization offset by using at least one of the type of the current block, the channel index of the current block, and the quantization step of the current block.

In an embodiment, when the type of the current block is the quantized latent tensor of the current image 2010 output from the image encoder 2032, a standard deviation with respect to the latent tensor may be greater than the case in which the type of the current block is the quantized latent tensor w of the optical flow g output from the optical flow encoder 2142. Therefore, when the type of the current block is the quantized latent tensor of the current image 2010 output from the image encoder 2032, the image decoding apparatus 2300 may obtain or determine a quantization offset less than the case in which the type of the current block is the quantized latent tensor w of the optical flow g output from the optical flow encoder 2142.

In an embodiment, when the type of the current block is the quantized latent tensor of the current image 2010 output from the image encoder 2032, a standard deviation with respect to the latent tensor may be greater than the case in which the type of the current block is the quantized latent tensor v of the residual image r output from the residual encoder 2152. Therefore, when the type of the current block is the quantized latent tensor of the current image 2010 output from the image encoder 2032, the image decoding apparatus 2300 may obtain or determine a quantization offset less than the case in which the type of the current block is the quantized latent tensor v of the residual image r output from the residual encoder 2152.

In an embodiment, when the type of the current block is the quantized latent tensor w of the optical flow g output from the optical flow encoder 2142, a standard deviation with respect to the latent tensor may be less than the case in which the type of the current block is the quantized latent tensor v of the residual image r output from the residual encoder 2152. Therefore, when the type of the current block is the quantized latent tensor w of the optical flow g output from the optical flow encoder 2142, the image decoding apparatus 2300 may obtain or determine a quantization offset greater than the case in which the type of the current block is the quantized latent tensor v of the residual image r output from the residual encoder 2152.

In an embodiment, when a channel index of a current block is included in a high frequency channel group, a standard deviation with respect to a transform coefficient may be less than the case in which the channel index is included in a low frequency channel group. Therefore, when the channel index of the current block is included in the high frequency channel group, the image decoding apparatus 2300 may obtain or determine a quantization offset greater than the case in which the channel index is included in the low frequency channel group. The image decoding apparatus may obtain or determine a large quantization offset when the channel index of the current block is included in a higher frequency channel group.

In an embodiment, a quantization step of a current block may have a greater value at a high rate. Therefore, the image decoding apparatus 2300 may obtain or determine relatively a large quantization offset in a case in which the quantization step of the current block is small, compared to a case in which the quantization step of the current block is great.

In an embodiment, the image decoding apparatus 2300 may determine a quantization offset by combining the rate modelling as in FIG. 26 with the rate modelling as in FIG. 27. For example, the image decoding apparatus 2300 may determine a quantization offset according to the rate modelling as in FIG. 27 when a frequency band of a current block is a low frequency band, and may determine a quantization offset according to the rate modelling as in FIG. 26 when the frequency band of the current block is a high frequency band.

Also, for example, the image decoding apparatus 2300 may determine a quantization offset according to the rate modelling as in FIG. 27 when a QP of the current block is equal to or greater than a preset value, and may determine a quantization offset according to the rate modelling as in FIG. 26 when the QP of the current block is less than the preset value.

The rate modelling as in FIG. 26 may indicate that a quantization offset depends only on a quantized transform coefficient or a quantized latent tensor, and the rate modelling as in FIG. 27 may indicate that the quantization offset may be determined according to at least one of a prediction mode of the current block, a frequency band of the current block, and a QP of the current block, or at least one of a type of the current block, a channel index of the current block, and a quantization step of the current block.

FIG. 28 is a diagram of an operation of classifying a frequency band according to an embodiment of the present disclosure.

In an embodiment, the image decoding apparatus 2300 may determine one quantization offset among a plurality of quantization offsets, based on a frequency band of a transform coefficient included in a current block. The image decoding apparatus 2300 may classify samples in the current block, based on a frequency band corresponding to transform coefficients included in the current block.

In an embodiment, the image decoding apparatus 2300 may classify a plurality of samples included in the current block, according to a plurality of frequency bands. The image decoding apparatus 2300 may determine, among the plurality of frequency bands, a frequency band for the current block. The image decoding apparatus 2300 may determine quantization offset, according to the determined frequency band.

In an embodiment, the image decoding apparatus 2300 may determine, as the frequency band for the current block, a frequency band according to the transform coefficient corresponding to the sample at a preset location among the plurality of frequency bands. The image decoding apparatus 2300 may determine, as the frequency band for the current block, a frequency band including, as a most frequent value, a frequency corresponding to the transform coefficient among the plurality of frequency bands. Alternatively, the image decoding apparatus may determine different quantization offset, according to a transform coefficient corresponding to a sample at a preset location included in the current block. The image decoding apparatus may determine a plurality of quantization offsets respectively corresponding to a plurality of transform coefficients included in the current block. When the plurality of quantization offsets are determined, the image decoding apparatus may change a plurality of transform coefficients by using the determined plurality of quantization offsets.

However, a method of determining a frequency band for a current block is not limited to the disclosed example.

In an embodiment, the image decoding apparatus 2300 may classify, as a first frequency band, a frequency band of a first sample set 2810 including all samples in the upper left of first samples m0 and n0 in the current block. The image decoding apparatus 2300 may classify, as a second frequency band, a frequency band of a second sample set 2820 of all samples that are located in the upper left of second samples m1 and n1 located in the lower right of the first samples m0 and no in the current block and are not classified as the first frequency band. The image decoding apparatus 2300 may classify, as a third frequency band, a frequency band of a third sample set 2830 of all samples that are not classified as the first frequency band nor the second frequency band.

In an embodiment, the image decoding apparatus 2300 may determine a frequency index according to the first frequency band to be 0, may determine a frequency index according to the second frequency band to be 1, and may determine a frequency index according to the third frequency band to be 2. The image decoding apparatus 2300 may determine a quantization offset or an offset parameter by inputting a determined frequency index to an offset table or an offset parameter table based on a frequency band of a current block.

FIG. 29 is a diagram of an operation of classifying a frequency band according to an embodiment of the present disclosure.

In an embodiment, the image decoding apparatus 2300 may determine one quantization offset among a plurality of quantization offsets, based on a frequency band of a current block. The image decoding apparatus 2300 may classify samples in the current block, based on a frequency band corresponding to transform coefficients included in the current block.

In an embodiment, the image decoding apparatus 2300 may classify a plurality of samples included in the current block, according to a plurality of frequency bands, based on a scan order of the plurality of samples included in the current block. The image decoding apparatus 2300 may determine, among the plurality of frequency bands, a frequency band for the current block. The image decoding apparatus 2300 may determine a quantization offset, according to the determined frequency band.

In an embodiment, the image decoding apparatus 2300 may determine, as the frequency band for the current block, a frequency band according to the transform coefficient corresponding to the sample at a preset location among the plurality of frequency bands. The image decoding apparatus 2300 may determine, as the frequency band for the current block, a frequency band including, as a most frequent value, a frequency corresponding to the transform coefficient among the plurality of frequency bands. Alternatively, the image decoding apparatus may determine different quantization offset, according to a transform coefficient corresponding to a sample at a preset location included in the current block. The image decoding apparatus may determine a plurality of quantization offsets respectively corresponding to a plurality of transform coefficients included in the current block. When the plurality of quantization offsets are determined, the image decoding apparatus may change a plurality of transform coefficients by using the determined plurality of quantization offsets.

However, a method of determining a frequency band for a current block is not limited to the disclosed example.

In an embodiment, the image decoding apparatus 2300 may align in a line a plurality of samples included in the current block according to a scan order. In an embodiment, the image decoding apparatus 2300 may classify, as a first frequency band, a frequency band of a first sample set 2910 of samples for which a scan order precedes a first sample x0 among the plurality of samples aligned according to the scan order. The image decoding apparatus 2300 may classify, as a second frequency band, a frequency band of a second sample set 2920 of samples for which a scan order precedes a second sample x1 and which are not included in the first sample set 2910 among the plurality of samples aligned according to the scan order. The image decoding apparatus 2300 may classify, as a second frequency band, a frequency band of a third sample set 2930 of samples that are not included in the first sample set 2910 nor the second sample set 2920 among the plurality of samples aligned according to the scan order.

In an embodiment, the image decoding apparatus 2300 may determine a frequency index according to the first frequency band to be 0, may determine a frequency index according to the second frequency band to be 1, and may determine a frequency index according to the third frequency band to be 2. The image decoding apparatus 2300 may determine a quantization offset or an offset parameter by inputting a determined frequency index to an offset table or an offset parameter table based on a frequency band of a current block.

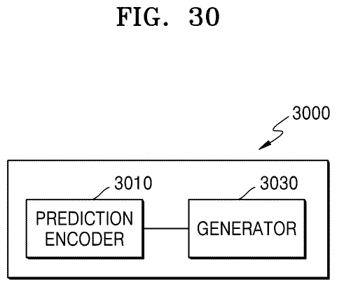

FIG. 30 is a block diagram illustrating a configuration of an image encoding apparatus according to an embodiment of the present disclosure.

In an embodiment, an image encoding apparatus 3000 may be distinguished between a case of performing image encoding/decoding based on block split and a case of performing image encoding/decoding based on a neural network. An operation in the case of performing image encoding/decoding based on block split will be first described, and then, an operation in the case of performing image encoding/decoding based on a neural network will be described.

Referring to FIG. 30, the image encoding apparatus 3000 may include a prediction encoder 3010 and a generator 3030. The prediction encoder 3010 shown in FIG. 30 may correspond to the encoder shown in FIG. 2, and the generator 3030 may correspond to the bitstream generator 210 shown in FIG. 2. Also, the prediction encoder 3010 may correspond to the prediction encoder 1915 shown in FIG. 19, and the generator 3030 may correspond to the entropy encoder shown in FIG. 19.

The prediction encoder 3010 and the generator 3030 according to an embodiment may be implemented as at least one processor. In an embodiment, the prediction encoder 3010 and the generator 3030 may operate according to at least one instruction stored in at least one memory.

At least one processor and the at least one memory of the image encoding apparatus 3000 may respectively correspond to the at least one processor and the at least one memory of the image decoding apparatus 2300, and thus, the same descriptions are omitted. In embodiments of the present disclosure, operations described as being performed by the image encoding apparatus 3000 or detailed configurations (see reference numerals 3010 and 3030 of FIG. 30) included in the image encoding apparatus 3000 are performed by the processor, unless there are particular explanations therefor.

In an embodiment, the image encoding apparatus 3000 may perform operations performed by the image decoding apparatus 2300 or a part/unit included in the image decoding apparatus 2300. The redundant same descriptions are omitted.

In an embodiment, the image encoding apparatus 3000 may include the at least one memory that stores input/output data of the prediction encoder 3010 and the generator 3030. Also, the image encoding apparatus 3000 may include a memory controller configured to control data input/output to/from the memory.

In an embodiment, the image encoding apparatus may split a picture into a plurality of largest coding units, and may split each of the largest coding units into blocks having various sizes and various shapes.

For example, when a prediction mode of a current block is an intra mode, the image encoding apparatus 3000 may determine a reference sample among samples of a spatial neighboring block located in an intra prediction direction of the current block, and may determine prediction samples of the current block by using the reference sample. Residual samples being a difference between the prediction samples and samples of the current block may be determined, the residual samples may be transformed based on a transformation block so as to generate transform coefficients, and quantization may be performed on the transform coefficients, such that quantized transform coefficients may be generated.

In an embodiment, the prediction encoder 3010 may determine prediction information used by the image decoding apparatus 2300 to predict a current block. For example, the prediction information may include information about a prediction mode of the current block. The information about the prediction mode of the current block may include information as to whether the current block is to be predicted in an intra mode or is to be predicted in an inter mode, or may include information as to whether the current block is to be uni-direction predicted or bi-predicted.

In an embodiment, when the prediction encoder 3010 determines the prediction mode of the current block as the intra mode, the prediction encoder 3010 may determine information about a prediction direction of the current block, and the prediction information may include the information about the prediction direction of the current block.

In an embodiment, when the prediction encoder 3010 determines the prediction mode of the current block as the inter mode, the prediction encoder 3010 may determine information about at least one of the information indicating as to whether the current block is to be uni-direction predicted or bi-predicted, information indicating a reference image, and motion information, and the determined information may be included in the prediction information.

In an embodiment, the prediction encoder 3010 may generate a prediction block by performing intra prediction or inter prediction on the current block according to a prediction mode of the prediction block. The prediction encoder 3010 may generate or determine the prediction block according to the determined prediction information, and may determine a residual block being a difference between an original block and the prediction block.

In an embodiment, the prediction encoder 3010 may encode the residual block. For example, the prediction encoder 3010 may perform transformation and quantization on the residual block. In an embodiment, the prediction encoder 3010 may determine transformation information and quantization information used to encode the residual block for the current block. The transformation information about the current block may include all information needed to perform inverse transformation on the current block. The transformation information about the current block may include information related to information indicating a transform kernel, a sub-block transform, a low frequency non-separable transform, or the like. However, the transformation information about the current block is not limited to the disclosed example.

In an embodiment, when the image encoding apparatus 3000 determines that the current block is to be decoded via a transformation skip mode, the image encoding apparatus 3000 may not be requested to generate a bitstream including the transformation information, and may determine the prediction block of the current block as a reconstructed block.

In an embodiment, the prediction encoder 3010 may determine or obtain the quantization information. The quantization information may include all information used by the image decoding apparatus 2300 to perform dequantization on the current block. For example, the quantization information may include at least one of at least one quantized transform coefficient and information indicating a QP.

In an embodiment, the prediction encoder 3010 may obtain a transform coefficient by performing dequantization based on the determined quantization information. For example, the prediction encoder 3010 may obtain the transform coefficient by performing inverse transformation on a quantized transform coefficient, based on the information indicating the QP for the current block. The information indicating the QP may include at least one of a differential QP, a predetermined quantization list, and a quantization index indicating one of a plurality of QPs included in the predetermined quantization list. However, the information indicating the QP refers to all information used to determine the QP and is not limited to the disclosed example.

In an embodiment, the generator 3030 may send or transmit a bitstream to the image decoding apparatus 2300 via a network. The generator 3030 may generate the bitstream including a syntax element for decoding of an image. Values that correspond to the syntax element may be included in the bitstream according to a hierarchical structure of the image. The generator 3030 may generate the bitstream by performing entropy encoding on bins corresponding to the syntax element. The bitstream may include a plurality of pieces of information used to reconstruct the current block. For example, the information used to reconstruct the current block may include at least one of quantization information, transformation information, and prediction information. The generator 3030 may generate the bitstream including the information indicating the QP.

In an embodiment, the prediction encoder 3010 may determine the information indicating the QP. The prediction encoder 3010 may obtain a transform coefficient of the current block by performing dequantization based on the information indicating the QP. The prediction encoder 3010 may determine quantization offset, based on at least one the prediction mode of the current block, a frequency band of the current block, and the QP of the current block. The prediction encoder 3010 may change the transform coefficient of the current block which is obtained by performing dequantization by using the quantization offset.

As a quantization offset for a transform coefficient of a current block is described in detail with reference to FIGS. 23 to 24, and FIGS. 26 to 29, the same descriptions are omitted.

In an embodiment, the image encoding apparatus 3000 may obtain a residual block of the current block by performing inverse transformation on the transform coefficient of the current block. For example, the image encoding apparatus 3000 may perform inverse transformation on transform coefficients of the current block by applying a transform kernel determined with respect to the current block, and the residual block may be reconstructed according to inverse transformation.

In an embodiment, the prediction encoder 3010 may reconstruct the current block by using the residual block obtained by performing dequantization and inverse transformation and the prediction block obtained by using the prediction information. The prediction encoder 3010 may use the reconstructed current block in encoding of another block.

In an embodiment, the generator may generate a bitstream including information generated according to neural network-based encoding on a current image.

In an embodiment, the prediction encoder 3010 may determine information used by the image decoding apparatus 2300 to decode a current block. The prediction encoder 3010 may determine information about at least one of a type of a current block to be processed, a channel index of the current block, and a quantization step of the current block.

In an embodiment, the prediction encoder 3010 may determine the type of the current block. The prediction encoder 3010 may determine a type index indicating the type of the current block.

In an embodiment, the prediction encoder 3010 may determine the channel index of the current block. The prediction encoder 3010 may determine information about a channel group including the channel index of the current block.

In an embodiment, the prediction encoder 3010 may determine a quantization step used to perform quantization on the current block. The prediction encoder 3010 may determine, by using the determined quantization step, information indicating the quantization step for the current block.

In an embodiment, the generator 3030 may generate a bitstream including at least one of the type of the current block, the channel index of the current block, and the quantization step of the current block. The generator 3030 may generate the bitstream including the information indicating the quantization step for the current block.

In an embodiment, the prediction encoder 3010 may obtain a latent tensor of the current block by performing dequantization based on the quantization step. The prediction encoder 3010 may determine one quantization offset among a plurality of quantization offsets, based on at least one of the type of the current block, the channel index of the current block, and the quantization step of the current block. The quantization offset may be used to change the latent tensor obtained by performing dequantization.

As a quantization offset for a latent tensor of a current block is described in detail with reference to FIG. 23, and FIGS. 25 to 29, the same descriptions are omitted.

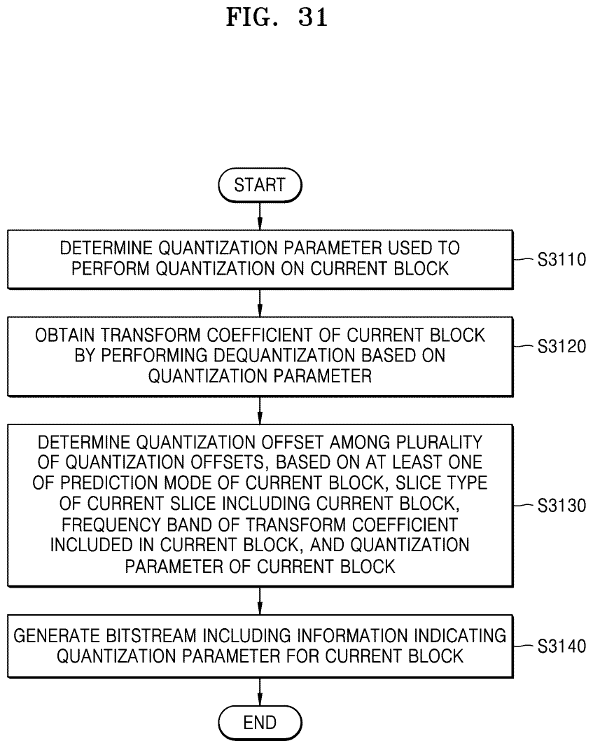

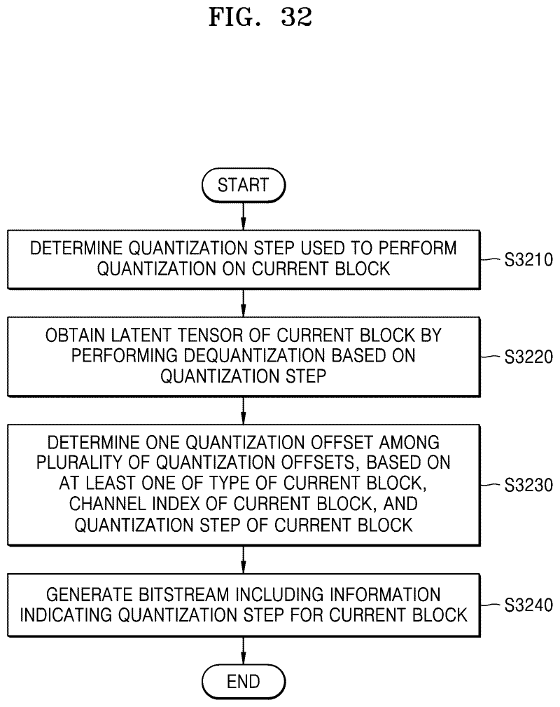

In an embodiment, a particular operation of the image encoding apparatus 3000 in the case of performing image encoding/decoding based on block split will be described again below with reference to FIG. 31. In an embodiment, a particular operation of the image encoding apparatus 3000 in the case of performing image encoding/decoding based on a neural network will be described again below with reference to FIG. 32.

FIG. 31 is a flowchart of an image encoding method according to an embodiment of the present disclosure.

In an embodiment, a particular operation of the image encoding method performed by the image encoding apparatus 3000 in the case of performing image encoding/decoding based on block split will now be described.

In operation S3110, the image encoding apparatus may determine a QP used to perform quantization on a current block.

In an embodiment, the image encoding apparatus 3000 may determine a most appropriate QP for quantization. For example, the image encoding apparatus 3000 may perform quantization on a plurality of samples included in the current block, by dividing values of the samples by using the QP. The image encoding apparatus 3000 may determine a most appropriate value as the QP capable of decreasing a loss in image reconstruction and decreasing a bitrate.

In operation S3120, the image encoding apparatus may obtain a transform coefficient of the current block by performing dequantization based on the QP.

In an embodiment, the image encoding apparatus 3000 may perform dequantization on a quantized transform coefficient by using the determined QP. The image encoding apparatus 3000 may obtain the transform coefficient of the current block by performing dequantization on the quantized transform coefficient.

The transform coefficient of the current block which is obtained by performing dequantization may be different from or equal to a transform coefficient obtained before quantization is performed in an encoding process with respect to a current image.

In operation S3130, the image encoding apparatus may determine one quantization offset among a plurality of quantization offsets, based on at least one of a prediction mode of the current block, a slice type of a current slice including the current block, a frequency band of a transform coefficient included in the current block, and a QP of the current block.

In an embodiment, the image encoding apparatus 3000 may determine or generate a look-up table based on at least one of the prediction mode of the current block, the slice type of the current slice the current block, the frequency band of the transform coefficient included in the current block, and the QP of the current block. The look-up table may include the offset table or an offset parameter table with reference to FIGS. 23 to 29. The image encoding apparatus 3000 may determine an offset table or an offset parameter table for determining an optimal quantization offset according to the prediction mode of the current block or the slice type of the current slice including the current block, the frequency band of the transform coefficient included in the current block, and the QP of the current block.

The look-up table may be information that is predetermined in advance and shared between the image encoding apparatus 3000 and the image decoding apparatus 2300.

In an embodiment, the image encoding apparatus 3000 may perform a quantization shift using a quantization offset so as to decrease an error with respect to an original image, by correcting a quantized transform coefficient to be close to a transform coefficient value obtained before quantization is performed in a current image encoding process.

In an embodiment, the image encoding apparatus 3000 may obtain a quantization offset corresponding to a current block by inputting, to the offset table or the offset parameter table, at least one index obtained by using at least one of a prediction mode of the current block, a slice type of a current slice including the current block, a frequency band of a transform coefficient included in the current block, and a QP of the current block.

An operation in which the image encoding apparatus 3000 obtains a quantization offset may correspond to an operation in which the image decoding apparatus 2300 determines one quantization offset among a plurality of quantization offsets, based on at least one of a prediction mode of the current block, a slice type of a current slice including the current block, a frequency band of a transform coefficient included in the current block, and a QP of the current block, and thus, the same descriptions are omitted.

In operation S3140, the image encoding apparatus may generate a bitstream including information indicating the QP for the current block.

In an embodiment, the image encoding apparatus 3000 may determine the information indicating the QP for the current block. The image encoding apparatus 3000 may generate the bitstream including the determined information indicating the QP.

In an embodiment, the information indicating the QP may include a differential QP indicating a difference between a QP for an encoded previous block that is a previous object to be processed and the QP for the current block. The information indicating the QP may include a quantization index indicating a determined QP among a plurality of QPs included in a predetermined quantization list. The information indicating the QP may include information about the quantization list and the quantization index.

However, the information indicating the QP is not limited to the disclosed example.

FIG. 32 is a flowchart of an image encoding method according to an embodiment of the present disclosure.

In an embodiment, a particular operation of the image encoding method performed by the image encoding apparatus 3000 in the case of performing image encoding/decoding based on a neural network will now be described.

In operation S3210, the image encoding apparatus may determine a quantization step used to perform quantization on a current block.

In an embodiment, the image encoding apparatus 3000 may determine the most appropriate quantization step for quantization. For example, the image encoding apparatus 3000 may perform quantization on a plurality of samples included in the current block, by dividing values of the samples by using the quantization step. The image encoding apparatus 3000 may determine an optimal value as the quantization step capable of decreasing a loss in image reconstruction and decreasing a bitrate.

In operation S3220, the image encoding apparatus may obtain a latent tensor of the current block by performing dequantization based on the quantization step.

In an embodiment, the image encoding apparatus 3000 may perform dequantization on a quantized latent tensor by using the determined quantization step. The image encoding apparatus 3000 may may obtain the latent tensor of the current block by performing dequantization on the quantized latent tensor.

The latent tensor of the current block which is obtained by performing dequantization may be different from or equal to a latent tensor obtained before quantization is performed in an encoding process with respect to a current image.

In operation S3230, the image encoding apparatus may determine one quantization offset among a plurality of quantization offsets, based on at least one of a type of the current block, a channel index of the current block, and the quantization step of the current block.

In an embodiment, the image encoding apparatus 3000 may determine or generate a look-up table based on at least one of the type of the current block, the channel index of the current block, and the quantization step of the current block. The look-up table may include the offset table or a quantization step table with reference to FIGS. 23 to 29. The image encoding apparatus 3000 may determine the offset table or the quantization step table for determining optimal quantization offset, according to the type of the current block, the channel index of the current block, and the quantization step of the current block.

The look-up table may be information that is predetermined in advance and shared between the image encoding apparatus 3000 and the image decoding apparatus 2300.

In an embodiment, the image encoding apparatus 3000 may perform a quantization shift using a quantization offset so as to decrease an error with respect to an original image, by correcting a quantized latent tensor to be close to a latent tensor value obtained before quantization is performed in a current image encoding process.

In an embodiment, the image encoding apparatus 3000 may obtain a quantization offset corresponding to the current block by inputting, to the offset table or the quantization step table, at least one index obtained by using the type of the current block, the channel index of the current block, and the quantization step of the current block.

An operation in which the image encoding apparatus 3000 obtains a quantization offset may correspond to an operation in which the image decoding apparatus 2300 determines one quantization offset among a plurality of quantization offsets, based on at least one of the type of the current block, the channel index of the current block, and the quantization step of the current block, and thus, the same descriptions are omitted.

In operation S3240, the image encoding apparatus may generate a bitstream including information indicating the quantization step for the current block.

In an embodiment, the image encoding apparatus 3000 may determine the information indicating the quantization step for the current block. The image encoding apparatus 3000 may generate the bitstream including the determined information indicating the quantization step.

In an embodiment, the information indicating the quantization step may include a differential quantization step indicating a difference between a quantization step for an encoded previous block that is a previous object to be processed and the quantization step for the current block. The information indicating the quantization step may include a quantization index indicating a determined quantization step among a plurality of quantization steps included in a predetermined quantization list. The information indicating the quantization step may include information about the quantization list and the quantization index.

However, the information indicating the quantization step is not limited to the disclosed example.

In an embodiment, an image decoding method for a quantization shift is provided. The image decoding method may include obtaining, from a bitstream, information indicating a QP for a current block (S2410). The image decoding method may include obtaining a transform coefficient of the current block by performing dequantization based on the information indicating the QP (S2420). The image decoding method may include determining a quantization offset among a plurality of quantization offsets, based on at least one of a slice type of a prediction mode of the current block, a current slice including the current block, a frequency band of the transform coefficient included in the current block, or the QP of the current block (S2430). The image decoding method may include changing the transform coefficient by using the determined quantization offset (S2440).

In an embodiment, the plurality of quantization offsets are determined according to an offset table or an offset parameter table which is predetermined by using at least one of a prediction mode of the current block, the slice type of the current slice including the current block, the frequency band of the transform coefficient included in the current block, or the QP of the current block.

In an embodiment, the image decoding method may include performing a quantization shift by performing interpolation on a value of the transform coefficient and a value subsequent to the transform coefficient by using the quantization offset.

In an embodiment, the image decoding method may include determining, as a quantization offset for the current block, a quantization offset value that is of a case in which the prediction mode of the current block is an intra mode and that is less than a quantization offset value of a case in which the prediction mode of the current block is an inter mode.

In an embodiment, the image decoding method may include, when the prediction mode is an inter mode, determining, as the quantization offset for the current block, a quantization offset that is of a case in which bi-direction prediction is performed on the current block and that has a value greater than a quantization offset of a case in which uni-direction prediction is performed on the current block.

In an embodiment, the determined quantization offset has a value that is greater in a case in which a frequency band of the current block is a high frequency band than in a case in which the frequency band is a low frequency band.

In an embodiment, the image decoding method may include, when the quantization offset is a second QP greater than a first QP, determining a second quantization offset as the quantization offset for the current block, the second quantization offset being greater than a first quantization offset determined based on the first QP.

In an embodiment, the image decoding method may include, when a quantized transform coefficient value for the current block is a second quantized transform coefficient less than a first quantized transform coefficient, determining a second quantization offset as the quantization offset for the current block, the second quantization offset being greater than a first quantization offset determined based on the first quantized transform coefficient.

In an embodiment, the image decoding method may include, based on locations of a plurality of samples included in the current block, classifying the plurality of samples included in the current block, according to a plurality of frequency bands. The image decoding method may include determining, among the plurality of frequency bands, a frequency band among the plurality of frequency bands. The image decoding method may include determining a quantization offset corresponding to the determined frequency band.

In an embodiment, the image decoding method may include, based on a scan order of the plurality of samples included in the current block, classifying the plurality of samples included in the current block, according to the plurality of frequency bands. The image decoding method may include determining, among the plurality of frequency bands, a frequency band among the plurality of frequency bands. The image decoding method may include determining a quantization offset corresponding to the determined frequency band

In an embodiment, the image decoding apparatus 2300 for a quantization shift is provided. The image decoding apparatus 2300 may include at least one memory storing at least one instruction and at least one processor configured to operate according to the at least one instruction. The at least one processor may be configured to obtain, from a bitstream, information indicating a QP for a current block. The at least one processor may be configured to obtain a transform coefficient of the current block by performing dequantization based on the information indicating the QP. The at least one processor may be configured to determine a quantization offset among a plurality of quantization offsets, based on at least one of a prediction mode of the current block, a slice type of a current slice including the current block, a frequency band of the transform coefficient included in the current block, or the QP of the current block. The at least one processor may be configured to change the transform coefficient by using the determined quantization offset.

In an embodiment, an image encoding method for a quantization shift is provided. The image encoding method may include determining a QP used to perform quantization on a current block (S3110). The image encoding method may include obtaining a transform coefficient of the current block by performing dequantization based on the QP (S3120). The image encoding method may include determining a quantization offset among a plurality of quantization offsets, based on at least one of a prediction mode of the current block, a slice type of a current slice including the current block, a frequency band of a transform coefficient included in the current block, and the QP of the current block, wherein the quantization offset is used to change the transform coefficient obtained by performing dequantization (S3130). The image encoding method may include generating a bitstream including information indicating the QP for the current block (S3140).

In an embodiment, the plurality of quantization offsets may be determined according to an offset table or an offset parameter table which is predetermined by using at least one of the prediction mode of the current block, the slice type of the current slice including the current block, the frequency band of the transform coefficient included in the current block, or the QP for the current block.

In an embodiment, a quantization shift may be performed on the transform coefficient obtained by performing dequantization, by interpolating a value of the transform coefficient and a value subsequent to the transform coefficient by using the quantization offset.

In an embodiment, the image encoding method may include determining, as the quantization offset for the current block, a quantization offset value that is of a case in which the prediction mode of the current block is an intra mode and that is less than a quantization offset value of a case in which the prediction mode of the current block is an inter mode.

In an embodiment, the image encoding apparatus 3000 for a quantization shift is provided. The image encoding apparatus 3000 may include at least one memory storing at least one instruction and at least one processor configured to operate according to the at least one instruction. The at least one processor may be configured to determine a QP used to perform quantization on a current block. The at least one processor may be configured to obtain a transform coefficient of the current block by performing dequantization based on the QP. The at least one processor may be configured to determine a quantization offset among a plurality of quantization offsets, based on at least one of a prediction mode of the current block, a slice type of a current slice including the current block, a frequency band of a transform coefficient included in the current block, and the QP of the current block, wherein the quantization offset is used to change the transform coefficient obtained by performing dequantization. The at least one processor may be configured to generate a bitstream including information indicating the QP of the current block.

In an embodiment, a computer-readable recording medium having stored therein a bitstream generated by the image encoding method for a quantization shift is provided. The bitstream may include information indicating a QP for a current block. The QP for the current block may be used to perform quantization on the current block, or may be used to obtain a transform coefficient of the current block by performing dequantization. The transform coefficient of the current block may be changed by using one quantization offset among a plurality of quantization offsets determined based on at least one of a prediction mode of the current block, a slice type of a current slice including the current block, a frequency band of the transform coefficient included in the current block, and the QP of the current block.

In an embodiment, an image decoding method for a quantization shift is provided. The image decoding method may include obtaining, from a bitstream, information indicating a quantization step for a current block (S2510). The image decoding method may include obtaining a latent tensor of the current block by performing dequantization based on the information indicating the quantization step (S2520). The image decoding method may include determining one quantization offset among a plurality of quantization offsets, based on at least one of a type of the current block, a channel index of the current block, or the quantization step of the current block (S2530). The image decoding method may include changing the latent tensor by using the determined quantization offset (S2540).

In an embodiment, an image encoding method for a quantization shift is provided. The image encoding method may include determining a quantization step used to perform quantization on a current block (S3210). The image encoding method may include obtaining a latent tensor of the current block by performing dequantization based on the quantization step, (S3220). The image encoding method may include determining one quantization offset among a plurality of quantization offsets, based on at least one of a type of the current block, a channel index of the current block, or the quantization step of the current block, and the quantization offset may be used to change the latent tensor obtained by performing dequantization (S3230). The image encoding method may include generating a bitstream including information indicating the quantization step for the current block (S3230).

In an embodiment, a computer-readable recording medium having stored therein a bitstream generated by the image encoding method for a quantization shift is provided. The bitstream may include information indicating a quantization step for a current block. The quantization step for the current block may be used to perform quantization on the current block, or may be used to obtain a latent tensor of the current block by performing dequantization. The latent tensor of the current block may be changed by using one quantization offset among a plurality of quantization offsets determined based on at least one of a type of the current block, a channel index of the current block, and the quantization step of the current block.

Various embodiments of the present disclosure may be implemented or supported by one or more computer programs, and the computer programs may be formed from computer-readable program code and recorded on a computer-readable medium. In the present disclosure, the “application” and the “program” may refer to one or more computer programs, software components, instruction sets, procedures, functions, objects, classes, instances, associated data, or parts thereof, which are suitable for implementation in computer-readable program code. The “computer-readable program code” may include various types of computer code, including source code, object code, and executable code. The “computer-readable medium” may include various types of media that are accessible by a computer, such as ROM, RAM, hard disk drive (HDD), compact disc (CD), DVD, or other types of memory.

In addition, a storage medium that is readable by a machine may be provided in the form of a non-transitory storage medium. The ‘non-transitory storage medium’ is a tangible device and may exclude wired, wireless, optical, or other communication links that transmit temporary electrical or other signals. On the other hand, the ‘non-transitory storage medium’ does not distinguish between a case where data is semi-permanently stored on the storage medium and a case where data is temporarily stored. For example, the ‘non-transitory storage medium’ may include a buffer in which data is temporarily stored. The computer-readable recording medium may be any available media that are accessible by a computer and may include any volatile and non-volatile media and any removable and non-removable media. The computer-readable medium includes a medium on which data may be permanently stored and a medium on which data may be stored and overwritten later, for example, a rewritable optical disk or an erasable memory device.

A method according to an embodiment of the present disclosure may be provided by being included in a computer program product. A computer program product may be traded between a seller and a buyer as commodities. The computer program product may be distributed in the form of a machine-readable storage medium (e.g., CD-ROM), or may be distributed (e.g., downloaded or uploaded) online either via an application store or directly between two user devices (e.g., smartphones). In the case of the online distribution, at least a part of a computer program product (e.g., a downloadable app) is stored at least temporarily on a machine-readable storage medium, such as a server of a manufacturer, a server of an application store, or memory of a relay server, or may be temporarily generated.

The foregoing description of the present disclosure is for illustrative purposes only, and those of ordinary skill in the art to which the present disclosure pertains will understand that modifications into other specific forms may be made thereto without changing the technical spirit or essential features of the present disclosure. For example, appropriate results may be achieved even when the technologies described above are performed in an order different from the methods described above, and/or components of the computer system or modules described above are coupled or combined in a manner different from the methods described above or are replaced or substituted by other components or equivalents. Therefore, it should be understood that the embodiments described above are illustrative in all respects and are not restrictive. For example, components described as a single entity may be implemented in a distributed manner. Similarly, components described as distributed may be implemented in a combined manner.

The scope of the present disclosure is indicated by the claims described below, and all changes or modifications derived from the meaning and scope of the claims and the equivalent concepts thereof should be interpreted as falling within the scope of the present disclosure.

What is claimed is:

1. An image decoding method comprising:
obtaining, from a bitstream, information indicating a quantization parameter for a current block;
obtaining a transform coefficient of the current block by performing dequantization based on the information indicating the quantization parameter;
determining a quantization offset among a plurality of quantization offsets, based on at least one of a prediction mode of the current block, a slice type of a current slice comprising the current block, a frequency band of the transform coefficient comprised in the current block, or the quantization parameter of the current block; and
changing the transform coefficient by using the determined quantization offset.

2. The image decoding method of claim 1,
wherein the plurality of quantization offsets are determined according to an offset table or an offset parameter table which is predetermined by using at least one of the prediction mode of the current block, the slice type of the current slice comprising the current block, the frequency band of the transform coefficient comprised in the current block, or the quantization parameter of the current block.

3. The image decoding method of claim 1,
wherein the changing of the transform coefficient comprises performing a quantization shift by performing interpolation, by using the quantization offset, on a value of the transform coefficient and a value subsequent to the transform coefficient.

4. The image decoding method of claim 1,
wherein the determining of the quantization offset comprises determining, as the quantization offset for the current block, a quantization offset value that is of a case in which the prediction mode of the current block is an intra mode and that is less than a quantization offset value of a case in which the prediction mode of the current block is an inter mode.

5. The image decoding method of claim 1,
wherein the determining of the quantization offset comprises determining, as the quantization offset for the current block, a quantization offset that is of a case in which bi-direction prediction is performed on the current block and that has a value greater than a quantization offset of a case in which uni-direction prediction is performed on the current block.

6. The image decoding method of claim 1,
wherein the determined quantization offset has a value that is greater in a case in which a frequency band of the current block is a high frequency band than in a case in which the frequency band of the current block is a low frequency band.

7. The image decoding method of claim 4,
wherein the determining of the quantization offset comprises, when the quantization offset value is a second quantization parameter greater than a first quantization parameter, determining a second quantization offset as the quantization offset for the current block, the second quantization offset being greater than a first quantization offset determined based on the first quantization parameter.

8. The image decoding method of claim 1,
wherein the determining of the quantization offset comprises, when a quantized transform coefficient value for the current block is a second quantized transform coefficient less than a first quantized transform coefficient, determining a second quantization offset as the quantization offset for the current block, the second quantization offset being greater than a first quantization offset determined based on the first quantized transform coefficient.

9. The image decoding method of claim 1,
wherein the determining of the quantization offset among the plurality of quantization offsets comprises:
based on locations of a plurality of samples comprised in the current block, classifying the plurality of samples comprised in the current block, according to a plurality of frequency bands;
determining, among the plurality of frequency bands, a frequency band for the current block; and
determining the quantization offset, according to the determined frequency band.

10. The image decoding method of claim 1,
wherein the determining of the quantization offset among the plurality of quantization offsets comprises:
based on a scan order of a plurality of samples comprised in the current block, classifying the plurality of samples comprised in the current block, according to a plurality of frequency bands;
determining, among the plurality of frequency bands, a frequency band for the current block; and
determining the quantization offset, according to the determined frequency band.

11. An image encoding method comprising:
determining a quantization parameter used to perform quantization on a current block;
obtaining a transform coefficient of the current block by performing dequantization based on the quantization parameter;
determining a quantization offset among a plurality of quantization offsets, based on at least one of a prediction mode of the current block, a slice type of a current slice comprising the current block, a frequency band of a transform coefficient comprised in the current block, and the quantization parameter of the current block, wherein the quantization offset is used to change the transform coefficient obtained by performing dequantization; and
generating a bitstream comprising information indicating the quantization parameter of the current block.

12. The image encoding method of claim 11,
wherein the plurality of quantization offsets are determined according to an offset table or an offset parameter table which is predetermined by using at least one of the prediction mode of the current block, the slice type of the current slice comprising the current block, the frequency band of the transform coefficient comprised in the current block, or the quantization parameter for the current block.

13. The image encoding method of claim 11,
wherein a quantization shift is performed on the transform coefficient obtained by performing dequantization, via interpolation of a value of the transform coefficient and a value subsequent to the transform coefficient by using the quantization offset.

14. The image encoding method of claim 11,
wherein the determining of the quantization offset comprises determining, as the quantization offset for the current block, a quantization offset value that is of a case in which the prediction mode of the current block is an intra mode and that is less than a quantization offset value of a case in which the prediction mode of the current block is an inter mode.

15. A non-transitory computer-readable recording medium storing computer program, which, when executable by at least one processor, causes the at least one processor to execute:
obtain, from a bitstream, information indicating a quantization parameter for a current block;
obtain a transform coefficient of the current block by performing dequantization based on the information indicating the quantization parameter;
determine a quantization offset among a plurality of quantization offsets, based on at least one of a prediction mode of the current block, a slice type of a current slice comprising the current block, a frequency band of the transform coefficient comprised in the current block, or the quantization parameter of the current block; and
change the transform coefficient by using the determined quantization offset.
